(19) United States
(12) Patent Application Publication
(10) Pub. No.: US 2015/0216637 A1
(43) Pub. Date: Aug. 6, 2015

(54) DENTAL COMPONENT, METAL POWDER FOR POWDER METALLURGY, AND METHOD FOR PRODUCING DENTAL COMPONENT

(71) Applicant: Seiko Epson Corporation, Tokyo (JP)

(72) Inventors: Isshin NARUMI, Hachinohe (JP); Hidefumi NAKAMURA, Hachinohe (JP); Hideki ISHIGAMI, Hachinohe (JP); Michio ITO, Shiojiri (JP)

(21) Appl. No.: 14/614,697

(22) Filed: Feb. 5, 2015

(30) Foreign Application Priority Data
Feb. 6, 2014 (JP) 2014-021139
Feb. 28, 2014 (JP) 2014-038956
Feb. 28, 2014 (JP) 2014-038957

(51) Int. Cl. A61C 13/00; A61C 8/00; B22F 5/00; C22C 19/07; B22F 3/12; A61C 7/14; A61C 13/08

(52) U.S. Cl. CPC A61C 13/0022; A61C 7/14; A61C 8/0096; A61C 8/0012; A61C 13/0006; A61C 8/0048; A61C 13/081; C22C 19/07; B22F 3/12; B22F 5/00

(57) ABSTRACT

A dental component is formed from a sintered body of a metal powder having particles containing Co, Cr, Mo, and Si as constituent components. In the particles, Co is contained as a main component, the content of Cr is 26% by mass or more and 35% by mass or less, the content of Mo is 5% by mass or more and 12% by mass or less, and the content of Si is 0.3% by mass or more and 2.0% by mass or less. The dental component has excellent proof stress and corrosion resistance. It is preferred that a part of Si in the sintered body is contained as silicon oxide, and the ratio of the content of Si contained as the silicon oxide to the content of Si in the sintered body is 20% or more and 80% or less.

### CROSS-REFERENCE TO RELATED APPLICATIONS

This application claims priority to Japanese Patent Application No. 2014-021139 filed on Feb. 6, 2014, Japanese Patent Application No. 2014-038956 filed on Feb. 28, 2014, and Japanese Patent Application No. 2014-038957 filed on Feb. 28, 2014. The entire disclosures of Japanese Patent Application Nos. 2014-021139, 2014-038956 and 2014-038957 are hereby incorporated herein by reference.

### BACKGROUND

1. Technical Field

The present invention relates to a dental component, a metal powder for powder metallurgy, and a method for producing a dental component.

2. Related Art

In the field of dental treatment, orthodontic treatment for straightening teeth, implant treatment for restoring the function of a lost tooth, and the like are performed.

As one example of the orthodontic treatment, the following method is used. First, an orthodontic bracket is attached to the teeth of a patient. Subsequently, an archwire is inserted in an archwire slot of the orthodontic bracket to fix the archwire to the orthodontic bracket. This archwire is fixed to the orthodontic bracket with a ligature wire made of a metal or a ligature tool such as a standing module. Therefore, the orthodontic bracket plays a role in fixing an archwire to teeth and transferring a force (stress) from the archwire to each tooth. In this manner, by applying a force to each tooth, each tooth is gradually moved, whereby the teeth can be brought to normal alignment.

JP-A-6-14942 (PTL 1) discloses an orthodontic bracket having one main body formed from at least one member selected from the group consisting of titanium, zircon, silicon, boron, beryllium, chromium, niobium, cobalt, and an alloy composition containing any of these elements as a base. In such an orthodontic bracket, the content of at least one element of the elements in the group contained in the main body is 40% and 99% or more by weight. Also in Examples of PTL 1, as specific examples of the material for the bracket, a cobalt-chromium alloy, a stainless steel, pure titanium, a titanium-based alloy, and the like are shown.

Among these, the cobalt-chromium alloy described in PTL 1 has a relatively high tensile strength, and also has corrosion resistance, and therefore attracts attention as a material for the orthodontic bracket.

However, the cobalt-chromium alloy in the related art has a problem that the fatigue strength is low. Therefore, when a force is repeatedly applied to the orthodontic bracket, deformation or the like may occur. As a result, it is necessary to restrict a force applied to the orthodontic bracket in the related art, so that the time required for orthodontic treatment is prolonged.

Further, those who provide orthodontic treatment (dentists and the like) are required to give consideration so that a large force is not applied to the orthodontic bracket. Therefore, the efficiency of the treatment is impeded.

In the orthodontic treatment method as described above, teeth are pulled each other, and therefore, there are some cases where it is relatively difficult to move a specific tooth to a desired direction. Therefore, recently, orthodontic treatment is performed by a method in which a dental anchor is fixed to the alveolar bone or the like, and this dental anchor and an orthodontic bracket are connected to each other with a ligature wire or the like (see JP-A-2007-111317 (PTL 2)). In this treatment method, the dental anchor serves as an anchorage. The dental anchor is fixed to the bone or the like and therefore moves little even after a lapse of time. Therefore, by using the dental anchor, a tooth can be moved based on the bone or the like, and thus, it becomes easier to move a specific tooth in a desired direction.

However, the dental anchor in the related art has a problem that the proof stress is low. Therefore, when a force is continuously applied to the dental anchor over a long period of time of, for example, several months, there is a concern that the dental anchor may be bent or fractured.

Examples of the dental implant to be used in implant treatment generally include a fixture to be fixed to the alveolar bone, the jaw bone, or the like, and an abutment to be screwed into the fixture. Then, the abutment screwed into the fixture is covered with a prosthesis (crown restoration), and fixed with a dental cement to finish it into a shape corresponding to the original tooth.

A prosthetic portion includes a metal frame and a ceramic coating member fired onto the outer surface of the metal frame. Among these, the metal frame is produced by, for example, casting a cobalt-chromium alloy (see JP-A-10-57402 (PTL 3)).

The cobalt-chromium alloy is a heat-resistant material developed for aircraft engines at first, and has excellent mechanical properties, corrosion resistance, and so on. Further, it also has excellent wear resistance, and therefore is used also as a material which forms a sliding portion of an artificial joint. In addition, it has excellent castability, and therefore is used also as a material which forms a denture base.

On the other hand, as a material which forms a fixture to be fixed to the bone, pure titanium or a titanium-based alloy is often used in the related art.

Pure titanium and a titanium-based alloy have high corrosion resistance, and therefore have high compatibility with biological tissues, and are considered to be suitable as a constituent material of a fixture to be placed in the mouth over a long period of time.

However, to a dental implant or a prosthesis, a large load is applied accompanying mastication or bruxism. Moreover, such a load is continuously and repeatedly applied over several tens of years if long. Therefore, the dental implant in the related art was sometimes deformed and fractured.

### SUMMARY

An advantage of some aspects of the invention is to provide a dental component having high proof stress and corrosion resistance, and also provide a metal powder for powder metallurgy and a method for producing a dental component capable of easily producing a dental component having high proof stress and corrosion resistance.

The invention can be implemented as the following aspects.

A dental component according to an aspect of the invention is formed from a sintered body of a metal powder having particles containing Co, Cr, Mo, and Si as constituent components. In the particles, Co is contained as a main component, the content of Cr is 26% by mass or more and 35% by mass or less, the content of Mo is 5% by mass or more and 12% by mass or less, and the content of Si is 0.3% by mass or more and 2.0% by mass or less.

According to this configuration, a dental component having high proof stress and corrosion resistance can be obtained. When the dental component is a dental orthodontic bracket, the fatigue strength of the dental orthodontic bracket can be increased. That is, a dental orthodontic bracket having excellent deformation resistance can be obtained. When the dental component is a dental anchor, the deformation resistance of the dental anchor can be enhanced. According to this, for example, it can be used in orthodontic treatment over a long period of time. When the dental component is a dental implant, the fracture resistance of the dental implant can be enhanced. Such a dental implant is, for example, hardly fractured even if a load accompanying mastication or bruxism is applied over a long period of time. Therefore, a burden on a patient accompanying the interruption of the treatment or retreatment can be reduced.

In the dental component according to the aspect of the invention, it is preferable that apart of Si in the sintered body is contained as silicon oxide, and the ratio of the content of Si contained as the silicon oxide to the content of Si in the sintered body is 20% or more and 80% or less.

According to this configuration, the mechanical properties of the dental component are improved. Further, since silicon oxide exists in a given amount in the dental component, the amount of oxides of transition metal elements such as Co, Cr, and Mo contained in the dental component can be sufficiently reduced. As a result, a dental component having high reliability can be obtained. When the dental component is a dental anchor, appropriate rigidity and slidability are imparted to the dental anchor. When the dental component is a dental implant, appropriate rigidity and slidability are imparted to the dental implant. Further, when a coating film is formed on the surface of the dental implant, the adhesiveness of the dental implant to the coating film can be enhanced due to an adhesive force derived from a so-called oxide bond.

In the dental component according to the aspect of the invention, it is preferable that the silicon oxide is segregated at the grain boundary of the sintered body.

According to this configuration, an increase in size of a metal crystal in the sintered body can be more reliably prevented, and thus, a dental component having more excellent mechanical properties can be obtained.

In the dental component according to the aspect of the invention, it is preferable that the particles further contain N as a constituent component, and the content of N in the particles is 0.09% by mass or more and 0.5% by mass or less.

According to this configuration, austenitization of the crystal structure of the sintered body of the metal powder which forms the dental component is promoted, and therefore, the toughness of the dental component can be increased. Further, the formation of a dendrite phase in the sintered body of the metal powder which forms the dental component is prevented, and therefore, also from this point of view, the toughness of the dental component can be enhanced. Further, when the dental component is a dental orthodontic bracket, the slidability of the dental orthodontic bracket can be enhanced.

In the dental component according to the aspect of the invention, it is preferable that in an X-ray diffraction pattern obtained by X-ray diffractometry using a Cu-Kα ray, when the height of the highest peak among the peaks derived from Co identified based on ICDD card is assumed to be 1, the height of the highest peak among the peaks derived from Co₃Mo identified based on ICDD card is 0.01 or more and 0.5 or less.

According to this configuration, high hardness and high slidability are imparted to the dental component, and therefore, a useful dental component can be obtained.

In the dental component according to the aspect of the invention, it is preferable that the dental component has a 0.2% proof stress of 500 MPa or more and a Young's modulus of 150 GPa or more.

According to this configuration, when the dental component is a dental orthodontic bracket, the long-term deformation resistance of the dental orthodontic bracket is improved. When the dental component is a dental anchor, a dental anchor capable of continuously applying an appropriate tensile strength to an orthodontic bracket or the like attached to a tooth can be obtained. Therefore, a dental anchor which is capable of selectively moving a specific tooth for a relatively short period of time, and is particularly suitable for orthodontic treatment can be obtained. Further, such a dental anchor is particularly hardly deformed, and therefore, the treatment efficiency for those who provide the orthodontic treatment can be enhanced. When the dental component is a dental implant, for example, the dental implant is hardly deformed during an operation of inserting the dental implant or the dental implant is hardly deformed by mastication, bruxism, or the like. Therefore, a dental implant having higher reliability can be obtained.

In the dental component according to the aspect of the invention, it is preferable that the dental component is a dental orthodontic bracket.

In the dental component according to the aspect of the invention, it is preferable that the dental component is a dental orthodontic bracket, and the dental orthodontic bracket has a Vickers hardness of 200 or more and 550 or less.

According to this configuration, even if a force from an archwire during orthodontic treatment is applied to a tooth over a long period of time, an orthodontic bracket which is hardly deformed can be obtained. As a result, a stress to be exerted on (applied to) a tooth by the archwire can be more strictly controlled over a long period of time. Accordingly, orthodontic treatment can be efficiently performed to achieve desired teeth alignment.

In the dental component according to the aspect of the invention, it is preferable that the dental component is a dental anchor.

In the dental component according to the aspect of the invention, it is preferable that the dental component is a dental anchor, and in a cross section of the dental anchor, when the major axis of a crystal structure of the sintered body is represented by CL and the minor axis thereof is represented by CS, an aspect ratio defined by CS/CL is 0.4 or more and 1 or less.

The crystal structure having such an aspect ratio has small anisotropy, and therefore, the dental anchor formed from a sintered body having such a crystal structure has high mechanical properties such as proof stress regardless of the direction of a force applied. That is, such a dental anchor can serve as an excellent anchorage even if it is used in any posture.

In the dental component according to the aspect of the invention, it is preferable that the dental component is a dental implant.

In the dental component according to the aspect of the invention, it is preferable that the dental component is a dental implant, and in a cross section of the dental implant, when the major axis of a crystal structure of the sintered body is represented by CL and the minor axis thereof is represented by CS, an aspect ratio defined by CS/CL is 0.4 or more and 1 or less.

The crystal structure having such an aspect ratio has small anisotropy, and therefore, the dental implant formed from a sintered body having such a crystal structure has high mechanical properties such as proof stress regardless of the direction of a force applied. That is, such a dental implant has excellent fracture resistance even if it is used in any posture. Due to this, the dental implant is not limited to the place where it is used in the mouth, and therefore is useful.

In the dental component according to the aspect of the invention, it is preferable that the dental component is a dental implant, and the dental implant is provided between the jawbone and a crown restoration, and in the dental implant, the arithmetic average roughness Ra of a part to be in contact with the jaw bone is smaller than the arithmetic average roughness Ra of a part to be in contact with the crown restoration.

According to this configuration, the adhesiveness between the dental implant and a crown restoration can be increased while increasing the efficiency of an operation of inserting the dental implant into the jaw bone. As a result, an artificial tooth having higher reliability can be provided.

A dental alloy material according to another aspect of the invention is formed from a sintered body of a metal powder having particles containing Co, Cr, Mo, and Si as constituent components. In the particles, Co is contained as a main component, the content of Cr is 26% by mass or more and 35% by mass or less, the content of Mo is 5% by mass or more and 12% by mass or less, and the content of Si is 0.3% by mass or more and 2.0% by mass or less.

According to this configuration, a dental alloy material having excellent mechanical properties such as proof stress can be obtained. By using such a dental alloy material, dental components such as a prosthesis which is hardly deformed against, for example, a chewing force or the like, and a component capable of applying a force to a tooth over a long period of time in orthodontic treatment can be produced. Further, since such a dental component has excellent corrosion resistance, even when it is placed in the mouth or inserted into the bone or the like, metal allergy or the like is hardly caused, and the biocompatibility can be enhanced.

A metal powder for powder metallurgy according to still another aspect of the invention includes particles containing Co, Cr, Mo, and Si as constituent components and is used for producing a dental component. In the particles, Co is contained as a main component, the content of Cr is 26% by mass or more and 35% by mass or less, the content of Mo is 5% by mass or more and 12% by mass or less, and the content of Si is 0.3% by mass or more and 2.0% by mass or less.

According to this configuration, a metal powder for powder metallurgy capable of easily producing a dental component having excellent deformation resistance can be obtained.

A method for producing a dental component according to yet another aspect of the invention includes: molding a metal powder having particles containing Co, Cr, Mo, and Si as constituent components by a metal powder injection molding method, thereby obtaining a molded body; and firing the molded body, thereby obtaining a sintered body. In the particles, Co is contained as a main component, the content of Cr is 26% by mass or more and 35% by mass or less, the content of Mo is 5% by mass or more and 12% by mass or less, and the content of Si is 0.3% by mass or more and 2.0% by mass or less.

According to this configuration, a dental component having high proof stress and high corrosion resistance can be easily produced. When the dental component is a dental orthodontic bracket, a dental orthodontic bracket having excellent deformation resistance can be easily produced. When the dental component is a dental anchor, a dental anchor having high proof stress and high corrosion resistance can be easily produced. When the dental component is a dental implant, a dental implant having high fracture resistance, high corrosion resistance, and also high dimensional accuracy can be easily produced.

In the method for producing a dental component according to the aspect of the invention, it is preferable that the dental component is a dental orthodontic bracket.

In the method for producing a dental component according to the aspect of the invention, it is preferable that the dental component is a dental anchor.

In the method for producing a dental component according to the aspect of the invention, it is preferable that the dental component is a dental implant.

### BRIEF DESCRIPTION OF THE DRAWINGS

The invention will be described with reference to the accompanying drawings, wherein like numbers reference like elements.

FIG. 1 is a perspective view showing a first embodiment of a dental component (dental orthodontic bracket) according to the invention and is a view showing a state before supporting an archwire (open state).

FIG. 2 is a perspective view showing the first embodiment of the dental component (dental orthodontic bracket) according to the invention and is a view showing a state of supporting an archwire (closed state).

FIG. 3 is a perspective view showing a state where an auxiliary tool is inserted in a bracket main body of the dental orthodontic bracket shown in FIG. 1.

FIG. 4 is a perspective view showing a state where the auxiliary tool is inserted in the bracket main body shown in FIG. 3.

FIG. 5 is a view when viewing the dental orthodontic bracket in a state shown in FIG. 4 in the extending direction of the archwire.

FIG. 6 is a view showing a state where the dental orthodontic bracket shown in FIG. 1 is attached to a tooth.

FIG. 7 is a front view showing a second embodiment of the dental component (dental anchor) according to the invention.

FIG. 8 is a view for illustrating orthodontic treatment using the dental anchor shown in FIG. 7 and is a view showing an example of a row of teeth before orthodontic treatment.

FIG. 9 is a view for illustrating orthodontic treatment using the dental anchor shown in FIG. 7 and is a view showing an example of a row of teeth after orthodontic treatment.

FIG. 10 is another view for illustrating orthodontic treatment using the dental anchor shown in FIG. 7.

FIGS. 11A to 11E are front views each showing a third embodiment of the dental component (dental implant) according to the invention and a crown restoration to be attached thereto.

FIG. 12 is a vertical cross-sectional view of the two-piece type dental implant shown in FIG. 11B and is a view showing a state where a fixture and an abutment are separated.

FIGS. 13A to 13C are views for illustrating a surgical process (operative procedure) using the dental implant shown in FIG. 12.

FIG. 14 is a graph showing a relationship between the concentration of N and the Vickers hardness in the test pieces of sample Nos. 47 to 53 shown in Table 5.

FIG. 15 is a graph showing a relationship between the concentration of N and the Vickers hardness in the test pieces of sample Nos. 47 to 53 shown in Table 10.

FIG. 16 is a graph showing a relationship between the concentration of N and the Vickers hardness in the test pieces of sample Nos. 47 to 53 shown in Table 15.

### DESCRIPTION OF EXEMPLARY EMBODIMENTS

Hereinafter, the dental component, the metal powder for powder metallurgy, and the method for producing a dental component according to the invention will be described in detail based on preferred embodiments shown in the accompanying drawings.

### Dental Component

Specific examples of the dental component according to the invention include a dental orthodontic bracket to be used in orthodontic treatment for straightening teeth, a dental anchor, and a dental implant to be used in implant treatment for the purpose of restoring the function of a lost tooth. Hereinafter, as preferred embodiments of the dental component according to the invention, a dental orthodontic bracket, a dental anchor, and a dental implant will be described.

### First Embodiment of Dental Component (Dental Orthodontic Bracket)

### Shape

First, a first embodiment of the dental component (dental orthodontic bracket) according to the invention will be described.

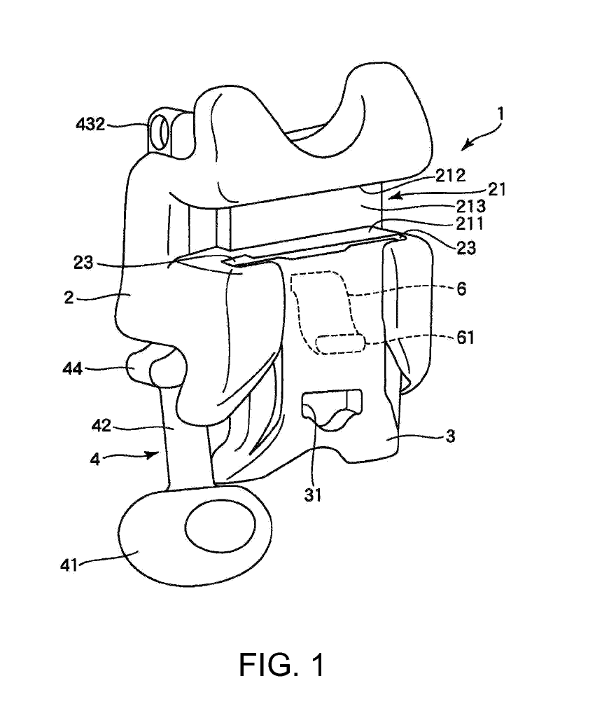

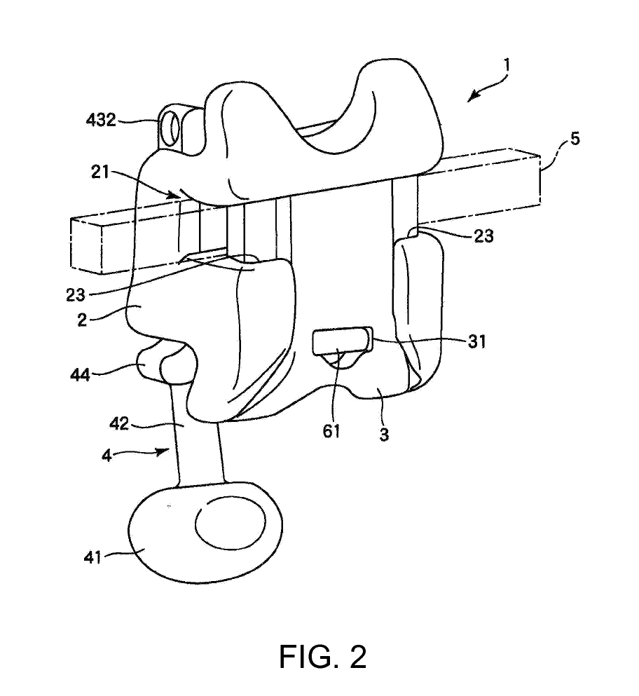

FIG. 1 is a perspective view showing a first embodiment of a dental component (dental orthodontic bracket) according to the invention and is a view showing a state before supporting an archwire (open state). FIG. 2 is a perspective view showing the first embodiment of the dental component (dental orthodontic bracket) according to the invention and is a view showing a state of supporting an archwire (closed state).

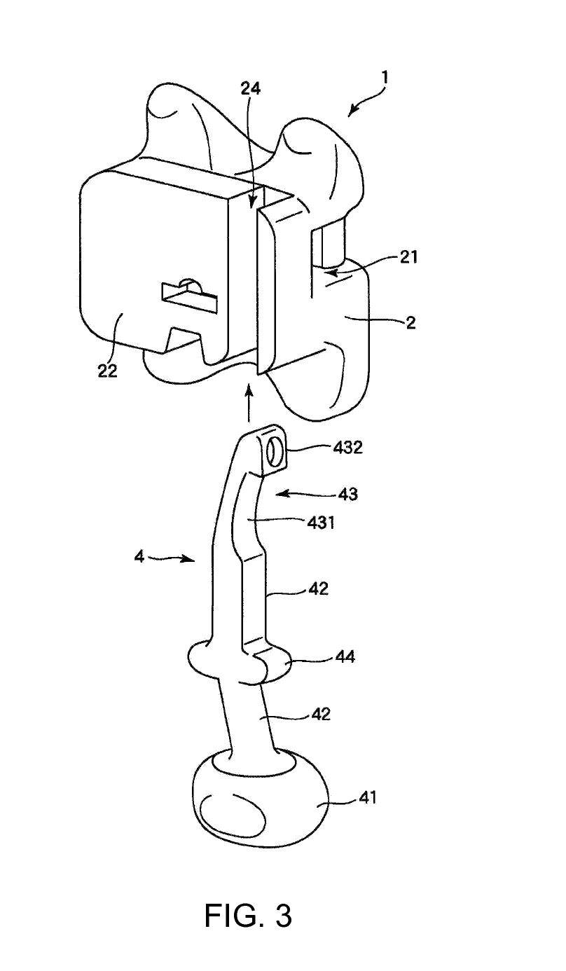

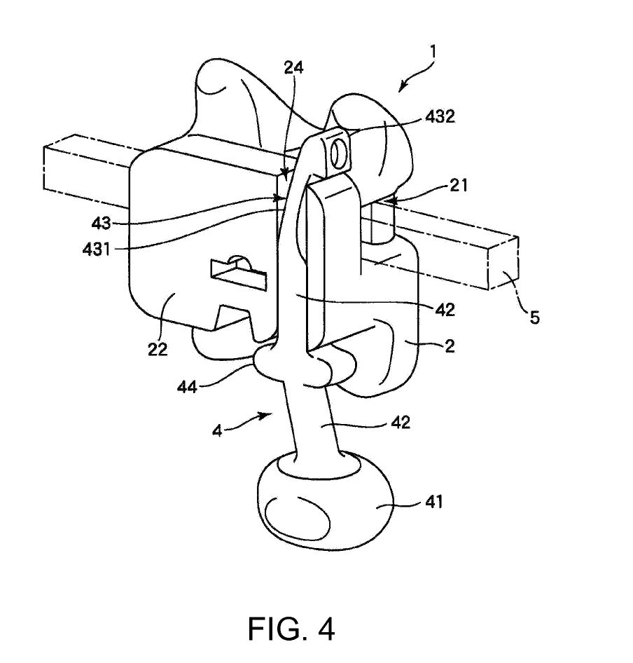

FIG. 3 is a perspective view showing a state where an auxiliary tool is inserted in a bracket main body of the dental orthodontic bracket shown in FIG. 1, and FIG. 4 is a perspective view showing a state where the auxiliary tool is inserted in the bracket main body shown in FIG. 3.

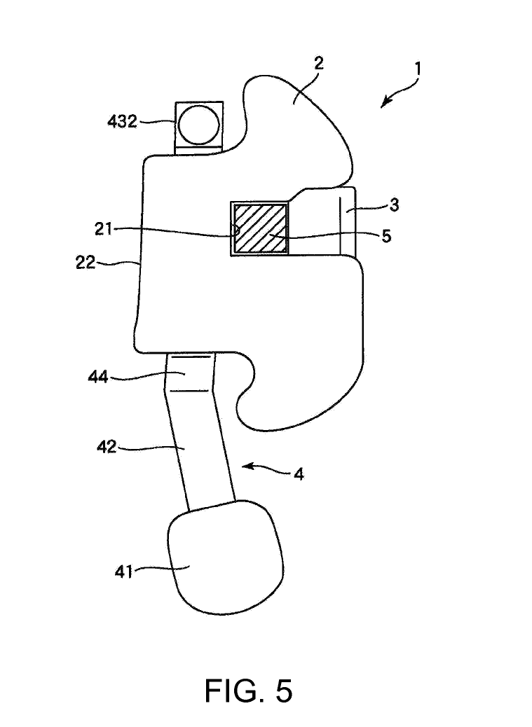

FIG. 5 is a view when viewing the dental orthodontic bracket in a state shown in FIG. 4 in the extending direction of an archwire, and FIG. 6 is a view showing a state where the dental orthodontic bracket shown in FIG. 1 is attached to a tooth.

A dental orthodontic bracket 1 shown in FIG. 1 (hereinafter sometimes abbreviated as “bracket 1”) is a member which is attached to each tooth 7 (see FIG. 6) to be straightened, and includes a bracket main body 2, a ligature cover 3, an auxiliary tool 4, and a spring arm 6. Hereinafter, the respective members of the bracket 1 will be described in detail sequentially.

The bracket main body 2 is a block body having two principal surfaces with a size slightly smaller than the front surface of a tooth 7. The bracket main body 2 has an archwire slot 21 formed from a groove opening to one of the two principal surfaces. In this archwire slot 21, an archwire 5 is inserted. The bracket is configured such that an appropriate frictional resistance occurs between the archwire slot 21 and the archwire 5, and also the archwire 5 is supported by the archwire slot 21. According to this, a force can be applied to the tooth 7 by the archwire 5 through the bracket 1, and by moving the tooth 7, orthodontic treatment can be performed.

When the bracket 1 is attached to the tooth 7, the archwire 5 is disposed substantially parallel to the row of teeth. Therefore, the archwire slot 21 is configured to extend substantially parallel to the row of teeth.

The archwire slot 21 is formed from a groove defined by a pair of facing side walls 211 and 212, and a side wall 213 connecting the side walls 211 and 212 to each other. When the archwire 5 is inserted in this archwire slot 21 as shown in FIGS. 2 and 5, a given frictional resistance occurs between the archwire 5 and the respective side walls 211, 212, and 213.

On the other hand, the bracket main body 2 includes a bonding base 22 provided on the other principal surface of the two principal surfaces. The bonding base 22 is a part formed by flattening a portion of the other principal surface of the bracket main body 2. By adhering this bonding base 22 to the front surface of a tooth, the bracket main body 2 can be attached to the tooth 7.

As an adhering method, for example, a dental cement, an adhesive, or the like is used. Incidentally, the bracket main body 2 may be attached not to the front surface of the tooth 7, but to the rear surface thereof.

Further, the bracket main body 2 includes a cover slot 23 capable of inserting the ligature cover 3 therein. In the cover slot 23, the ligature cover 3 (described below) can be inserted in a sliding manner. The cover slot 23 is configured such that the bracket can be put into an open state where the archwire slot 21 is open as shown in FIG. 1 and into a closed state where the ligature cover 3 moves so as to close the opening of the archwire slot 21.

The spring arm 6 is provided in the cover slot 23. When the ligature cover 3 is inserted in the cover slot 23, a tip portion 61 of the spring arm 6 is pressed against the surface of the ligature cover 3 by the elastic force of the spring arm 6.

The ligature cover 3 has a plate shape and is configured to slide parallel to one of the principal surfaces of the bracket main body 2 into and out from the cover slot 23.

Further, the ligature cover 3 includes a through-hole 31 formed passing therethrough. When the ligature cover 3 is in a closed state, the tip portion 61 of the spring arm 6 fits in the through-hole 31 of the ligature cover 3 as shown in FIG. 2. According to this, the ligature cover 3 is fixed in a closed state.

When the ligature cover 3 is in a closed state, the archwire slot 21 is formed from a hole defined by the respective side walls 211, 212, and 213, and the ligature cover 3. Therefore, the almost entire side surface of the archwire 5 inserted in the archwire slot 21 comes in contact with the inner surface of the hole. Due to this, the contact area between the archwire 5 and the bracket 1 can be increased, and therefore, a frictional resistance can be efficiently caused between the archwire 5 and the bracket 1 and also the state of the inner surface of the hole of the bracket 1 can be efficiently reflected in the operability of the archwire 5.

The bracket main body 2 further includes a tool slot 24 capable of inserting the auxiliary tool 4 therein. In the tool slot 24, the auxiliary tool 4 (described later) can be inserted. The tool slot 24 is formed by a groove which opens to the other principal surface of the two principal surfaces of the bracket main body 2.

The auxiliary tool 4 includes a head 41, a shank 42 extending from the head 41, an engaging portion 43 provided for the shank 42 on the opposite side from the head 41 (hereinafter referred to as “on the tip side”), and a flange 44 provided on a portion of the shank 42.

The head 41 shown in FIG. 3 has a substantially spherical shape. This head is a part intended to be held by a dentist in orthodontic treatment.

The shank 42 is a slightly curved rod-shaped part.

The engaging portion 43 includes a shank portion 431 which is provided on the tip side of the shank 42 and has a smaller diameter than the shank 42 and a protrusion portion 432 which is provided on the tip side of the shank portion 431 so as to protrude from one side surface of the shank portion 431.

The flange 44 is apart formed by partially enlarging the outer diameter of the shank 42.

When such an auxiliary tool 4 is inserted in the tool slot 24 provided in the bracket main body 2, as shown in FIG. 4, the protrusion portion 432 of the engaging portion 43 is engaged with the tip portion of the tool slot 24. According to this, the auxiliary tool 4 is fixed in the extending direction of the tool slot 24.

Since the shank 42 is slightly curved, when the auxiliary tool 4 is inserted in the tool slot 24, the outer surface of the shank 42 comes in contact with the side wall of the tool slot 24. According to this, the auxiliary tool 4 is fixed also in the direction orthogonal to the extending direction of the tool slot 24.

By fixing the auxiliary tool 4 to the bracket main body 2 in this manner, a dentist can operate the entire bracket 1 by holding the auxiliary tool 4. According to this, even when the bracket main body 2 is small and a portion which can be held is extremely small, the bracket 1 can be easily held. As a result, fine alignment or the like of the bracket 1 can be easily performed, and a treatment operation of a dentist can be facilitated, and also the bracket 1 can be attached more accurately to a desired position on the tooth 7.

The bracket 1 may be used in orthodontic treatment in a state where the auxiliary tool 4 is inserted in the tool slot 24 or in a state where the auxiliary tool 4 is removed from the tool slot 24.

The archwire 5 is used such that it is inserted in the archwire slot 21 of the bracket 1 attached to each of the multiple teeth 7 so as to connect the multiple brackets 1 to one another. According to this, orthodontic treatment can be performed by applying a force to each tooth 7 through the bracket 1 by the archwire 5.

The constituent material of the archwire 5 is not particularly limited, and examples thereof include Ti, a Ti-based alloy, an Ni—Ti-based alloy, and stainless steel.

The horizontal cross-sectional shape of the archwire 5 may be a circle, but is preferably a polygon such as a rectangle or a hexagon, more preferably a rectangle. According to this, the control of the frictional resistance between the archwire 5 and the bracket 1 is facilitated, and thus, a stress to be exerted on the tooth 7 can be easily controlled.

The shape of the bracket 1 as described above is merely a shape of an embodiment of the invention and is not limited to the configuration shown in the drawing. For example, the bracket 1 having the above-described shape is used mainly in a self-ligating system, however, the dental orthodontic bracket according to the invention is not limited to a bracket for use in such a system, and can be applied to brackets having various shapes such as brackets used in orthodontic systems in the related art. Also in this case, the deformation of the bracket can be prevented, and therefore, the advantageous effects of the invention can be exhibited.

### Constituent Materials

Next, the constituent materials of the dental orthodontic bracket 1 will be described.

The bracket 1 is formed from a Co—Cr—Mo—Si-based alloy.

Specifically, the alloy which forms the bracket 1 contains Co as a main component, and has a Cr content of 26% by mass or more and 35% by mass or less, a Mo content of 5% by mass or more and 12% by mass or less, and a Si content of 0.3% by mass or more and 2.0% by mass or less.

The bracket 1 formed from such an alloy has high deformation resistance. Therefore, the bracket 1 which is hardly deformed even if a force is applied over a long period of time or the strength of a force applied is repeatedly changed can be obtained. Such a bracket 1 contributes to the reduction in time required for orthodontic treatment and also the enhancement of treatment efficiency for those who provide the orthodontic treatment.

Further, the bracket 1 formed from such an alloy has appropriate slidability for the archwire 5. In other words, the bracket 1 has an appropriate frictional resistance with the archwire 5. Due to this, even when a tooth moves as the orthodontic treatment proceeds, a force applied to the tooth through the bracket 1 by the archwire 5 is hardly changed. As a result, it is not necessary to frequently adjust a torque applied to the bracket 1 by the archwire 5, and the time required for orthodontic treatment can be reduced, and also a burden on a patient can be reduced.

Further, the bracket 1 formed from such an alloy has high hardness and high Young's modulus. Therefore, the bracket 1 is hardly deformed even when a force is applied by the archwire 5 for a long period of time in orthodontic treatment. As a result, a stress to be exerted on the tooth 7 by the archwire 5 can be more strictly controlled over along period of time, and thus, orthodontic treatment can be efficiently performed to achieve desired teeth alignment.

Further, the bracket 1 is formed from a sintered body of a metal powder having particles containing a Co—Cr—Mo—Si-based alloy. That is, the bracket 1 is produced by sintering such a metal powder using a powder metallurgy method. According to the powder metallurgy method, it is easy to approximate the shape of the bracket 1 to a desired shape, and therefore, the bracket 1 having high dimensional accuracy can be obtained. Due to this, a frictional resistance as designed can be caused with respect to the archwire 5, and thus, a stress to be exerted on the tooth 7 can be more easily and strictly controlled.

Further, in such a bracket 1 (the sintered body which forms the bracket 1), the crystal particle diameter of the metal structure thereof is small and the isotropy thereof is high. Therefore, the bracket 1 having high deformation resistance against a force from all directions can be obtained.

In this embodiment, strictly, the bracket 1 can be obtained by separately producing the bracket main body 2, the ligature cover 3, and the auxiliary tool 4 by a powder metallurgy method and assembling these members.

Here, among the constituent elements of this alloy, Co (cobalt) is a main component of the alloy which forms the bracket 1, and has a great effect on the basic properties of the bracket 1.

The content of Co is set to be the largest of the constituent elements of this alloy, and specifically the content of Co is preferably 50% by mass or more and 67.5% by mass or less, more preferably 55% by mass or more and 67% by mass or less.

Cr (chromium) mainly acts to improve the corrosion resistance of the bracket 1. It is considered that this is because by the addition of Cr, a passivation film (such as Cr₂O₃) is easily formed on the alloy, and thus, the chemical stability is improved. By the improvement of the corrosion resistance, an effect that metal ions are hardly eluted even when the alloy comes in contact with, for example, a body fluid is expected. Therefore, the bracket 1 formed from an alloy containing Cr has more excellent compatibility with a living body. Further, by using Cr along with Co, Mo, and Si, the mechanical properties of the bracket 1 can be further enhanced.

The content of Cr in the alloy which forms the bracket 1 is set to 26% by mass or more and 35% by mass or less. If the content of Cr is less than the above lower limit, the corrosion resistance of the bracket 1 is deteriorated. Therefore, in the case where the bracket 1 is in contact with a body fluid over a long period of time, a large amount of metal ions may be eluted. On the other hand, if the content of Cr exceeds the above upper limit, the amount of Cr with respect to Mo or Si is relatively too large, and therefore, the surface state of the bracket 1 is changed. Due to this, the slidability for the archwire 5 may be deteriorated. In addition, the balance thereof with Co, Mo, or Si is lost so that the mechanical properties are deteriorated.

The content of Cr is set to preferably 27% by mass or more and 34% by mass or less, more preferably 28% by mass or more and 33% by mass or less.

Mo (molybdenum) mainly acts to enhance the corrosion resistance of the bracket 1. That is, by the addition of Mo, the corrosion resistance improved by the addition of Cr can be further enhanced. It is considered that this is because by the addition of Mo, the passivation film containing a Cr oxide as a main material is further densified. Therefore, the Mo-added alloy is more difficult to elute metal ions, and thus, the bracket 1 having particularly high compatibility with a living body can be obtained.

The content of Mo in the alloy which forms the bracket 1 is set to 5% by mass or more and 12% by mass or less. If the content of Mo is less than the above lower limit, the corrosion resistance of the bracket 1 may be insufficient. On the other hand, if the content of Mo exceeds the above upper limit, the amount of Mo with respect to Cr or Si is relatively too large, and therefore, the surface state of the bracket 1 is changed. Due to this, the slidability for the archwire 5 may be deteriorated. In addition, the balance thereof with Co, Cr, or Si is lost so that the mechanical properties are deteriorated.

The content of Mo is set to preferably 5.5% by mass or more and 11% by mass or less, more preferably 6% by mass or more and 9% by mass or less.

Si (silicon) acts to enhance the slidability of the bracket 1 for the archwire 5. By the addition of Si, silicon oxide is formed by oxidizing a part of Si in the bracket 1 (the sintered body which forms the bracket 1). Examples of the silicon oxide include SiO and SiO₂. It is considered that when such silicon oxide is formed in the bracket 1, the frictional resistance with the archwire 5 is decreased so that the slidability is enhanced.

Si also acts to enhance the mechanical properties of the bracket 1. The above-described silicon oxide prevents a significant increase in size of a metal crystal when the metal crystal grows in the production of the bracket 1. Due to this, in the Si-added alloy, the particle diameter of the metal crystal is suppressed to be small, and thus, the mechanical properties of the bracket 1 can be further enhanced. In particular, by substituting a Co atom with a Si atom as a substitutional element, the crystal structure is slightly distorted so that the Young's modulus is increased. Therefore, by the addition of Si, the bracket 1 can achieve both excellent slidability and excellent mechanical properties, particularly excellent Young's modulus. As a result, the bracket 1 having higher deformation resistance can be obtained.

In order to obtain the effect as described above, it is necessary to set the content of Si to 0.3% by mass or more and 2.0% by mass or less. If the content of Si is less than the above lower limit, the amount of silicon oxide present in the bracket 1 is decreased, and therefore, the frictional resistance with the archwire 5 is increased to deteriorate the slidability. Further, the size of a metal crystal is liable to increase in the production of the bracket 1, and therefore, a possibility that the mechanical properties of the bracket 1 are also deteriorated is increased. On the other hand, if the content of Si exceeds the above upper limit, the amount of silicon oxide present in the bracket 1 is too large, and a region where silicon oxide is spatially distributed in a continuous manner is liable to be formed in the bracket 1. In such a region, the frictional resistance with the archwire 5 is decreased.

The content of Si is set to preferably 0.5% by mass or more and 1.0% by mass or less, more preferably 0.6% by mass or more and 0.9% by mass or less.

Further, apart of Si in the sintered body which forms the bracket 1 preferably exists in the form of silicon oxide as described above. In particular, the ratio of the content of Si contained as silicon oxide to the total content of Si in the sintered body which forms the bracket 1 is preferably 20% or more and 80% or less, more preferably 30% or more and 70% or less, further more preferably 35% or more and 65% or less. By setting the ratio of the content of Si contained as silicon oxide to the total content of Si contained in the bracket 1 within the above range, the mechanical properties of the bracket 1 are improved. Further, by the existence of a given amount of silicon oxide in the bracket 1, the amount of oxides of transition metal elements such as Co, Cr, and Mo contained in this bracket 1 can be sufficiently reduced. That is, Si is more easily oxidized than Co, Cr, and Mo, and deprives oxygen bonded to these transition metal elements to cause a reduction reaction. Therefore, it is considered that the fact that not the total amount of Si in the sintered body which forms the bracket 1 is Si contained as silicon oxide means that a sufficient amount of Si is present in the sintered body, and therefore, a sufficient reduction reaction is caused with respect to the transition metal elements. Accordingly, by setting the ratio of the content of Si contained as silicon oxide to the total content of Si in the sintered body which forms the bracket 1 within the above range, in the bracket 1, the effect such as high slidability and high mechanical properties as described above are prevented from being inhibited by an oxide of Co, Cr, or Mo. As a result, the bracket 1 having higher reliability can be obtained.

Further, by setting the ratio of the content of Si contained as silicon oxide to the total content of Si in the sintered body which forms the bracket 1 within the above range, appropriate hardness and slidability are imparted to the bracket 1. That is, by the existence of a given amount of Si which is not in the form of silicon oxide in the bracket 1, Si and at least one element selected from Co, Cr, and Mo produce a hard intermetallic compound. Accordingly, it is considered that the hardness and slidability of the bracket 1 are enhanced. By increasing the hardness of the bracket 1, even when a force is applied to the bracket 1 by the archwire 5 over a long period of time in orthodontic treatment, the deformation of the bracket 1 can be prevented. As a result, a stress to be exerted on the tooth 7 by the archwire 5 can be more strictly controlled over a long period of time, and thus, orthodontic treatment can be performed to achieve desired teeth alignment. Further, by enhancing the slidability for the archwire 5, a stress to be exerted on the tooth 7 by the archwire 5 can be more easily and strictly controlled.

Incidentally, by the addition of Si, significant growth of a metal crystal in the sintered body which forms the bracket 1 is inhibited, and therefore, from this point of view, the hardness of the bracket 1 tends to be decreased. However, it is considered that a part of Si forms an intermetallic compound, and therefore, a significant decrease in the hardness is prevented, and a hardness and a toughness are obtained to such an extent that the deformation of the bracket 1 is prevented.

This intermetallic compound is not particularly limited, however, examples thereof include CoSi₂, Cr₃Si, MoSi₂, and Mo₅Si₃.

In consideration of the deposition amount of the intermetallic compound, the ratio of the content of Si to the content of Mo (Si/Mo) is preferably 0.05 or more and 0.2 or less, more preferably 0.08 or more and 0.15 or less in terms of mass ratio. According to this, the bracket 1 can achieve both high slidability for the archwire 5 and high mechanical properties.

Silicon oxide may be distributed at any place, but is preferably distributed in a segregated manner at the grain boundary (the boundary surface between metal crystals). By segregating silicon oxide at such a place, an increase in size of a metal crystal can be more reliably prevented, and thus, the bracket 1 having more excellent mechanical properties can be obtained. Further, deposits of silicon oxide segregated at the grain boundary keep a proper distance from one another by themselves, and therefore, the deposits of silicon oxide can be more uniformly dispersed in the bracket 1. As a result, the frictional resistance on the contact surface between the archwire slot 21 and the archwire 5 becomes constant, and therefore, when a force is applied to the bracket 1 by the archwire 5, it is prevented that the force is effectively applied to the bracket or the force is not effectively applied to the bracket 1 due to sliding between the contact surfaces, and thus, a force can be efficiently applied to the tooth 7 with a given correlation with respect to a force applied to the archwire 5. Accordingly, orthodontic treatment can be performed to achieve desired teeth alignment in a shorter period of time.

The deposits of segregated silicon oxide can be analyzed to specify the size, distribution, and the like thereof by an area analysis of a qualitative analysis. Specifically, in a compositional image of Si obtained by an electron beam microanalyzer (EPMA), an average diameter of a region where Si is segregated is preferably 0.1 μm or more and 10 μm or less, more preferably 0.3 μm or more and 8 μm or less. When the average diameter of a region where Si is segregated is within the above range, the size of the deposit of silicon oxide becomes most suitable for exhibiting the respective effects as described above. That is, if the average diameter of a region where Si is segregated is less than the above lower limit, the deposits of silicon oxide are not segregated in a region having a sufficient size, and the above-described respective effects may not be sufficiently obtained. On the other hand, if the average diameter of a region where Si is segregated exceeds the above upper limit, the mechanical properties of the bracket 1 may be deteriorated.

The average diameter of a region where Si is segregated can be determined as an average of the diameter of a circle having the same area (projected area circle equivalent diameter) as that of the region where Si is segregated in the compositional image of Si.

Further, the bracket 1 includes a first phase formed mainly from Co and a second phase formed mainly from Co₃Mo. By including the second phase of these phases, high hardness and high slidability are imparted to the bracket 1 in the same manner as the intermetallic compound containing Si described above, and therefore, a useful bracket 1 from the viewpoint of improvement of the reliability can be obtained. On the other hand, in the case where the second phase is included excessively, the second phase is liable to be significantly segregated, and thus, the mechanical properties are deteriorated.

Therefore, it is preferred that the first phase and the second phase are included at an appropriate ratio from the above point of view. Specifically, for the bracket 1, a crystal structure analysis is performed by X-ray diffractometry using a Cu-Kα ray, and when the height of the highest peak among the peaks derived from Co is assumed to be 1, the height of the highest peak among the peaks derived from Co₃Mo is preferably 0.01 or more and 0.5 or less, more preferably 0.02 or more and 0.4 or less.

If the height of the highest peak of Co₃Mo when the height of the highest peak of Co is assumed to be 1 is less than the above lower limit, the ratio of Co₃Mo to Co in the bracket 1 is decreased, and therefore, the hardness and slidability of the bracket 1 may be decreased. On the other hand, if the height of the highest peak of Co₃Mo exceeds the above upper limit, the abundance of Co₃Mo is too large, and therefore, Co₃Mo is liable to be significantly segregated so that the mechanical properties of the bracket 1 are decreased and also the slidability may be decreased.

The Cu-Kα ray is generally a characteristic X-ray with an energy of 8.048 keV.

Further, when a peak derived from Co is identified, the identification is performed based on the database of Co of ICDD (The International Centre for Diffraction Data) card. Similarly, when a peak derived from Co₃Mo is identified, the identification is performed based on the database of Co₃Mo of ICDD card.

The abundance ratio of Co₃Mo in the bracket 1 is preferably 0.01% by mass or more and 10% by mass or less, more preferably 0.05% by mass or more and 5% by mass or less. According to this, the hardness and slidability of the bracket 1 can be further increased.

The abundance ratio of these components can be obtained by quantification of the abundance ratio of Co₃Mo from the results of the crystal structure analysis.

The alloy which forms the bracket 1 may contain N (nitrogen) other than the elements described above. N mainly acts to enhance the mechanical properties of the bracket 1. N is an austenitizing element, and therefore accelerates the austenitization of the crystal structure of the bracket 1 and acts to enhance the toughness.

By the incorporation of N, the formation of a dendrite phase in the sintered body which forms the bracket 1 is prevented, and the content of the dendrite phase becomes very small. Therefore, also from this point of view, the toughness can be enhanced.

The bracket 1 containing N has appropriate hardness and high toughness, and also can decrease the content of the dendrite phase. Accordingly, the slidability of the bracket 1 can be improved.

Here, the dendrite phase is a dendritically grown crystal structure, and if a large amount of such a dendrite phase is contained, the mechanical properties and slidability of the bracket 1 are deteriorated. Therefore, the reduction of the content of the dendrite phase is effective in the enhancement of the mechanical properties and slidability of the bracket 1. Specifically, the bracket 1 is observed with a scanning electron microscope, and in the obtained observation image, the ratio of the area occupied by the dendrite phase is preferably 20% or less, more preferably 10% or less. The bracket 1 satisfying such conditions has particularly high mechanical properties and slidability.

The bracket 1 is formed from a sintered body of a metal powder as described above. The metal powder has a high cooling rate and also has high cooling uniformity since the volume of each metal powder particle is very small. Therefore, in the bracket 1 formed from a sintered body of such a metal powder, the formation of a dendrite phase is prevented. On the other hand, in the method in the related art such as casting, forging, or rolling, when a molten metal is cooled, the volume to be cooled is larger than that of the powder, and therefore, the cooling rate is low and also the cooling uniformity is low. As a result, it is considered that in a bracket produced by such a method, a relatively large amount of a dendrite phase is formed.

The area ratio described above is calculated as a ratio of the area occupied by the dendrite phase to the area of the observation image, and the length of one side of the observation image is set to about 50 μm or more and 1000 μm or less.

In order to obtain the effect as described above, it is necessary to set the content of N to preferably 0.09% by mass or more and 0.5% by mass or less. If the content of N is less than the above lower limit, the austenitization of the crystal structure of the bracket 1 is insufficient, and therefore, the hardness of the bracket 1 is excessively increased so that also the toughness may be liable to be decreased. It is considered that this is because in the bracket 1, other than the austenite phase (γ phase), a large amount of an hcp structure (ε phase) is deposited. As a result, the mechanical properties and slidability of the bracket 1 may be deteriorated. On the other hand, if the content of N exceeds the above upper limit, various nitrides are produced in a large amount, and also the composition may make sintering difficult. Therefore, the sintered density of the bracket 1 is decreased so that the mechanical properties may be deteriorated. Examples of the produced nitrides include Cr₂N. If such a nitride is deposited, the hardness is also increased, and thus, the toughness is decreased also in this case.

The content of N is set to preferably 0.12% by mass or more and 0.4% by mass or less, more preferably 0.14% by mass or more and 0.25% by mass or less, further more preferably 0.15% by mass or more and 0.22% by mass or less.

In particular, when the content of N is within the range of 0.15% by mass or more and 0.22% by mass or less, the austenite phase becomes particularly dominant, and a significant decrease in hardness and a remarkable improvement of toughness are observed. When the bracket 1 at this time is subjected to a crystal structure analysis by X-ray diffractometry using a Cu-Kα ray, a main peak derived from the austenite phase is very strongly observed. On the other hand, the heights of the peak derived from the hcp structure and the other peaks are all 5% or less of the height of the main peak. This proves that the austenite phase is dominant.

The ratio of the content of N to the content of Si (N/Si) is preferably 0.1 or more and 0.8 or less, more preferably 0.2 or more and 0.6 or less in terms of mass ratio. According to this, both high mechanical properties and high slidability can be achieved. That is, by the addition of Si in a given amount, as described above, the slidability is increased, however, when the addition amount of Si is too large, the mechanical properties of the bracket 1 may be deteriorated. By adding N at a ratio within the above range, the high slidability obtained by the addition of Si and the above-described effect obtained by the addition of N can be exhibited without cancelling out each other, and therefore, the slidability can be synergistically improved. It is considered that this is because while metal elements such as Si and Co form a substitutional solid solution, metal elements such as N and Co form an interstitial solid solution, and therefore, these metal elements can coexist with one another. Moreover, it is considered that the distortion of the crystal structure due to the solid solution of Si is suppressed by the solid solution of N. Accordingly, it is considered that the deterioration of the mechanical properties is prevented.

Further, when Si is added, a distortion occurs in the crystal structure as described above, however, in this state, a hysteresis is likely to occur in the behavior of thermal expansion and thermal contraction. If a large hysteresis occurs in the behavior of thermal expansion and thermal contraction, the thermal properties of the bracket 1 may change over time.

On the other hand, by the addition of N at the above-described ratio, N is interstitially solid-dissolved in the crystal structure, and therefore, the distortion of the crystal structure is suppressed. As a result, a hysteresis in the behavior of thermal expansion and thermal contraction is prevented so that the thermal properties of the bracket 1 can be stabilized.

Accordingly, by the addition of Si and N in an appropriate amount, the slidability of the bracket 1 can be enhanced, and also the mechanical properties and thermal properties can be stabilized.

If the ratio of the content of N to the content of Si is less than the above lower limit, the distortion of the crystal structure cannot be sufficiently suppressed, and thus, the toughness and the like may be deteriorated. On the other hand, if the ratio thereof exceeds the above upper limit, the composition makes sintering difficult, and thus, the sintered density of the bracket 1 is decreased and also the mechanical properties may be deteriorated.

The alloy which forms the bracket 1 may contain C (carbon) other than the elements described above. By the addition of C, the hardness and tensile strength of the bracket 1 are further increased, and also the slidability is further enhanced. A detailed reason why the slidability is further enhanced is not clear, but one of the reasons is considered that due to the formation of a carbide, the frictional resistance with the archwire 5 is decreased.

The content of C in the alloy which forms the bracket 1 is not particularly limited, but is preferably 1.5% by mass or less, more preferably 0.7% by mass or less. If the content of C exceeds the above upper limit, the brittleness of the bracket 1 is increased so that the mechanical properties may be deteriorated.

The lower limit of the addition amount of C is not particularly limited, however, in order to sufficiently exhibit the above-described effect, the lower limit is preferably set to about 0.05% by mass.

The content of C is preferably about 0.02 times or more and 0.5 times or less, more preferably about 0.05 times or more and 0.3 times or less of the content of Si. It is considered that by setting the ratio of the content of C to the content of Si within the above range, these components synergistically act to improve the slidability while minimizing the adverse effect of silicon oxide or a carbide on the mechanical properties of the bracket 1. Due to this, the bracket 1 having particularly excellent slidability for the archwire 5 can be obtained.

The content of N is preferably about 0.3 times or more and 10 times or less, more preferably about 2 times or more and 8 times or less of the content of C. By setting the ratio of the content of N to the content of C within the above range, particularly, both of the improvement of the slidability of the bracket 1 by the addition of C and the improvement of the slidability of the bracket 1 by the addition of N can be achieved. Further, excessive sliding is prevented, and the torque from the archwire 5 is easily transferred to the bracket 1. As a result, in orthodontic treatment, a force of a desired magnitude can be applied to each tooth, and thus, a time required for orthodontic treatment can be decreased.

In addition, the alloy which forms the bracket 1 may contain, other than the elements described above, impurities inevitably generated during the production. In this case, the total content of the impurities is set to preferably 1% by mass or less, more preferably 0.5% by mass or less, further more preferably 0.2% by mass or less. Examples of such impurity elements include B, O, Na, Mg, Al, P, S, and Mn.

On the other hand, it is preferred that the alloy which forms the bracket 1 does not substantially contain Ni (nickel). Ni is often contained in a given amount in a bracket in the related art for ensuring plastic workability. However, Ni is sometimes treated as a causative substance of metal allergy and is an element suspected to have an adverse effect on a living body. To the alloy which forms the bracket 1, Ni is not added as a constituent element except for Ni inevitably mixed therein during the production. Therefore, the bracket 1 according to the invention hardly causes metal allergy, and thus has particularly high compatibility with a living body. Incidentally, in consideration of a case where Ni is inevitably mixed therein, the content of Ni is preferably 0.05% by mass or less, more preferably 0.03% by mass or less.

The remainder of the alloy which forms the bracket 1 other than the elements described above is Co. As described above, the content of Co is set to be the largest of the elements contained in the alloy which forms the bracket 1.

The respective constituent elements of the alloy which forms the bracket 1 and the compositional ratio thereof can be determined by, for example, atomic absorption spectrometry specified in JIS G 1257, ICP optical emission spectroscopy specified in JIS G 1258, spark optical emission spectroscopy specified in JIS G 1253, X-ray fluorescence spectroscopy specified in JIS G 1256, gravimetry, titrimetry, and absorption spectroscopy specified in JIS G 1211 to G 1237, or the like. Specifically, an optical emission spectrometer for solids (spark optical emission spectrometer) manufactured by SPECTRO Analytical Instruments GmbH (model: SPECTROLAB, type: LAVMB08A) can be used.

Further, when C (carbon) and S (sulfur) are determined, particularly, an infrared absorption method after combustion in a current of oxygen (after combustion in a high-frequency induction furnace) specified in JIS G 1211 is also used. Specifically, a carbon-sulfur analyzer, CS-200 manufactured by LECO Corporation can be used.

Further, when N (nitrogen) and O (oxygen) are determined, particularly, a method for determination of nitrogen content in iron and steel specified in JIS G 1228 and a method for determination of oxygen content in metallic materials specified in JIS Z 2613 are also used. Specifically, an oxygen-nitrogen analyzer, TC-300/EF-300 manufactured by LECO Corporation can be used.

The bracket 1 shown in FIG. 1 is a member formed from a sintered body of a metal powder as described above, that is, it is a member produced by a powder metallurgy method. The mechanical properties of such a bracket 1 are improved as compared with a member produced by, for example, a casting method. The bracket 1 produced by a powder metallurgy method is a member produced by using a metal powder obtained by quenching (since the volume is small, it is easily quenched), and therefore, significant grain growth of a metal crystal is more difficult to occur than in the case of using a casting method or the like. As a result, it is considered that it is difficult to form a metal crystal with an increased size in the bracket 1, and thus, the mechanical properties of the bracket 1 are improved. Further, according to the powder metallurgy method, a homogeneous composition is easily obtained, and therefore, uniform distribution of Si and silicon oxide is also easily obtained. Accordingly, the bracket 1 having uniform slidability (an individual difference in slidability is small) can be obtained.

When the bracket 1 contains N, it is preferred that N is solid-dissolved in a material from the time when the metal powder is produced, and the bracket is formed from a sintered body obtained by using the powder. In the bracket 1 produced in this manner, N is substantially uniformly distributed, and therefore, the physical properties of the entire bracket 1 can be made substantially uniform. Accordingly, such a bracket 1 has high homogeneity, and also an individual difference is prevented, and thus, a stress to be exerted on multiple teeth 7 can be appropriately controlled respectively.

It is considered that the reason why such a homogeneous bracket 1 is obtained is because as described above, N is solid-dissolved in the metal material from the time when the powder is produced, and the bracket is formed from a sintered body produced by a powder metallurgy method using the powder. In order to solid-dissolve N in the metal material at the time when the powder is produced, for example, a method in which at least one element selected from Co, Cr, Mo, and Si contained in the starting material is nitrided in advance, a method in which a molten metal (a metal melt) is maintained in a nitrogen gas atmosphere when or after the starting material is melted, a method in which nitrogen gas is injected (bubbled) in a molten metal, or the like is used.

Further, there is also a method in which a molded body obtained by molding the metal powder or a sintered body obtained by sintering the molded body is heated in a nitrogen gas atmosphere or is subjected to an HIP treatment in a nitrogen gas atmosphere, whereby the alloy is impregnated with nitrogen (a nitriding treatment). However, in this method, it is difficult to uniformly nitride the molded body or the sintered body from a surface layer region to an inner layer region. Supposedly, in the case of performing a nitriding treatment, it is necessary to perform the treatment over an extremely long period of time while controlling the nitriding speed, and therefore, the method is a little problematic from the viewpoint of production efficiency of the bracket.

When the molded body obtained by solid-dissolving N in the powder is degreased and fired, a variation in the concentration of solid-dissolved N can be suppressed by performing degreasing and firing in an inert gas such as nitrogen gas or argon gas.

As the metal powder (metal powder for powder metallurgy according to the invention) to be used for the production of the bracket 1, a powder formed from the alloy as described above is used. The average particle diameter thereof is preferably 3 μm or more and 100 μm or less, more preferably 4 μm or more and 80 μm or less, further more preferably 5 μm or more and 60 μm or less. By using a metal powder having such a particle diameter, the bracket 1 having high density, high mechanical properties, and excellent slidability can be produced.

The average particle diameter is obtained as a particle diameter when the cumulative amount on a mass basis from the smaller particle diameter side in the particle size distribution obtained by laser diffractometry is 50%.

If the average particle diameter of the metal powder is less than the above lower limit, the moldability in powder metallurgy is deteriorated, and therefore, the density of the bracket 1 is decreased so that the mechanical properties may be deteriorated. On the other hand, if the average particle diameter of the metal powder exceeds the above upper limit, the packing density of the metal powder in powder metallurgy is decreased, and therefore, also in this case, the density of the bracket 1 is decreased so that the mechanical properties may be deteriorated. Further, the uniformity of the composition is deteriorated so that the slidability of the bracket 1 for the archwire 5 may be deteriorated.

The particle size distribution of the metal powder is preferably as narrow as possible. Specifically, when the average particle diameter of the metal powder is within the above range, the maximum particle diameter is preferably 200 μm or less, more preferably 150 μm or less. By controlling the maximum particle diameter of the metal powder within the above range, the particle size distribution of the metal powder can be made narrower. According to this, the mechanical properties and slidability of the bracket 1 can be further improved.

Here, the “maximum particle diameter” refers to a particle diameter when the cumulative amount on a mass basis from the smaller particle diameter side in the particle size distribution obtained by laser diffractometry is 99.9%.

The average of the aspect ratio defined by PS/PL wherein PS (μm) represents the minor axis of each particle of the metal powder and PL (μm) represents the major axis thereof is preferably about 0.4 or more and 1 or less, more preferably about 0.7 or more and 1 or less. The particles having an aspect ratio within this range have a shape relatively close to a spherical shape, and therefore, the packing factor when the metal powder containing particles having such a particle diameter is compact-molded is increased. As a result, the bracket 1 having high mechanical properties and slidability can be obtained.

Here, the “major axis” is the maximum length in the projected image of the particle, and the “minor axis” is the maximum length in the direction orthogonal to the major axis. Incidentally, the average of the aspect ratio is obtained as an average of measurement values of 100 or more particles of the metal powder.

On the other hand, in the cross section of the bracket 1, the average of the aspect ratio defined by CS/CL wherein CL represents the major axis of each crystal structure of the sintered body of the metal powder and CS represents the minor axis thereof is preferably about 0.4 or more and 1 or less, more preferably about 0.5 or more and 1 or less. The crystal structure having such an aspect ratio has small anisotropy, and therefore, the bracket 1 formed from the sintered body having such a crystal structure have high mechanical properties such as proof stress regardless of the direction of a force applied. That is, such a bracket 1 has excellent deformation resistance even if it is used in any posture.

Here, the “major axis” is the maximum length in one crystal structure in the observation image of the cross section of the bracket 1, and the “minor axis” is the maximum length in the direction orthogonal to the major axis. Incidentally, the average of the aspect ratio is obtained as an average of measurement values of 100 or more crystal structures.

It is preferred that the bracket 1 has independent small pores therein. By having such pores, in the bracket 1, pores are exposed also on the surface thereof. Accordingly, in the bracket 1, the contact area with the archwire 5 is decreased, and therefore, a contact resistance can be decreased while supporting the archwire 5. Due to this, the slidability for the archwire 5 can be enhanced, and as a result, a stress to be exerted on the tooth 7 by the archwire 5 can be more easily controlled.

The average diameter of the pores is preferably 0.1 μm or more and 10 μm or less, more preferably 0.3 μm or more and 8 μm or less. When the average diameter of the pores is within the above range, the bracket 1 having higher slidability can be obtained. That is, if the average diameter of the pores is less than the above lower limit, the slidability may not be sufficiently enhanced depending on the surface state of the archwire 5, and on the other hand, if the average diameter of the pores exceeds the above upper limit, the mechanical properties may be deteriorated depending on the shape of the bracket 1.

The average diameter of the pores can be obtained as an average of the diameter of a circle having the same area as that of a pore (projected area circle equivalent diameter) in a scanning electron microscopic image of the cross section of the bracket 1.

The ratio of the area occupied by the pores in the observation image of the bracket 1 is preferably 0.001% or more and 1% or less, more preferably 0.005% or more and 0.5% or less. When the ratio of the area occupied by the pores is within the above range, both of the mechanical properties and the slidability of the bracket 1 can be more highly achieved.

This area ratio is calculated as a ratio of the area occupied by the pores to the area of the observation image, and the length of one side of the observation image is set to about 50 μm or more and 1000 μm or less.

The Vickers hardness of the bracket 1 is preferably 200 or more and 550 or less, more preferably 200 or more and 480 or less, further more preferably 240 or more and 380 or less. The bracket 1 having such a hardness is hardly deformed even when a force by the archwire 5 is applied over a long period of time in orthodontic treatment. As a result, a stress to be exerted on the tooth 7 by the archwire 5 can be more strictly controlled over a long period of time, and thus, orthodontic treatment can be efficiently performed to achieve desired teeth alignment.

The Vickers hardness of the bracket 1 is measured in accordance with the test method specified in JIS Z 2244.

The tensile strength of the bracket 1 is preferably 520 MPa or more, more preferably 600 MPa or more and 1500 MPa or less. The bracket 1 having such a tensile strength also has high deformation resistance over a long period of time.

Similarly, the 0.2% proof stress of the bracket 1 is preferably 450 MPa or more, more preferably 500 MPa or more and 1200 MPa or less. The bracket 1 having such a 0.2% proof stress also has high deformation resistance over a long period of time.

The tensile strength and the 0.2% proof stress are measured in accordance with the test method specified in JIS Z 2241.

The elongation of the bracket 1 is preferably 2% or more and 50% or less, more preferably 10% or more and 45% or less. The bracket 1 having such an elongation is hardly chipped, cracked, or the like, and thus, by using the bracket 1, a force can be continuously applied to the tooth 7 over a long period of time.

The elongation (elongation at break) of the bracket 1 is measured in accordance with the test method specified in JIS Z 2241.

The Young's modulus of the bracket 1 is preferably 150 GPa or more, more preferably 170 GPa or more and 300 GPa or less. The bracket 1 having such a Young's modulus is particularly hardly deformed, and therefore, by using the bracket 1, a given force can be continuously applied to the tooth 7 over a long period of time, and it becomes easy to control a stress to be exerted on the tooth 7.

The fatigue strength of the bracket 1 is preferably 250 MPa or more, more preferably 350 MPa or more, further more preferably 500 MPa or more and 1000 MPa or less. Even if the bracket 1 having such a fatigue strength is used in an environment in which a load is repeatedly applied thereto in a state where the bracket is in contact with a body fluid in the mouth, the occurrence of a fatigue crack or the like is prevented, and the bracket 1 can contributes to orthodontic treatment over a long period of time.

The fatigue strength of the bracket 1 is measured in accordance with the test method specified in JIS T 0309. The waveform of an applied load corresponding to a repeated stress is set to a sine wave, and the stress ratio (minimum stress/maximum stress) is set to 0.1. Further, the repeated frequency is set to 30 Hz, and the repeat count is set to 1×10⁷.

It is considered that the surface roughness of the bracket 1 affects the slidability for the archwire 5. In view of this, the arithmetic average roughness Ra of the surface of the bracket 1 is preferably 0.05 μm or more and 2 μm or less, more preferably 0.1 μm or more and 1 μm or less. By setting the surface roughness of the bracket 1 within the above range, the slidability for the archwire 5 can be optimized for orthodontic treatment. That is, when the surface roughness of the bracket 1 is less than the above lower limit, a contact area between the bracket 1 and the archwire 5 is increased to increase the frictional resistance, and therefore, the slidability may be deteriorated. When the slidability is deteriorated, the archwire 5 and the bracket 1 behave as if they are adhered to each other. Therefore, when the tooth 7 moves as the orthodontic treatment proceeds, a force applied to the bracket 1 by the archwire 5 is decreased, and as a result, it may be necessary to frequently adjust a force to be applied to the bracket 1 by the archwire 5, or it may take a long period of time to complete the orthodontic treatment. On the other hand, if the surface roughness of the bracket 1 exceeds the above upper limit, a contact area between the bracket 1 and the archwire 5 is decreased to decrease the frictional resistance, and therefore, the slidability may be too high. If the slidability is too high, when a force is tried to be applied to the bracket 1 by the archwire 5, the force is almost not applied thereto. As a result, the orthodontic treatment may not be able to be performed.

The surface roughness of the bracket 1 can be obtained as an arithmetic average roughness Ra obtained by measurement in a region in which both end portions of the archwire slot 21 are excluded using a stylus-type or laser probe-type surface roughness tester. Incidentally, the both end portions of the archwire slot 21 are portions having a length of 10% of the total length starting at both ends of the archwire slot 21.

Examples of the metal powder to be used for the production of the bracket 1 include metal powders produced by a variety of powdering methods such as an atomization method (such as a water atomization method, a gas atomization method, or a spinning water atomization method), a reducing method, a carbonyl method, and a pulverization method.

Among these, a metal powder produced by an atomization method is preferably used, and a metal powder produced by a water atomization method or a spinning water atomization method is more preferably used. The atomization method is a method in which a molten metal (a metal melt) is caused to collide with a fluid (a liquid or a gas) sprayed at a high speed to atomize the metal melt, followed by cooling, whereby a metal powder is produced. By producing the metal powder through such an atomization method, an extremely fine powder can be efficiently produced. Further, the shape of the particle of the obtained powder is closer to a spherical shape by the action of surface tension. Due to this, a molded body having a high packing factor is obtained when such a metal powder is molded by a powder metallurgy method. Accordingly, the bracket 1 having excellent mechanical properties can be obtained.

### Second Embodiment of Dental Component (Dental Anchor)

Next, a second embodiment of the dental component (dental anchor) according to the invention will be described.

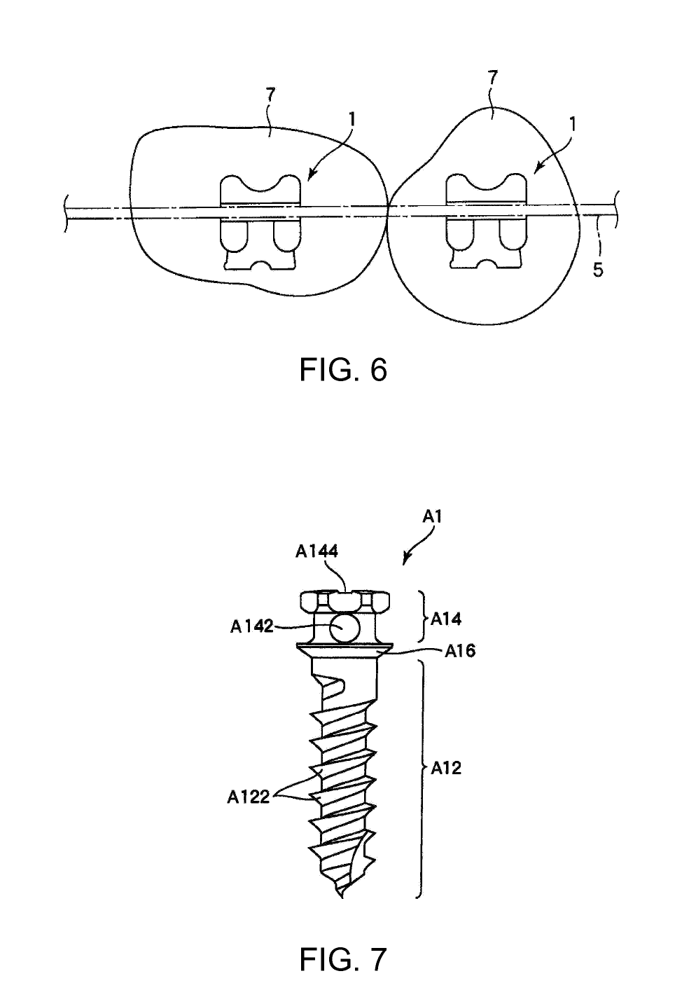

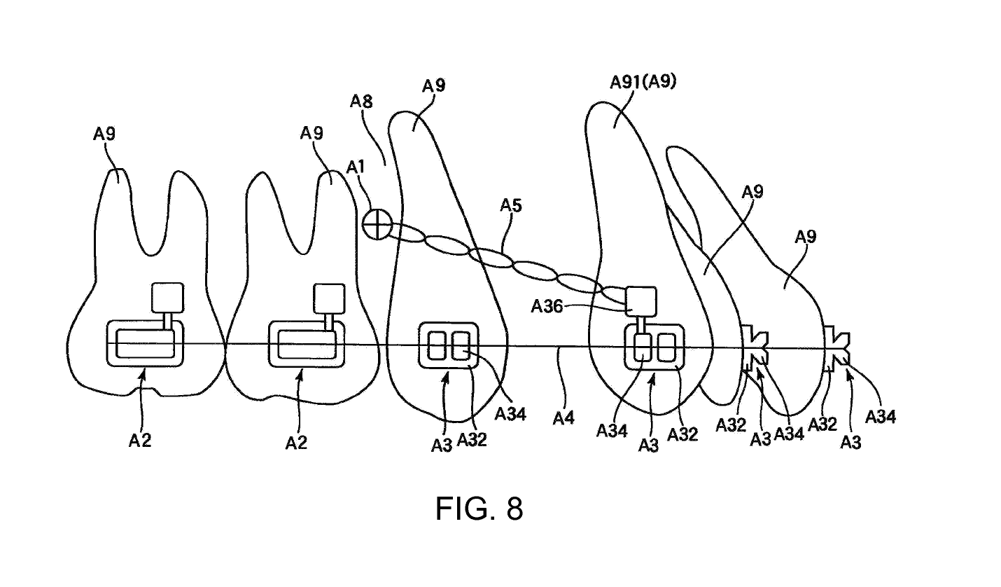

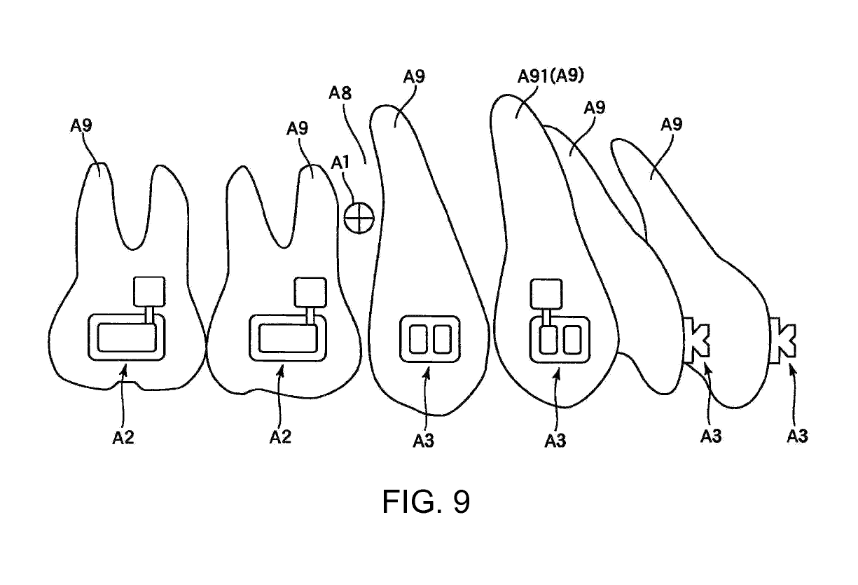

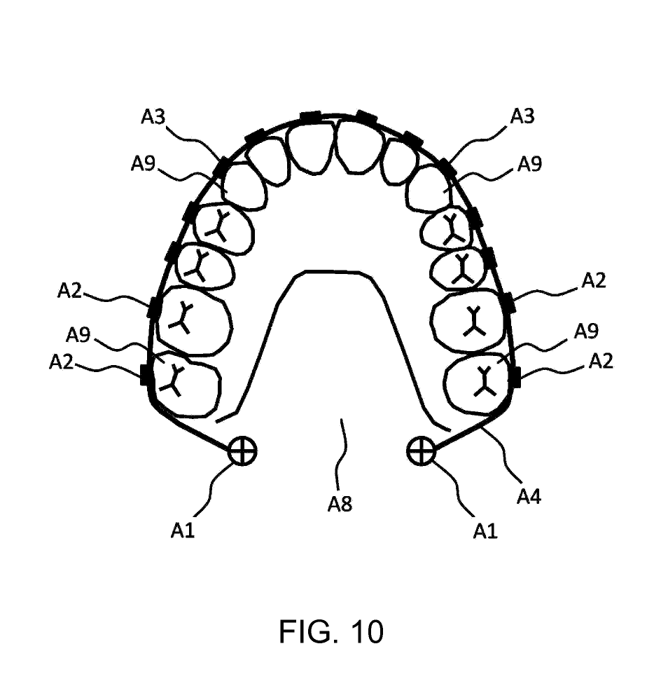

FIG. 7 is a front view showing a second embodiment of the dental component (dental anchor) according to the invention. FIGS. 8 and 9 are views for illustrating orthodontic treatment using the dental anchor shown in FIG. 7, and FIG. 8 is a view showing an example of a row of teeth before orthodontic treatment, and FIG. 9 is a view showing an example of a row of teeth after orthodontic treatment. Further, FIG. 10 is another view for illustrating orthodontic treatment using the dental anchor shown in FIG. 7.

### Shape

The dental anchor A1 shown in FIG. 7 is a member to be fixed to the alveolar bone, the jaw bone, or the like, and has a long and substantially cylindrical shape. The dental anchor A1 includes a male screw portion A12, a head portion A14 provided on one end side of the male screw portion A12, and a sleeve A16 located between the male screw portion A12 and the head portion A14. Hereinafter, the respective portions of the dental anchor A1 will be described in detail sequentially.

The male screw portion A12 is a part to be screwed into a pilot hole formed in advance in the alveolar bone or the like, or a part to be directly screwed into the alveolar bone or the like without forming a hole in advance. The shape of the male screw portion A12 is not particularly limited, however, for example, as shown in FIG. 7, a single-threaded screw shape (a screw shape) as if a screw thread A122 draws a simple spiral structure is adopted.

In the male screw portion A12, a notch or the like may be formed as needed.

The length of the male screw portion A12 (the length along the axis line of the dental anchor A1) is not particularly limited, but is set to, for example, about 3 mm or more and 15 mm or less. The diameter of the male screw portion A12 is not particularly limited, but is set to about 1 mm or more and 2.5 mm or less at a position where the diameter is the largest.

The head portion A14 shown in FIG. 7 includes a through-hole A142 opening to the side surfaces thereof, and a groove A144 formed on an end surface (a surface on the opposite side from the male screw portion A12) of the head portion A14.

The openings at both ends of the through-hole A142 open to the side surfaces of the head portion A14. The openings of the through-hole A142 shown in FIG. 7 have a circular shape, and therefore, the shape of the through-hole A142 is a cylinder. This through-hole A142 is formed such that the axis line thereof intersects the axis line of the dental anchor A1. In this through-hole A142, for example, a chain (a ligature wire) or the like which connects the dental anchor A1 and an orthodontic bracket, and the through-hole is used for fixing the chain and the dental anchor A1 to each other.

The number of through-holes A142 is not particularly limited, and two or more through-holes A142 may be formed.

The groove A144 is formed on a circular end surface of the head portion A14 in the shape of a line passing through, for example, the center of the end surface. The number of the grooves A144 is not particularly limited, and two or more grooves A144 may be formed. Also with this groove A144, for example, a chain (a ligature wire) or the like is engaged, whereby the chain and the dental anchor A1 can be fixed to each other. Further, when the dental anchor A1 is screwed into the alveolar bone or the like, the groove A144 can be used also as an engaging groove for engaging a tool or the like therewith.

The length of the head portion A14 is not particularly limited, but is set to, for example, about 1 mm or more and 10 mm or less. Further, the diameter of the head portion A14 is not particularly limited, but is set to, for example, about 1 mm or more and 3 mm or less at a position where the diameter is the largest.

The sleeve A16 is provided between the male screw portion A12 and the head portion A14 and is a member having a larger diameter than these parts. By providing such a sleeve A16, when the dental anchor A1 is screwed into the alveolar bone or the like, the head portion A14 can be easily and reliably exposed, and therefore, the operation efficiency can be enhanced.

The diameter of the sleeve A16 is not particularly limited, but is set to, for example, about 1.2 times or more and 3 times or less of the diameter of the male screw portion A12.

### Use Mode

Next, an example of the orthodontic treatment using the dental anchor A1 shown in FIG. 7 will be described.

The respective teeth A9 shown in FIG. 8 form a row of teeth from a molar tooth to a front tooth on one side of the upper jaw. Among these, a tooth A91 is deviated from the ideal position and dislocated toward the front side. The following description is related to an example of orthodontic treatment by moving this tooth A91 toward the rear side.

In the orthodontic treatment, as shown in FIG. 8, an orthodontic buccal tube A2 or an orthodontic bracket A3 is attached to the front surface of each tooth.

Among these, the orthodontic bracket A3 includes a base A32 and a tie wing A34. In a gap between the tie wings A34, an archwire A4 is inserted. The tie wing A34 and the archwire A4 are fixed to each other using a ligation unit (not shown).

On the other hand, the orthodontic buccal tube A2 fixes the archwire A4 at the vicinity of an end portion thereof. At this time, fixation is performed while applying a force of pulling the archwire A4. According to this, to the orthodontic bracket A3, a force is continuously applied by the archwire A4, and each tooth A9 is gradually moved accordingly.

Here, by selectively moving the tooth A91, first, a dental anchor A1 is fixed to the alveolar bone A8 at the rear side of the tooth A91. On the other hand, as the orthodontic bracket A3 attached to the tooth A91, a bracket including also a chain engaging portion A36 in addition to the base A32 and the tie wing A34 is used. Then, the dental anchor A1 and the chain engaging portion A36 are connected to each other with a chain A5. The chain A5 has elasticity and can apply a larger force to the tooth A91. According to this, the moving amount of the tooth A91 can be selectively increased. As a result, the tooth A91 can be moved to the ideal position shown in FIG. 9.

The chain 5 can be substituted with a member such as a rubber or a coil spring.

The dental anchor A1 is also used for purposes other than an anchorage for the chain A5, and is sometimes used as, for example, an anchorage for the archwire A4. The respective teeth A9 shown in FIG. 10 form a row of teeth when viewing the upper jaw vertically from the lower part. To the front surface of the respective teeth A9 shown in FIG. 10, an orthodontic buccal tube A2 or an orthodontic bracket A3 is attached. The dental anchors A1 shown in FIG. 10 are inserted vertically from the lower part to the upper part into the alveolar bone A8 of the upper jaw at the rear side of the back teeth on both sides, respectively. Then, to these two dental anchors A1, end portions of the archwire A4 are fixed, respectively. According to this, a tensile force is continuously applied to the archwire A4 by using the dental anchors A1 as anchorages, and each tooth A9 can be gradually moved accordingly.

The shape of the dental anchor A1 as described above is merely the shape of one embodiment of the invention and is not limited to the structure shown in the drawings. For example, the sleeve may be omitted, and the head portion may be provided with a structure other than the through-hole or the groove.

### Constituent Materials

Next, the constituent materials of the dental anchor A1 will be described.

Such a dental anchor A1 is formed from a Co—Cr—Mo—Si-based alloy in the same manner as the dental orthodontic bracket 1 described above.

Specifically, the alloy which forms the dental anchor A1 contains Co as a main component, and has a Cr content of 26% by mass or more and 35% by mass or less, a Mo content of 5% by mass or more and 12% by mass or less, and a Si content of 0.3% by mass or more and 2.0% by mass or less.

The dental anchor A1 formed from such an alloy has high proof stress. Therefore, the dental anchor A1 which is hardly bent or fractured even if a force is applied to the dental anchor A1 over a long period of time or the strength of a force applied is repeatedly changed can be obtained. By using such a dental anchor A1, the orthodontic treatment is prevented from being interrupted or needing retreatment, and thus, a burden on a patient can be reduced.

Further, the dental anchor A1 formed from the alloy as described above has high corrosion resistance. Therefore, metal ions are hardly eluted even when the dental anchor A1 is used in a state of, for example, being in contact with a body fluid in the mouth. Further, the dental anchor A1 contains almost no elements causing metal allergy such as nickel. Due to this, the dental anchor A1 hardly causes, for example, metal allergy or the like, and can increase the biocompatibility.

On the other hand, high corrosion resistance leads to an advantage that, for example, when the dental anchor A1 is inserted into the alveolar bone A8, the adhesion between the bone tissue and the dental anchor A1 is easily prevented. Therefore, when the dental anchor A1 is pulled out from the alveolar bone A8 after completion of the orthodontic treatment, it can be pulled out while minimizing the damage to the tissue of the alveolar bone A8. Accordingly, a burden on a patient accompanying the orthodontic treatment can be further reduced.

Further, the dental anchor A1 formed from the alloy as described above has high hardness and high Young's modulus. Therefore, the dental anchor A1 is hardly deformed when it is inserted into the alveolar bone A8. Accordingly, the treatment efficiency for those who provide the orthodontic treatment (dentists and the like) can be enhanced. Further, a function of continuously applying an appropriate tensile force to the chain A5 can be maintained over a long period of time.

Further, the dental anchor A1 is formed from a sintered body of a metal powder having particles containing a Co—Cr—Mo—Si-based alloy. That is, the dental anchor A1 is produced by sintering such a metal powder using a powder metallurgy method. According to the powder metallurgy method, it is easy to approximate the shape of the dental anchor A1 to a desired shape, and therefore, the dental anchor A1 having high dimensional accuracy can be obtained. Due to this, for example, the screw thread A122 of the male screw portion A12 can be shaped as designed, and thus, the efficiency of operation of inserting the male screw portion A12 into the alveolar bone A8 can be further enhanced.

Further, in such a dental anchor A1, the crystal particle diameter of the metal structure thereof is decreased and the isotropy thereof is increased. Therefore, the anisotropy of the proof stress is decreased, and thus, the dental anchor A1 which is hardly deformed with respect to a force from all directions can be obtained.

Here, among the constituent elements of this alloy, Co (cobalt) is a main component of the alloy which forms the dental anchor A1, and has a great effect on the basic properties of the dental anchor A1.

The content of Co is set to be the largest of the constituent elements of this alloy, and specifically the content of Co is preferably 50% by mass or more and 67.5% by mass or less, more preferably 55% by mass or more and 67% by mass or less.

Cr (chromium) mainly acts to improve the corrosion resistance of the dental anchor A1. It is considered that this is because by the addition of Cr, a passivation film (such as Cr₂O₃) is easily formed on the alloy, and thus, the chemical stability is improved. By the improvement of the corrosion resistance, an effect that metal ions are hardly eluted even when the alloy comes in contact with, for example, a body fluid is expected. Therefore, the dental anchor A1 formed from an alloy containing Cr has more excellent compatibility with a living body. Further, by using Cr along with Co, Mo, and Si, the mechanical properties of the dental anchor A1 can be further enhanced.

The content of Cr in the alloy which forms the dental anchor A1 is set to 26% by mass or more and 35% by mass or less. If the content of Cr is less than the above lower limit, the corrosion resistance of the dental anchor A1 is deteriorated. Therefore, in the case where the dental anchor A1 is in contact with a body fluid over a long period of time, metal ions may be eluted. On the other hand, if the content of Cr exceeds the above upper limit, the amount of Cr with respect to Mo or Si is relatively too large, and therefore, the brittleness may be increased. In addition, the balance thereof with Co, Mo, or Si is lost so that the mechanical properties such as proof stress may be deteriorated.

The content of Cr is set to preferably 27% by mass or more and 34% by mass or less, more preferably 28% by mass or more and 33% by mass or less.

Mo (molybdenum) mainly acts to further enhance the corrosion resistance of the dental anchor A1. That is, by the addition of Mo, the corrosion resistance improved by the addition of Cr can be further enhanced. It is considered that this is because by the addition of Mo, the passivation film containing a Cr oxide as a main material is further densified. Therefore, the Mo-added alloy is more difficult to elute metal ions, and thus, the dental anchor A1 having particularly high compatibility with a living body can be obtained.

The content of Mo in the alloy which forms the dental anchor A1 is set to 5% by mass or more and 12% by mass or less. If the content of Mo is less than the above lower limit, the corrosion resistance of the dental anchor A1 may be insufficient. On the other hand, if the content of Mo exceeds the above upper limit, the amount of Mo with respect to Cr or Si is relatively too large, and therefore, the brittleness may be increased. In addition, the balance thereof with Co, Cr, or Si is lost so that the mechanical properties such as proof stress may be deteriorated.

The content of Mo is set to preferably 5.5% by mass or more and 11% by mass or less, more preferably 6% by mass or more and 9% by mass or less.

Si (silicon) acts to enhance the slidability of the surface of the dental anchor A1. By the addition of Si, silicon oxide is formed by oxidizing a part of Si in the dental anchor A1 (the sintered body which forms the dental anchor A1). Examples of the silicon oxide include SiO and SiO₂. When such silicon oxide is formed in the dental anchor A1, the frictional resistance with the alveolar bone A8 is decreased so that the insertion operation is more facilitated.

Si also acts to enhance the mechanical properties such as proof stress of the dental anchor A1. The above-described silicon oxide prevents a significant increase in size of a metal crystal when the metal crystal grows in the production of the dental anchor A1. Due to this, in the Si-added alloy, the particle diameter of the metal crystal is suppressed to be small, and thus, the mechanical properties such as proof stress of the dental anchor A1 can be further enhanced. Further, by substituting a Co atom with a Si atom as a substitutional element, the crystal structure is slightly distorted so that the Young's modulus is increased. Therefore, by the addition of Si, the dental anchor A1 can achieve both excellent slidability and excellent mechanical properties, particularly excellent proof stress and Young's modulus. As a result, the dental anchor A1 having higher deformation resistance can be obtained.

In order to obtain the effect as described above, it is necessary to set the content of Si to 0.3% by mass or more and 2.0% by mass or less. If the content of Si is less than the above lower limit, the amount of silicon oxide present in the dental anchor A1 is also decreased, and therefore, the frictional resistance with the alveolar bone A8 is increased to deteriorate the slidability. Further, the size of a metal crystal is liable to increase in the production of the dental anchor A1, and therefore, a possibility that the mechanical properties of the dental anchor A1 are also deteriorated is increased. On the other hand, if the content of Si exceeds the above upper limit, the amount of silicon oxide present in the dental anchor A1 is too large, and a region where silicon oxide is spatially distributed in a continuous manner is liable to be formed. In such a region, the crystal structure of the sintered body which forms the dental anchor A1 is liable to be discontinuous at a given size, and therefore, when an external force is applied to the dental anchor A1, this region is liable to serve as the starting point of fracture. As a result, the mechanical properties of the dental anchor A1 may be deteriorated. In addition, due to the silicon oxide spatially distributed in a continuous manner, the slidability is liable to be deteriorated.

The content of Si is set to preferably 0.5% by mass or more and 1.0% by mass or less, more preferably 0.6% by mass or more and 0.9% by mass or less.

Further, apart of Si in the sintered body which forms the dental anchor A1 preferably exists in the form of silicon oxide as described above. In particular, the ratio of the content of Si contained as silicon oxide to the total content of Si in the sintered body which forms the dental anchor A1 is preferably 20% or more and 80% or less, more preferably 30% or more and 70% or less, further more preferably 35% or more and 65% or less. By setting the ratio of the content of Si contained as silicon oxide to the total content of Si contained in the dental anchor A1 within the above range, the mechanical properties of the dental anchor A1 are improved. Further, by the existence of a given amount silicon oxide in the dental anchor A1, the amount of oxides of transition metal elements such as Co, Cr, and Mo contained in this dental anchor A1 can be sufficiently reduced. That is, Si is more easily oxidized than Co, Cr, and Mo, and deprives oxygen bonded to these transition metal elements to cause a reduction reaction. Therefore, it is considered that the fact that not the total amount of Si in the sintered body which forms the dental anchor A1 is Si contained as silicon oxide means that a sufficient amount of Si is present in the sintered body, and therefore, a sufficient reduction reaction is caused with respect to the transition metal elements. Accordingly, by setting the ratio of the content of Si contained as silicon oxide to the total content of Si in the sintered body which forms the dental anchor A1 within the above range, in the dental anchor A1, the effect such as high mechanical properties and high slidability as described above are prevented from being inhibited by each oxide of Co, Cr, or Mo. As a result, the dental anchor A1 having higher reliability can be obtained.

Further, by setting the ratio of the content of Si contained as silicon oxide to the total content of Si in the sintered body which forms the dental anchor A1 within the above range, appropriate hardness and slidability are imparted to the dental anchor A1. That is, by the existence of a given amount of Si which is not in the form of silicon oxide in the dental anchor A1, Si and at least one element selected from Co, Cr, and Mo produce a hard intermetallic compound. Accordingly, it is considered that the hardness and slidability of the dental anchor A1 are increased. Since the hardness of the dental anchor A1 is increased, when the dental anchor A1 is inserted into the alveolar bone A8 by using a tool or the like, the deformation or the like of the dental anchor A1 can be prevented. Accordingly, the dental anchor A1 can be efficiently inserted into the alveolar bone A8. In addition, since the slidability is enhanced, the efficiency of the insertion operation can be further enhanced.

Incidentally, by the addition of Si, significant growth of a metal crystal in the sintered body which forms the dental anchor A1 is inhibited, and therefore, from this point of view, the hardness of the dental anchor A1 tends to be decreased. However, it is considered that a part of Si forms an intermetallic compound, and therefore, a significant decrease in the hardness is prevented, and a hardness and a toughness are obtained to such an extent that the deformation of the dental anchor A1 is prevented.

This intermetallic compound is not particularly limited, however, examples thereof include CoSi₂, Cr₃Si, MoSi₂, and Mo₅Si₃.

In consideration of the deposition amount of the intermetallic compound, the ratio of the content of Si to the content of Mo (Si/Mo) is preferably 0.05 or more and 0.2 or less, more preferably 0.08 or more and 0.15 or less in terms of mass ratio. According to this, the dental anchor A1 can achieve both high slidability and high mechanical properties.

Silicon oxide may be distributed at any place, but is preferably distributed in a segregated manner at the grain boundary (the boundary surface between metal crystals). By segregating silicon oxide at such a place, an increase in size of a metal crystal can be more reliably prevented, and thus, the dental anchor A1 having more excellent mechanical properties such as proof stress can be obtained. Further, deposits of silicon oxide segregated at the grain boundary keep a proper distance from one another by themselves, and therefore, the deposits of silicon oxide can be more uniformly dispersed in the dental anchor A1. As a result, the slidability of the dental anchor A1 can be further enhanced.

The deposits of segregated silicon oxide can be analyzed to specify the size, distribution, and the like thereof by an area analysis of a qualitative analysis. Specifically, in a compositional image of Si obtained by an electron beam microanalyzer (EPMA), an average diameter of a region where Si is segregated is preferably 0.1 μm or more and 10 μm or less, more preferably 0.3 μm or more and 8 μm or less. When the average diameter of a region where Si is segregated is within the above range, the size of the deposit of silicon oxide becomes most suitable for exhibiting the respective effects as described above. That is, if the average diameter of a region where Si is segregated is less than the above lower limit, the deposits of silicon oxide are not segregated to a sufficient size, and the above-described respective effects may not be sufficiently obtained depending on the content of Si. On the other hand, if the average diameter of a region where Si is segregated exceeds the above upper limit, the mechanical properties of the dental anchor A1 may be deteriorated depending on the content of Si.

The average diameter of a region where Si is segregated can be determined as an average of the diameter of a circle having the same area (projected area circle equivalent diameter) as that of the region where Si is segregated in the compositional image of Si.

Further, the dental anchor A1 includes a first phase formed mainly from Co and a second phase formed mainly from Co₃Mo. By including the second phase of these phases, high hardness and high slidability are imparted to the dental anchor A1 in the same manner as the intermetallic compound containing Si described above, and therefore, a useful dental anchor A1 from the viewpoint of improvement of the reliability can be obtained. On the other hand, in the case where the second phase is included excessively, the second phase is liable to be significantly segregated, and thus, the mechanical properties may be deteriorated.

Therefore, it is preferred that the first phase and the second phase are included at an appropriate ratio from the above point of view. Specifically, for the dental anchor A1, a crystal structure analysis is performed by X-ray diffractometry using a Cu-Kα ray, and when the height of the highest peak among the peaks derived from Co is assumed to be 1, the height of the highest peak among the peaks derived from Co₃Mo is preferably 0.01 or more and 0.5 or less, more preferably 0.02 or more and 0.4 or less.

If the height of the highest peak of Co₃Mo when the height of the highest peak of Co is assumed to be 1 is less than the above lower limit, the ratio of Co₃Mo to Co in the dental anchor A1 is decreased, and therefore, the hardness and slidability of the dental anchor A1 may be decreased. On the other hand, if the height of the highest peak of Co₃Mo exceeds the above upper limit, the abundance of Co₃Mo is too large, and therefore, Co₃Mo is liable to be significantly segregated so that the mechanical properties such as proof stress of the dental anchor A1 are decreased and also the slidability may be decreased.

The Cu-Kα ray is generally a characteristic X-ray with an energy of 8.048 keV.

Further, when a peak derived from Co is identified, the identification is performed based on the database of Co of ICDD (The International Centre for Diffraction Data) card. Similarly, when a peak derived from Co₃Mo is identified, the identification is performed based on the database of Co₃Mo of ICDD card.

The abundance ratio of Co₃Mo in the dental anchor A1 is preferably 0.01% by mass or more and 10% by mass or less, more preferably 0.05% by mass or more and 5% by mass or less. According to this, the hardness and slidability of the dental anchor A1 can be further increased.

The abundance ratio of these components can be obtained by quantification of the abundance ratio of Co₃Mo from the results of the crystal structure analysis.

The alloy which forms the dental anchor A1 may contain N (nitrogen) other than the elements described above. N mainly acts to enhance the mechanical properties of the dental anchor A1. N is an austenitizing element, and therefore accelerates the austenitization of the crystal structure of the dental anchor A1 and acts to enhance the toughness.

By the incorporation of N, the formation of a dendrite phase in the sintered body which forms the dental anchor A1 is prevented, and the content of the dendrite phase becomes very small. Therefore, also from this point of view, the toughness can be enhanced.

The dental anchor A1 containing N has appropriate hardness and high toughness, and also can decrease the content of the dendrite phase. Accordingly, the slidability of the dental anchor A1 can be enhanced.

Here, the dendrite phase is a dendritically grown crystal structure, and if a large amount of such a dendrite phase is contained, the mechanical properties and slidability of the dental anchor A1 are deteriorated. Therefore, the reduction of the content of the dendrite phase is effective in the enhancement of the mechanical properties and slidability of the dental anchor A1. Specifically, the dental anchor A1 is observed with a scanning electron microscope, and in the obtained observation image, the ratio of the area occupied by the dendrite phase is preferably 20% or less, more preferably 10% or less. The dental anchor A1 satisfying such conditions has particularly high mechanical properties and slidability.

The dental anchor A1 is formed from a sintered body of a metal powder as described above. The metal powder has a high cooling rate and also has high cooling uniformity since the volume of each metal powder particle is very small. Therefore, in the dental anchor A1 formed from a sintered body of such a metal powder, the formation of a dendrite phase is prevented. On the other hand, in the method in the related art such as casting, forging, or rolling, when a molten metal is cooled, the volume to be cooled is larger than that of the powder, and therefore, the cooling rate is low and also the cooling uniformity is low. As a result, it is considered that in the dental anchor A1 produced by such a method, a relatively large amount of a dendrite phase is formed.

The area ratio described above is calculated as a ratio of the area occupied by the dendrite phase to the area of the observation image, and the length of one side of the observation image is set to about 50 μm or more and 1000 μm or less.

In order to obtain the effect as described above, it is necessary to set the content of N to preferably 0.09% by mass or more and 0.5% by mass or less. If the content of N is less than the above lower limit, the austenitization of the crystal structure of the dental anchor A1 is insufficient, and therefore, the hardness of the dental anchor A1 is excessively increased so that also the toughness may be liable to be decreased. It is considered that this is because in the dental anchor A1, other than the austenite phase (γ phase), a large amount of an hcp structure (ε phase) is deposited. As a result, the mechanical properties and slidability of the dental anchor A1 may be deteriorated. On the other hand, if the content of N exceeds the above upper limit, various nitrides are produced in a large amount, and also the composition may make sintering difficult. Therefore, the sintered density of the dental anchor A1 is decreased so that the mechanical properties may be deteriorated. Examples of the produced nitrides include Cr₂N. If such a nitride is deposited, the hardness is also increased, and thus, the toughness is decreased also in this case.

The content of N is set to preferably 0.12% by mass or more and 0.4% by mass or less, more preferably 0.14% by mass or more and 0.25% by mass or less, further more preferably 0.15% by mass or more and 0.22% by mass or less.

In particular, when the content of N is within the range of 0.15% by mass or more and 0.22% by mass or less, the austenite phase becomes particularly dominant, and a significant decrease in hardness and a remarkable improvement of toughness are observed. When the dental anchor A1 at this time is subjected to a crystal structure analysis by X-ray diffractometry using a Cu-Kα ray, a main peak derived from the austenite phase is very strongly observed. On the other hand, the heights of the peak derived from the hcp structure and the other peaks are all 5% or less of the height of the main peak. This proves that the austenite phase is dominant.

The ratio of the content of N to the content of Si (N/Si) is preferably 0.1 or more and 0.8 or less, more preferably 0.2 or more and 0.6 or less in terms of mass ratio. According to this, both high mechanical properties and high slidability can be achieved. That is, by the addition of Si in a given amount, as described above, the slidability is increased, however, when the addition amount of Si is too large, the mechanical properties of the dental anchor A1 may be deteriorated. By adding N at a ratio within the above range, the high slidability obtained by the addition of Si and the above-described effect obtained by the addition of N can be exhibited without cancelling out each other, and therefore, the slidability can be synergistically improved. It is considered that this is because while metal elements such as Si and Co form a substitutional solid solution, metal elements such as N and Co form an interstitial solid solution, and therefore, these metal elements can coexist with one another. Moreover, it is considered that the distortion of the crystal structure due to the solid solution of Si is suppressed by the solid solution of N. Accordingly, it is considered that the deterioration of the mechanical properties is prevented.

Further, when Si is added, a distortion occurs in the crystal structure as described above, however, in this state, a hysteresis is likely to occur in the behavior of thermal expansion and thermal contraction. If a large hysteresis occurs in the behavior of thermal expansion and thermal contraction, the thermal properties of the dental anchor A1 may change over time.

On the other hand, by the addition of N at the above-described ratio, N is interstitially solid-dissolved in the crystal structure, and therefore, the distortion of the crystal structure is suppressed. As a result, a hysteresis in the behavior of thermal expansion and thermal contraction is prevented so that the thermal properties of the dental anchor A1 can be stabilized.

Accordingly, by the addition of Si and N in an appropriate amount, the slidability of the dental anchor A1 can be enhanced, and also the mechanical properties and thermal properties can be stabilized.

If the ratio of the content of N to the content of Si is less than the above lower limit, the distortion of the crystal structure cannot be sufficiently suppressed, and thus, the toughness and the like may be deteriorated. On the other hand, if the ratio thereof exceeds the above upper limit, the composition makes sintering difficult, and thus, the sintered density of the dental anchor A1 is decreased and also the mechanical properties may be deteriorated.

The alloy which forms the dental anchor A1 may contain C (carbon) other than the elements described above. By the addition of C, the hardness and tensile strength of the dental anchor A1 are further increased, and also the slidability is further enhanced. A detailed reason why the slidability is further enhanced is not clear, but one of the reasons is considered that due to the formation of a carbide, the frictional resistance is decreased.

The content of C in the alloy which forms the dental anchor A1 is not particularly limited, but is preferably 1.5% by mass or less, more preferably 0.7% by mass or less. If the content of C exceeds the above upper limit, the brittleness of the dental anchor A1 is increased so that the mechanical properties may be deteriorated.

The lower limit of the addition amount of C is not particularly limited, however, in order to sufficiently exhibit the above-described effect, the lower limit is preferably set to about 0.05% by mass.

The content of C is preferably about 0.02 times or more and 0.5 times or less, more preferably about 0.05 times or more and 0.3 times or less of the content of Si. It is considered that by setting the ratio of the content of C to the content of Si within the above range, these components synergistically act to improve the slidability while minimizing the adverse effect of silicon oxide or a carbide on the mechanical properties of the dental anchor A1. Due to this, the dental anchor A1 having particularly excellent slidability can be obtained.

The content of N is preferably about 0.3 times or more and 10 times or less, more preferably about 2 times or more and 8 times or less of the content of C. By setting the ratio of the content of N to the content of C within the above range, particularly, both of the improvement of the slidability of the dental anchor A1 by the addition of C and the improvement of the mechanical properties of the dental anchor A1 by the addition of N can be achieved.

In addition, the alloy which forms the dental anchor A1 may contain, other than the elements described above, impurities inevitably generated during the production. In this case, the total content of the impurities is set to preferably 1% by mass or less, more preferably 0.5% by mass or less, further more preferably 0.2% by mass or less. Examples of such impurity elements include B, O, Na, Mg, Al, P, S, and Mn.

On the other hand, it is preferred that the alloy which forms the dental anchor A1 does not substantially contain Ni (nickel). Ni is often contained in a given amount in a Co—Cr-based alloy for use in a living body in the related art for ensuring plastic workability. However, Ni is sometimes treated as a causative substance of metal allergy and is an element suspected to have an adverse effect on a living body. To the alloy which forms the dental anchor A1, Ni is not added as a constituent element except for Ni inevitably mixed therein during the production. Therefore, the dental anchor A1 according to the invention hardly causes metal allergy, and thus has particularly high compatibility with a living body. Incidentally, in consideration of a case where Ni is inevitably mixed therein, the content of Ni is preferably 0.05% by mass or less, more preferably 0.03% by mass or less.

The remainder of the alloy which forms the dental anchor A1 other than the elements described above is Co. As described above, the content of Co is set to be the largest of the elements contained in the alloy which forms the dental anchor A1.

The respective constituent elements of the alloy which forms the dental anchor A1 and the compositional ratio thereof can be determined by, for example, atomic absorption spectrometry specified in JIS G 1257, ICP optical emission spectroscopy specified in JIS G 1258, spark optical emission spectroscopy specified in JIS G 1253, X-ray fluorescence spectroscopy specified in JIS G 1256, gravimetry, titrimetry, and absorption spectroscopy specified in JIS G 1211 to G 1237, or the like. Specifically, an optical emission spectrometer for solids (spark optical emission spectrometer) manufactured by SPECTRO Analytical Instruments GmbH (model: SPECTROLAB, type: LAVMB08A) can be used.

Further, when C (carbon) and S (sulfur) are determined, particularly, an infrared absorption method after combustion in a current of oxygen (after combustion in a high-frequency induction furnace) specified in JIS G 1211 is also used. Specifically, a carbon-sulfur analyzer, CS-200 manufactured by LECO Corporation can be used.

Further, when N (nitrogen) and O (oxygen) are determined, particularly, a method for determination of nitrogen content in iron and steel specified in JIS G 1228 and a method for determination of oxygen content in metallic materials specified in JIS Z 2613 are also used. Specifically, an oxygen-nitrogen analyzer, TC-300/EF-300 manufactured by LECO Corporation can be used.

The dental anchor A1 shown in FIG. 7 is a member formed from a sintered body of a metal powder as described above, that is, it is a member produced by a powder metallurgy method. The mechanical properties of such a dental anchor A1 are improved as compared with a member produced by, for example, a casting method, a forging method, a rolling method, or the like. The dental anchor A1 produced by a powder metallurgy method is a member produced by using a metal powder obtained by quenching (since the volume is small, it is easily quenched), and therefore, significant grain growth of a metal crystal is more difficult to occur than in the case of using a casting method or the like. As a result, it is considered that it is difficult to form a metal crystal with an increased size, and thus, the mechanical properties of the dental anchor A1 are improved. Further, according to the powder metallurgy method, a homogeneous composition is easily obtained, and therefore, uniform distribution of Si and silicon oxide is also easily obtained. Accordingly, the dental anchor A1 having uniform slidability (an individual difference in slidability is small) can be obtained.

When the dental anchor A1 contains N, it is preferred that N is solid-dissolved in a material from the time when the metal powder is produced, and the dental anchor is formed from a sintered body obtained by using the powder. In the dental anchor A1 produced in this manner, N is substantially uniformly distributed, and therefore, the physical properties of the entire dental anchor A1 can be made substantially uniform. Accordingly, such a dental anchor A1 has high homogeneity, and also an individual difference is reduced.

It is considered that the reason why such a homogeneous dental anchor A1 is obtained is because as described above, N is solid-dissolved in the metal material from the time when the powder is produced, and the dental anchor is formed from a sintered body produced by a powder metallurgy method using the powder. In order to solid-dissolve N in the metal material at the time when the powder is produced, for example, a method in which at least one element selected from Co, Cr, Mo, and Si contained in the starting material is nitrided in advance, a method in which a molten metal (a metal melt) is maintained in a nitrogen gas atmosphere when or after the starting material is melted, a method in which nitrogen gas is injected (bubbled) in a molten metal, or the like is used.

Further, there is also a method in which a molded body obtained by molding the metal powder or a sintered body obtained by sintering the molded body is heated in a nitrogen gas atmosphere or is subjected to an HIP treatment in a nitrogen gas atmosphere, whereby the alloy is impregnated with nitrogen (a nitriding treatment). However, in this method, it is difficult to uniformly nitride the molded body or the sintered body from a surface layer region to an inner layer region. Supposedly, in the case of performing a nitriding treatment, it is necessary to perform the treatment over an extremely long period of time while controlling the nitriding speed, and therefore, the method is a little problematic from the viewpoint of production efficiency of the dental anchor A1.

When the molded body obtained by solid-dissolving N in the powder is degreased and fired, a variation in the concentration of solid-dissolved N can be suppressed by performing degreasing and firing in an inert gas such as nitrogen gas or argon gas.

As the metal powder to be used for the production of the dental anchor A1, a powder formed from the alloy as described above is used. The average particle diameter thereof is preferably 3 μm or more and 100 μm or less, more preferably 4 μm or more and 80 μm or less, further more preferably 5 μm or more and 60 μm or less. By using a metal powder having such a particle diameter, the dental anchor A1 having high density, high mechanical properties such as proof stress, and excellent slidability can be produced.

The average particle diameter is obtained as a particle diameter when the cumulative amount on a mass basis from the smaller particle diameter side in the particle size distribution obtained by laser diffractometry is 50%.

If the average particle diameter of the metal powder is less than the above lower limit, the bulk density of the metal powder is decreased and the moldability in powder metallurgy is deteriorated, and therefore, the density of the dental anchor A1 is decreased so that the mechanical properties may be deteriorated. On the other hand, if the average particle diameter of the metal powder exceeds the above upper limit, the packing density of the metal powder in powder metallurgy is decreased, and therefore, also in this case, the density of the dental anchor A1 is decreased so that the mechanical properties may be deteriorated. Further, the uniformity of the composition may be deteriorated.

The particle size distribution of the metal powder is preferably as narrow as possible. Specifically, when the average particle diameter of the metal powder is within the above range, the maximum particle diameter is preferably 200 μm or less, more preferably 150 μm or less. By controlling the maximum particle diameter of the metal powder within the above range, the particle size distribution of the metal powder can be made narrower. According to this, the mechanical properties and slidability of the dental anchor A1 can be further improved.

Here, the “maximum particle diameter” refers to a particle diameter when the cumulative amount on a mass basis from the smaller particle diameter side in the particle size distribution obtained by laser diffractometry is 99.9%.

The average of the aspect ratio defined by PS/PL wherein PS (μm) represents the minor axis of each particle of the metal powder and PL (μm) represents the major axis thereof is preferably about 0.4 or more and 1 or less, more preferably about 0.7 or more and 1 or less. The particles having an aspect ratio within this range have a shape relatively close to a spherical shape, and therefore, the packing factor when the metal powder containing particles having such a particle diameter is compact-molded is increased. As a result, the dental anchor A1 having high mechanical properties and slidability can be obtained.

Here, the “major axis” is the maximum length in the projected image of the particle, and the “minor axis” is the maximum length in the direction orthogonal to the major axis. Incidentally, the average of the aspect ratio is obtained as an average of measurement values of 100 or more particles of the metal powder.

On the other hand, in the cross section of the dental anchor A1, the average of the aspect ratio defined by CS/CL wherein CL represents the major axis of each crystal structure of the sintered body of the metal powder and CS represents the minor axis thereof is preferably about 0.4 or more and 1 or less, more preferably about 0.5 or more and 1 or less. The crystal structure having such an aspect ratio has small anisotropy, and therefore, the dental anchor A1 formed from the sintered body having such a crystal structure have high mechanical properties such as proof stress regardless of the direction of a force applied. That is, such a dental anchor A1 can serve an excellent anchorage even if it is used in any posture.

Here, the “major axis” is the maximum length in one crystal structure in the observation image of the cross section of the dental anchor A1, and the “minor axis” is the maximum length in the direction orthogonal to the major axis. Incidentally, the average of the aspect ratio is obtained as an average of measurement values of 100 or more crystal structures.

The Vickers hardness of the dental anchor A1 is preferably 200 or more and 480 or less, more preferably 240 or more and 380 or less. The dental anchor A1 having such a hardness is prevented from being deformed or the like, for example, when the dental anchor A1 is inserted into the alveolar bone A8 using a tool or the like. According to this, the dental anchor A1 can be efficiently inserted into the alveolar bone A8. If the Vickers hardness thereof is less than the above lower limit, when the dental anchor A1 is inserted using a tool or the like, the dental anchor A1 may be deformed. On the other hand, if the Vickers hardness thereof exceeds the above upper limit, the toughness is decreased so that the impact resistance may be deteriorated depending on the composition of the alloy which forms the dental anchor A1.

The Vickers hardness of the dental anchor A1 is measured in accordance with the test method specified in JIS Z 2244.

The tensile strength of the dental anchor A1 is preferably 520 MPa or more, more preferably 600 MPa or more and 1500 MPa or less. The dental anchor A1 having such a tensile strength also has high deformation resistance over a long period of time.

Similarly, the 0.2% proof stress of the dental anchor A1 is preferably 450 MPa or more, more preferably 500 MPa or more and 1200 MPa or less. The dental anchor A1 having such a 0.2% proof stress can continuously apply an appropriate tensile force to the orthodontic bracket 3 through the chain A5. Accordingly, the dental anchor A1 capable of selectively moving a specific tooth A91 for a relatively short period of time and particularly suitable for orthodontic treatment can be obtained.

The tensile strength and the 0.2% proof stress are measured in accordance with the test method specified in JIS Z 2241.

The elongation of the dental anchor A1 is preferably 2% or more and 50% or less, more preferably 10% or more and 45% or less. The dental anchor A1 having such an elongation can continuously maintain a tensile force applied to the orthodontic bracket 3 through the chain A5 appropriate over a long period of time. Further, such a dental anchor A1 is hardly chipped, cracked, or the like, and therefore has high reliability.

The elongation (elongation at break) of the dental anchor A1 is measured in accordance with the test method specified in JIS Z 2241.

The Young's modulus of the dental anchor A1 is preferably 150 GPa or more, more preferably 170 GPa or more and 300 GPa or less. The dental anchor A1 having such a Young's modulus is particularly hardly deformed, and therefore, can enhance the treatment efficiency for those who provide the orthodontic treatment.

The fatigue strength of the dental anchor A1 is preferably 250 MPa or more, more preferably 350 MPa or more, further more preferably 500 MPa or more and 1000 MPa or less. Even if the dental anchor A1 having such a fatigue strength is used in an environment in which a load is repeatedly applied thereto in a state where the dental anchor is in contact with a body fluid in the mouth, the occurrence of a fatigue crack or the like is prevented, and the dental anchor A1 can contributes to orthodontic treatment over a long period of time.

The fatigue strength of the dental anchor A1 is measured in accordance with the test method specified in JIS T 0309. The waveform of an applied load corresponding to a repeated stress is set to a sine wave, and the stress ratio (minimum stress/maximum stress) is set to 0.1. Further, the repeated frequency is set to 30 Hz, and the repeat count is set to 1×10⁷.

The arithmetic average roughness Ra of the surface of the dental anchor A1 is preferably 0.05 μm or more and 2 μm or less, more preferably 0.1 μm or more and 1 μm or less. By setting the surface roughness of the dental anchor A1 within the above range, when the dental anchor A1 is inserted into the alveolar bone A8, the insertion operation can be efficiently performed. Further, the dental anchor A1 after insertion can be prevented from being unintentionally pulled out. If the surface roughness of the dental anchor A1 is less than the above lower limit, the slidability of the dental anchor A1 is too high so that the dental anchor A1 may be easily pulled out. Further, the chain A5 engaged with the dental anchor A1 is easily slid so that an appropriate tensile force may not be applied to the orthodontic bracket 3. On the other hand, if the surface roughness of the dental anchor A1 exceeds the above upper limit, the slidability of the dental anchor A1 is too low so that the efficiency of the insertion operation is deteriorated and also the efficiency of the pulling-out operation may be deteriorated.

The surface roughness of the dental anchor A1 can be obtained as an arithmetic average roughness Ra obtained by measuring, for example, a region between the screw threads A122 of the male screw portion A12 using a stylus-type or laser probe-type surface roughness tester.

Examples of the metal powder to be used for the production of the dental anchor A1 include metal powders produced by a variety of powdering methods such as an atomization method (such as a water atomization method, a gas atomization method, or a spinning water atomization method), a reducing method, a carbonyl method, and a pulverization method.

Among these, a metal powder produced by an atomization method is preferably used, and a metal powder produced by a water atomization method or a spinning water atomization method is more preferably used. The atomization method is a method in which a molten metal (a metal melt) is caused to collide with a fluid (a liquid or a gas) sprayed at a high speed to atomize the metal melt, followed by cooling, whereby a metal powder is produced. By producing the metal powder through such an atomization method, an extremely fine powder can be efficiently produced. Further, the shape of the particle of the obtained powder is closer to a spherical shape by the action of surface tension. Due to this, a molded body having a high packing factor is obtained when such a metal powder is molded by a powder metallurgy method. Accordingly, the dental anchor A1 having excellent mechanical properties can be obtained.

### Third Embodiment of Dental Component (Dental Implant)

Next, a third embodiment of the dental component (dental implant) according to the invention will be described.

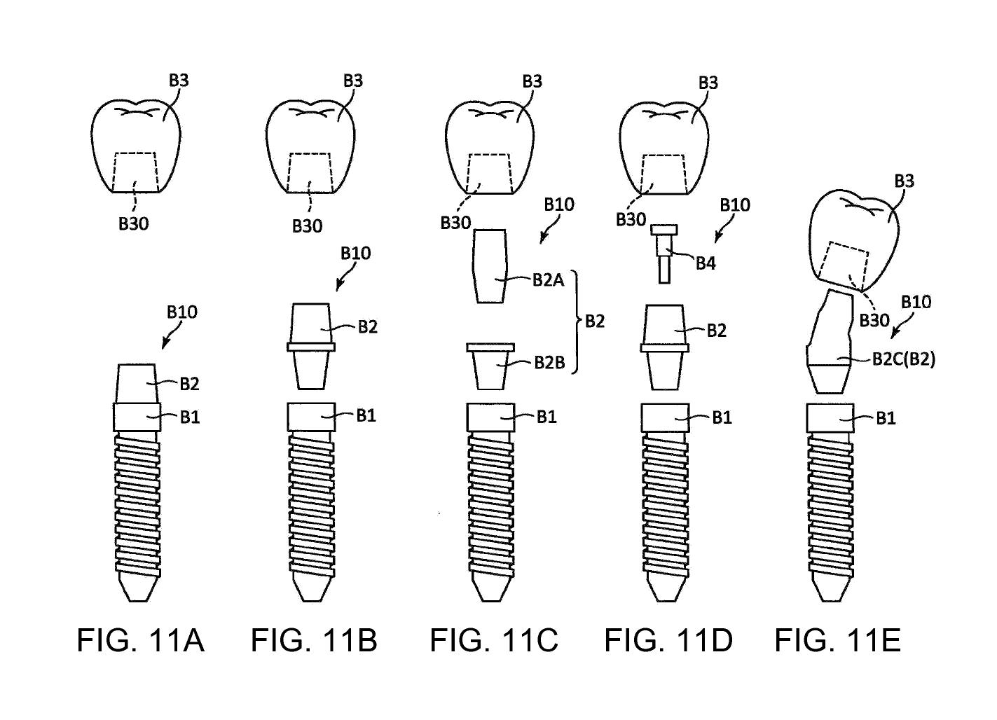

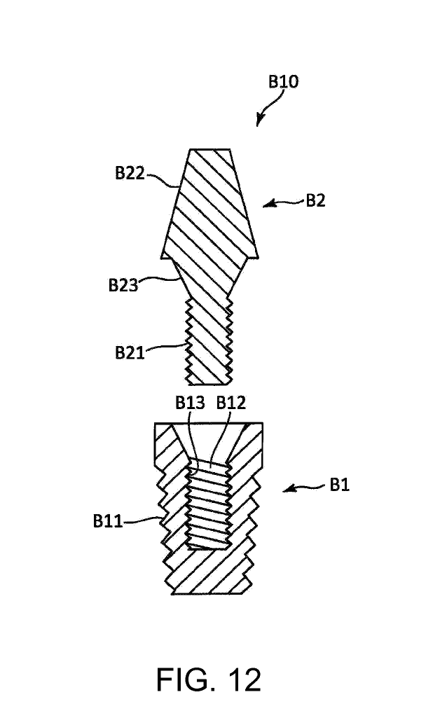

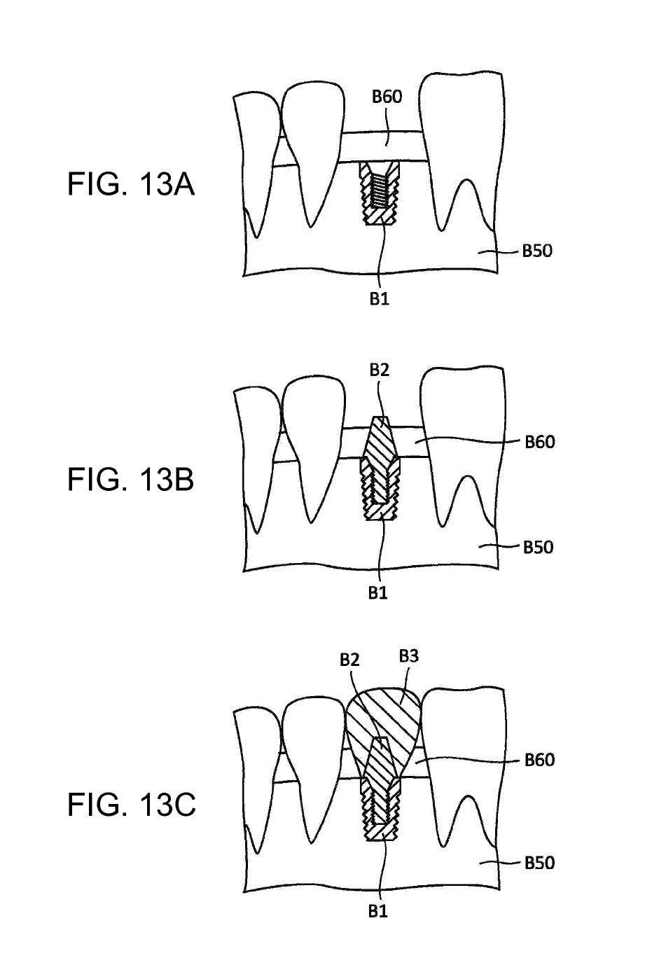

FIGS. 11A to 11E are front views each showing a third embodiment of the dental component (dental implant) according to the invention and a crown restoration to be attached thereto, and FIG. 11A is a front view of a one-piece type in which a fixture and an abutment are integrally formed, FIG. 11B is an exploded front view of a two-piece type in which a fixture and an abutment are separate members, FIG. 11C is an exploded front view of a three-piece type in which an abutment is further divided into two members, FIG. 11D is an exploded front view of a type further including an abutment screw for fixing a fixture and an abutment, and FIG. 11E is an exploded front view of a type which is formed from two pieces and in which an abutment is tilted. FIG. 12 is a vertical cross-sectional view of the two-piece type dental implant shown in FIG. 11B and is a view showing a state where a fixture and an abutment are separated. FIGS. 13A to 13C are views for illustrating a surgical process (operative procedure) using the dental implant shown in FIG. 12. In the drawings referred to herein, some parts of configurations are shown exaggeratedly and actual dimensions and the like are not accurately reflected in these parts. Further, in the following description, an upper side and a lower side in each drawing are referred to as “upper” and “lower”, respectively, for the sake of convenience of explanation.

### Shape

A dental implant system B10 shown in FIG. 11A is a member which has a long cylindrical shape and in which a fixture B1 to be fixed to the jaw bone or the like and an abutment B2 are integrally formed.

A dental implant system B10 shown in FIG. 11B has a long bottomed cylindrical shape, and includes a fixture B1 to be fixed to the jaw bone or the like and an abutment B2 to be screwed into the fixture B1.

A dental implant system B10 shown in FIG. 11C includes a fixture B1, a lower abutment B2A to be screwed into the fixture B1, and an upper abutment B2B to be screwed into the lower abutment B2A.

A dental implant system B10 shown in FIG. 11D includes a fixture B1, an abutment B2 to be screwed into the fixture B1, and an abutment screw B4 which fixes the fixture B1 and the abutment B2 to each other.

A dental implant system B10 shown in FIG. 11E includes a fixture B1 and an angle abutment B2C to be screwed into the fixture B1. The angle abutment B2C has a substantially cylindrical shape, but the direction of the axis line is different between the upper portion and the lower portion. That is, the axis line of the upper portion is tilted with respect to the axis line of the lower portion, and the tilt angle thereof is set to, for example, about 1° or more and 30° or less.

There are various types of dental implant systems B10 according to the forms of the fixture B1 and the abutment B2, however, in the following description, a two-piece type dental implant system shown in FIG. 11B will be described as a representative system. Incidentally, the following configuration can also be applied to other types of dental implant systems.

The members which form the above-described dental implant system B10, for example, the fixture B1, the abutment B2, the lower abutment B2A, the upper abutment B2B, the angle abutment B2C, the abutment screw B4, and the like each correspond to the “dental component (dental implant) according to the invention”. Incidentally, the member in which the fixture B1 and the abutment B2 are integrally formed also corresponds to the “dental component (dental implant) according to the invention”.

### (1) Fixture

The fixture B1 is a member which is inserted into the jaw bone or the like and fixed thereto in an operative procedure using the dental implant system B10.

The fixture B1 has a bottomed cylindrical shape as described above and is provided with a male screw portion B11 on an outer circumferential surface thereof. According to this, the fixture B1 is threaded by machining or the like or can be fixed to the perforated jaw bone by screwing. The shape of the male screw portion B11 is not particularly limited, however, for example, a shape such as a single-threaded screw or a double-threaded screw (a screw shape) as if a screw thread draws a simple spiral structure is adopted.

In a part of the male screw portion B11, for example, a notch portion with a given length where a screw thread is not formed may be provided along the axis direction of the fixture B1. By providing such a notch portion, bone formation by osteoblasts can be allowed to proceed in this region, and therefore, loosening or the like of the fixture B1 can be effectively prevented.

The length of the fixture B1 (the length along the axis line of the fixture B1) is not particularly limited, but is set to, for example, about 5 mm or more and 20 mm or less. Further, the diameter (the largest outer diameter) of the fixture B1 is not particularly limited, but is set to, for example, about 3 mm or more and 6 mm or less.

Further, the male screw portion B11 may be formed such that the diameter thereof gradually decreases toward a tip end side at the time of insertion.

The surface of the fixture B1 may be subjected to any of various surface treatments such as a surface-roughening treatment and an etching treatment as needed. By performing such a surface treatment, the affinity for osteoblasts is increased when the fixture B1 is inserted into the jaw bone or the like, and thus, adhesion to the bone can be accelerated.

In a cylindrical portion B12 (the inner side of the bottomed cylinder) of the fixture B1, the abutment B2 (described below) is inserted. In an inner circumferential surface of the cylindrical portion B12, a female screw portion B13 which can be screwed to a male screw portion B21 of the abutment B2 is provided.

### (2) Abutment

The abutment B2 is a member which is fixed to the fixture B1 in an operative procedure using the dental implant system B10. It is also a member, which is covered with a crown restoration B3 to be used for the purpose of improving the aesthetic appearance or obtaining excellent bite alignment.

The abutment B2 includes a male screw portion B21 which has a substantially cylindrical shape, is provided on one end side, and is screwed into the female screw portion B13 of the fixture B1 described above, a crown fixing portion B22 which is provided on the other end side and has a substantially trapezoidal vertical cross section, and an intermediate portion B23 which is located between the male screw portion B21 and the crown fixing portion B22.

Further, the dental implant system B10 shown in FIG. 12 is configured such that when the male screw portion B21 of the abutment B2 and the female screw portion B13 of the fixture B1 are screwed to each other, the male screw portion B21 and the intermediate portion B23 of the abutment B2 are inserted into the cylindrical portion B12 of the fixture B1.

Incidentally, the shape of the crown fixing portion B22 is not limited to the shape shown in the drawing, and may be for example, a conical shape, a pyramidal shape, a dome shape, or the like.

The length of the abutment B2 (the length along the axis line of the abutment B2) is not particularly limited, but is set to, for example, about 3 mm or more and 15 mm or less. Further, the diameter (the largest outer diameter) of the abutment B2 is not particularly limited, but is set to, for example, about 3 mm or more and 6 mm or less.

The shape of the dental implant as described above is merely a shape of an embodiment of the invention and is not limited to the shape shown in the drawing.

### Use Mode

Next, one example of a surgical process (operative procedure) using the dental implant system B10 shown in FIG. 12 will be described with reference to FIGS. 13A to 13C.

### Fixture Insertion Treatment

After an anesthesia is given to a patient, the fixture B1 is screwed into the threaded jaw bone B50 (FIG. 13A).

Thereafter, the fixture B1 is covered with the gingiva (gum) B60 as needed.

### Abutment Screwing Treatment

After a lapse of a given period (generally about 3 to 6 months) from the fixture insertion treatment, and bone formation by osteoclasts and the bonding (osseointegration) between the fixture B1 and the jawbone B50 sufficiently proceed, the abutment B2 is screwed into the fixture B1 fixed to the jaw bone B50 (FIG. 13B).

When the fixture B1 is covered with the gingiva B60 or the like, before screwing the abutment B2, the gingiva B60 is incised to expose the fixture B1 as needed.

### Crown Restoration Covering Treatment

Subsequently, the crown restoration B3 shaped by molding is fixed to the abutment B2 (FIG. 13C). Specifically, a hole (an abutment insertion portion B30 shown in FIGS. 11A to 11E) is provided for the crown restoration B3 in advance, and the crown fixing portion B22 of the abutment B2 is inserted in this hole, whereby the fixation is achieved.

The crown restoration B3 is seen in appearance after this operative procedure, and therefore is formed from, for example, a ceramic material or the like in consideration of aesthetic appearance or the like. In order to adhere the abutment B2 to the crown restoration B3, for example, a dental cement or the like is used.

In the case where the gingiva B60 is incised in an abutment screwing treatment, generally, a period of about 1 to 6 weeks is given after the abutment screwing treatment, and after it is confirmed that swelling of the gingiva B60 goes down, this treatment is performed.

### Constituent Materials

Next, the constituent materials of the dental implant according to the invention will be described.

Such a dental implant is formed from a Co—Cr—Mo—Si-based alloy in the same manner as the dental orthodontic bracket 1 and the dental anchor A1 described above.

Specifically, the alloy which forms the dental implant contains Co as a main component, and has a Cr content of 26% by mass or more and 35% by mass or less, a Mo content of 5% by mass or more and 12% by mass or less, and a Si content of 0.3% by mass or more and 2.0% by mass or less.

The dental implant formed from such an alloy has high proof stress. Therefore, the dental implant which is hardly fractured even if a force is repeatedly applied to the dental implant over a long period of time due to mastication, bruxism, or the like can be obtained. By using such a dental implant, the treatment of restoring a lost tooth is prevented from being interrupted or needing retreatment, and thus, a burden on a patient can be reduced.

Further, the dental implant formed from the alloy as described above has high corrosion resistance. Therefore, metal ions are hardly eluted even when the dental implant is used in a state of, for example, being in contact with a body fluid in the mouth. Further, the dental implant contains almost no elements causing metal allergy such as nickel. Due to this, the dental implant hardly causes, for example, metal allergy or the like, and can increase the biocompatibility. Such a dental implant is hardly denatured or deteriorated.

On the other hand, the dental implant formed from the alloy as described above has high hardness and high Young's modulus. Therefore, the dental implant is hardly deformed when it is inserted into the jaw bone B50. Accordingly, the treatment efficiency for those who provide the treatment (dentists and the like) using an insertion driver or the like can be enhanced. Further, a function of fixing the crown restoration B3 to the jaw bone B50 can be maintained even if a load accompanying mastication, bruxism, or the like is applied over a long period of time.

Further, s dental implant is formed from a sintered body of a metal powder having particles containing a Co—Cr—Mo—Si-based alloy. That is, the dental implant is produced by sintering such a metal powder using a powder metallurgy method. According to the powder metallurgy method, it is easy to approximate the shape of the dental implant to a desired shape, and therefore, the dental implant having high dimensional accuracy can be obtained. Due to this, for example, the screw thread of the female screw portion B13 of the fixture B1, and the screw thread of the male screw portion B21 of the abutment B2 can be shaped as designed, and thus, the screwability is improved. As a result, the efficiency of operation of screwing the fixture B1 and the abutment B2 to each other can be further enhanced.

Further, in such a dental implant, the crystal particle diameter of the metal structure thereof is decreased and the isotropy thereof is increased. Therefore, the anisotropy of the proof stress is decreased, and thus, the dental implant which is hardly deformed with respect to a force from all directions can be obtained.

Here, among the constituent elements of this alloy, Co (cobalt) is a main component of the alloy which forms the dental implant, and has a great effect on the basic properties of the dental implant.

The content of Co is set to be the largest of the constituent elements of this alloy, and specifically the content of Co is preferably 50% by mass or more and 67.5% by mass or less, more preferably 55% by mass or more and 67% by mass or less.

Cr (chromium) mainly acts to improve the corrosion resistance of the dental implant. It is considered that this is because by the addition of Cr, a passivation film (such as Cr₂O₃) is easily formed on the alloy, and thus, the chemical stability is improved. By the improvement of the corrosion resistance, an effect that metal ions are hardly eluted, and denaturation or deterioration hardly occurs even when the alloy comes in contact with, for example, a body fluid is expected. Therefore, the dental implant formed from an alloy containing Cr has more excellent compatibility with a living body. Further, by using Cr along with Co, Mo, and Si, the mechanical properties of the dental implant can be further enhanced.

The content of Cr in the alloy which forms the dental implant is set to 26% by mass or more and 35% by mass or less. If the content of Cr is less than the above lower limit, the corrosion resistance of the dental implant is deteriorated. Therefore, in the case where the dental implant is in contact with a body fluid over a long period of time, metal ions may be eluted. On the other hand, if the content of Cr exceeds the above upper limit, the amount of Cr with respect to Mo or Si is relatively too large, and therefore, the brittleness may be increased. In addition, the balance thereof with Co, Mo, or Si is lost so that the mechanical properties such as proof stress may be deteriorated.

The content of Cr is set to preferably 27% by mass or more and 34% by mass or less, more preferably 28% by mass or more and 33% by mass or less.

Mo (molybdenum) mainly acts to further enhance the corrosion resistance of the dental implant. That is, by the addition of Mo, the corrosion resistance improved by the addition of Cr can be further enhanced. It is considered that this is because by the addition of Mo, the passivation film containing a Cr oxide as a main material is further densified. Therefore, the Mo-added alloy is more difficult to elute metal ions, and thus, the dental implant having particularly high compatibility with a living body can be obtained.

The content of Mo in the alloy which forms the dental implant is set to 5% by mass or more and 12% by mass or less. If the content of Mo is less than the above lower limit, the corrosion resistance of the dental implant may be insufficient. On the other hand, if the content of Mo exceeds the above upper limit, the amount of Mo with respect to Cr or Si is relatively too large, and therefore, the brittleness may be increased. In addition, the balance thereof with Co, Cr, or Si is lost so that the mechanical properties such as proof stress may be deteriorated.

The content of Mo is set to preferably 5.5% by mass or more and 11% by mass or less, more preferably 6% by mass or more and 9% by mass or less.

Si (silicon) acts to enhance the slidability of the surface of the dental implant. By the addition of Si, silicon oxide is formed by oxidizing a part of Si in the dental implant (the sintered body which forms the dental implant). Examples of the silicon oxide include SiO and SiO₂. When such silicon oxide is formed in the dental implant, the frictional resistance with the jaw bone B50 is decreased so that the insertion operation is more facilitated.

Si also acts to enhance the mechanical properties such as proof stress of the dental implant. The above-described silicon oxide prevents a significant increase in size of a metal crystal when the metal crystal grows in the production of the dental implant. Due to this, in the Si-added alloy, the particle diameter of the metal crystal is suppressed to be small, and thus, the mechanical properties such as proof stress of the dental implant can be further enhanced. Further, by substituting a Co atom with a Si atom as a substitutional element, the crystal structure is slightly distorted so that the Young's modulus is increased. Therefore, by the addition of Si, the dental implant can achieve both excellent slidability and excellent mechanical properties, particularly excellent proof stress and Young's modulus. As a result, the dental implant having higher fracture resistance can be obtained.

In order to obtain the effect as described above, it is necessary to set the content of Si to 0.3% by mass or more and 2.0% by mass or less. If the content of Si is less than the above lower limit, the amount of silicon oxide is also decreased, and therefore, the frictional resistance with the jaw bone B50 is increased to deteriorate the slidability. Further, the size of a metal crystal is liable to increase in the production of the dental implant, and therefore, a possibility that the mechanical properties of the dental implant are also deteriorated is increased. On the other hand, if the content of Si exceeds the above upper limit, the amount of silicon oxide present in the dental implant is too large, and a region where silicon oxide is spatially distributed in a continuous manner is liable to be formed. In such a region, the structure of the dental implant is liable to be discontinuous at a given size, and therefore, when an external force is applied to the dental implant, this region is liable to serve as the starting point of fracture. As a result, the mechanical properties of the dental implant may be deteriorated. In addition, due to the silicon oxide spatially distributed in a continuous manner, the slidability is liable to be deteriorated.

The content of Si is set to preferably 0.5% by mass or more and 1.0% by mass or less, more preferably 0.6% by mass or more and 0.9% by mass or less.

Further, apart of Si in the sintered body which forms the dental implant preferably exists in the form of silicon oxide as described above. In particular, the ratio of the content of Si contained as silicon oxide to the total content of Si in the sintered body which forms the dental implant is preferably 20% or more and 80% or less, more preferably 30% or more and 70% or less, further more preferably 35% or more and 65% or less. By setting the ratio of the content of Si contained as silicon oxide to the total content of Si contained in the dental implant within the above range, the mechanical properties of the dental implant are improved. Further, by the existence of a given amount silicon oxide in the dental implant, the amount of oxides of transition metal elements such as Co, Cr, and Mo contained in this dental implant can be sufficiently reduced. That is, Si is more easily oxidized than Co, Cr, and Mo, and deprives oxygen bonded to these transition metal elements to cause a reduction reaction. Therefore, it is considered that the fact that not the total amount of Si in the sintered body which forms the dental implant is Si contained as silicon oxide means that a sufficient amount of Si is present in the sintered body, and therefore, a sufficient reduction reaction is caused with respect to the transition metal elements. Accordingly, by setting the ratio of the content of Si contained as silicon oxide to the total content of Si in the sintered body which forms the dental implant within the above range, in the dental implant, the effect such as high mechanical properties and high slidability as described above are prevented from being inhibited by each oxide of Co, Cr, or Mo. As a result, the dental implant having higher reliability can be obtained.

Further, by setting the ratio of the content of Si contained as silicon oxide to the total content of Si in the sintered body which forms the dental implant within the above range, appropriate hardness and slidability are imparted to the dental implant. That is, by the existence of a given amount of Si which is not in the form of silicon oxide in the dental implant, Si and at least one element selected from Co, Cr, and Mo produce a hard intermetallic compound. Accordingly, it is considered that the hardness and slidability of the dental implant are increased. Since the hardness of the dental implant is increased, when the dental implant is inserted into the jaw bone B50 by using an insertion driver or the like, the deformation or the like of the dental implant can be prevented. Accordingly, the dental implant can be efficiently inserted into the jaw bone B50. In addition, since the slidability is enhanced, the efficiency of the insertion operation can be further enhanced.

Incidentally, by the addition of Si, significant growth of a metal crystal in the sintered body which forms the dental implant is inhibited, and therefore, from this point of view, the hardness of the dental implant tends to be decreased. However, it is considered that a part of Si forms an intermetallic compound, and therefore, a significant decrease in the hardness is prevented, and a hardness and a toughness are obtained to such an extent that the deformation of the dental implant is prevented.

This intermetallic compound is not particularly limited, however, examples thereof include CoSi₂, Cr₃Si, MoSi₂, and Mo₅Si₃.

In consideration of the deposition amount of the intermetallic compound, the ratio of the content of Si to the content of Mo (Si/Mo) is preferably 0.05 or more and 0.2 or less, more preferably 0.08 or more and 0.15 or less in terms of mass ratio. According to this, the dental implant can achieve both high slidability and high mechanical properties.

Silicon oxide may be distributed at any place, but is preferably distributed in a segregated manner at the grain boundary (the boundary surface between metal crystals). By segregating silicon oxide at such a place, an increase in size of a metal crystal can be more reliably prevented, and thus, the dental implant having more excellent mechanical properties such as proof stress can be obtained. Further, deposits of silicon oxide segregated at the grain boundary keep a proper distance from one another by themselves, and therefore, the deposits of silicon oxide can be more uniformly dispersed in the dental implant. As a result, the slidability of the dental implant can be further enhanced.

Further, silicon oxide contributes to an increase in adhesiveness of a coating formed on the surface of the dental implant. On the surface of the dental implant, a coating film containing a ceramic based on any of various oxides such as aluminum oxide, zirconium oxide, silicon oxide, calcium oxide, magnesium oxide, titanium oxide, and calcium phosphate is formed as needed. By setting the ratio of the content of Si contained as silicon oxide within the above range, the adhesiveness between the dental implant and the coating film can be enhanced while suppressing a decrease in the mechanical properties or slidability of the dental implant. It is considered that this adhesiveness is derived from the formation of a so-called oxide bond between silicon oxide on the dental implant side and the oxide on the coating film side.

If the ratio of the content of Si contained as silicon oxide is lower than the above lower limit, the amount of silicon oxide is decreased, and therefore, the slidability is decreased and also depending on the shape of the dental implant, the mechanical properties may be liable to be deteriorated. Then, an effect of enhancing the adhesiveness between the dental implant and the coating film through silicon oxide may be deteriorated. On the other hand, if the ratio of the content of Si contained as silicon oxide exceeds the above upper limit, as described above, silicon oxide is liable to be spatially distributed in a continuous manner, and therefore, depending on the shape of the dental implant, the mechanical properties may be deteriorated.

The deposits of segregated silicon oxide can be analyzed to specify the size, distribution, and the like thereof by an area analysis of a qualitative analysis. Specifically, in a compositional image of Si obtained by an electron beam microanalyzer (EPMA), an average diameter of a region where Si is segregated is preferably 0.1 μm or more and 10 μm or less, more preferably 0.3 μm or more and 8 μm or less. When the average diameter of a region where Si is segregated is within the above range, the size of the deposit of silicon oxide becomes most suitable for exhibiting the respective effects as described above. That is, if the average diameter of a region where Si is segregated is less than the above lower limit, the deposits of silicon oxide are not segregated to a sufficient size, and the above-described respective effects may not be sufficiently obtained depending on the content of Si. On the other hand, if the average diameter of a region where Si is segregated exceeds the above upper limit, the mechanical properties of the dental implant may be deteriorated depending on the content of Si.

The average diameter of a region where Si is segregated can be determined as an average of the diameter of a circle having the same area (projected area circle equivalent diameter) as that of the region where Si is segregated in the compositional image of Si.

Further, the dental implant includes a first phase formed mainly from Co and a second phase formed mainly from Co₃Mo. By including the second phase of these phases, high hardness and high slidability are imparted to the dental implant in the same manner as the intermetallic compound containing Si described above, and therefore, a useful dental implant from the viewpoint of improvement of the reliability can be obtained. On the other hand, in the case where the second phase is included excessively, the second phase is liable to be significantly segregated, and thus, the mechanical properties may be deteriorated.

Therefore, it is preferred that the first phase and the second phase are included at an appropriate ratio from the above point of view. Specifically, for the dental implant, a crystal structure analysis is performed by X-ray diffractometry using a Cu-Kα ray, and when the height of the highest peak among the peaks derived from Co is assumed to be 1, the height of the highest peak among the peaks derived from Co₃Mo is preferably 0.01 or more and 0.5 or less, more preferably 0.02 or more and 0.4 or less.

If the height of the highest peak of Co₃Mo when the height of the highest peak of Co is assumed to be 1 is less than the above lower limit, the ratio of Co₃Mo to Co in the dental implant is decreased, and therefore, the hardness and slidability of the dental implant may be decreased. On the other hand, if the height of the highest peak of Co₃Mo exceeds the above upper limit, the abundance of Co₃Mo is too large, and therefore, Co₃Mo is liable to be significantly segregated so that the mechanical properties such as proof stress of the dental implant are decreased and also the slidability may be decreased.

The Cu-Kα ray is generally a characteristic X-ray with an energy of 8.048 keV.

Further, when a peak derived from Co is identified, the identification is performed based on the database of Co of ICDD (The International Centre for Diffraction Data) card. Similarly, when a peak derived from Co₃Mo is identified, the identification is performed based on the database of Co₃Mo of ICDD card.

The abundance ratio of Co₃Mo in the dental implant is preferably 0.01% by mass or more and 10% by mass or less, more preferably 0.05% by mass or more and 5% by mass or less. According to this, the dental implant having a higher hardness and higher slidability of can be obtained.

The abundance ratio of these components can be obtained by quantification of the abundance ratio of Co₃Mo from the results of the crystal structure analysis.

The alloy which forms the dental implant may contain N (nitrogen) other than the elements described above. N mainly acts to enhance the mechanical properties of the dental implant. N is an austenitizing element, and therefore accelerates the austenitization of the crystal structure of the dental implant and acts to enhance the toughness.

By the incorporation of N, the formation of a dendrite phase in the sintered body which forms the dental implant is prevented, and the content of the dendrite phase becomes very small. Therefore, also from this point of view, the toughness can be enhanced.

The dental implant containing N has appropriate hardness and high toughness, and also can decrease the content of the dendrite phase. Accordingly, the slidability of the dental implant can be enhanced.

Here, the dendrite phase is a dendritically grown crystal structure, and if a large amount of such a dendrite phase is contained, the mechanical properties and slidability of the dental implant are deteriorated. Therefore, the reduction of the content of the dendrite phase is effective in the enhancement of the mechanical properties and slidability of the dental implant. Specifically, the dental implant is observed with a scanning electron microscope, and in the obtained observation image, the ratio of the area occupied by the dendrite phase is preferably 20% or less, more preferably 10% or less. The dental implant satisfying such conditions has particularly high mechanical properties and slidability.

The dental implant is formed from a sintered body of a metal powder as described above. The metal powder has a high cooling rate and also has high cooling uniformity since the volume of each metal powder particle is very small. Therefore, in the dental implant formed from a sintered body of such a metal powder, the formation of a dendrite phase is prevented. On the other hand, in the method in the related art such as casting, forging, or rolling, when a molten metal is cooled, the volume to be cooled is larger than that of the powder, and therefore, the cooling rate is low and also the cooling uniformity is low. As a result, it is considered that in the dental implant produced by such a method, a relatively large amount of a dendrite phase is formed.

The area ratio described above is calculated as a ratio of the area occupied by the dendrite phase to the area of the observation image, and the length of one side of the observation image is set to about 50 μm or more and 1000 μm or less.

In order to obtain the effect as described above, it is necessary to set the content of N to preferably 0.09% by mass or more and 0.5% by mass or less. If the content of N is less than the above lower limit, the austenitization of the crystal structure of the dental implant is insufficient, and therefore, the hardness of the dental implant is excessively increased so that also the toughness may be liable to be decreased. It is considered that this is because in the dental implant, other than the austenite phase (γ phase), a large amount of an hcp structure (ε phase) is deposited. As a result, the mechanical properties and slidability of the dental implant may be deteriorated. On the other hand, if the content of N exceeds the above upper limit, various nitrides are produced in a large amount, and also the composition may make sintering difficult. Therefore, the sintered density of the dental implant is decreased so that the mechanical properties may be deteriorated. Examples of the produced nitrides include Cr₂N. If such a nitride is deposited, the hardness is also increased, and thus, the toughness is decreased also in this case.

The content of N is set to preferably 0.12% by mass or more and 0.4% by mass or less, more preferably 0.14% by mass or more and 0.25% by mass or less, further more preferably 0.15% by mass or more and 0.22% by mass or less.

In particular, when the content of N is within the range of 0.15% by mass or more and 0.22% by mass or less, the austenite phase becomes particularly dominant, and a significant decrease in hardness and a remarkable improvement of toughness are observed. When the dental implant at this time is subjected to a crystal structure analysis by X-ray diffractometry using a Cu-Kα ray, a main peak derived from the austenite phase is very strongly observed. On the other hand, the heights of the peak derived from the hcp structure and the other peaks are all 5% or less of the height of the main peak. This proves that the austenite phase is dominant.

The ratio of the content of N to the content of Si (N/Si) is preferably 0.1 or more and 0.8 or less, more preferably 0.2 or more and 0.6 or less in terms of mass ratio. According to this, both high mechanical properties and high slidability can be achieved. That is, by the addition of Si in a given amount, as described above, the slidability is increased, however, when the addition amount of Si is too large, the mechanical properties of the dental implant may be deteriorated. By adding N at a ratio within the above range, the high slidability obtained by the addition of Si and the above-described effect obtained by the addition of N can be exhibited without cancelling out each other, and therefore, the slidability can be synergistically improved. It is considered that this is because while metal elements such as Si and Co form a substitutional solid solution, metal elements such as N and Co form an interstitial solid solution, and therefore, these metal elements can coexist with one another. Moreover, it is considered that the distortion of the crystal structure due to the solid solution of Si is suppressed by the solid solution of N. Accordingly, it is considered that the deterioration of the mechanical properties is prevented.

Further, when Si is added, a distortion occurs in the crystal structure as described above, however, in this state, a hysteresis is likely to occur in the behavior of thermal expansion and thermal contraction. If a large hysteresis occurs in the behavior of thermal expansion and thermal contraction, the thermal properties of the dental implant may change over time.

On the other hand, by the addition of N at the above-described ratio, N is interstitially solid-dissolved in the crystal structure, and therefore, the distortion of the crystal structure is suppressed. As a result, a hysteresis in the behavior of thermal expansion and thermal contraction is prevented so that the thermal properties of the dental implant can be stabilized.

Accordingly, by the addition of Si and N in an appropriate amount, the slidability of the dental implant can be enhanced, and also the mechanical properties and thermal properties can be stabilized.

If the ratio of the content of N to the content of Si is less than the above lower limit, the distortion of the crystal structure cannot be sufficiently suppressed, and thus, the toughness and the like may be deteriorated. On the other hand, if the ratio thereof exceeds the above upper limit, the composition makes sintering difficult, and thus, the sintered density of the dental implant is decreased and also the mechanical properties may be deteriorated.

The alloy which forms the dental implant may contain C (carbon) other than the elements described above. By the addition of C, the hardness and tensile strength of the dental implant are further increased, and also the slidability is further enhanced. A detailed reason why the slidability is further enhanced is not clear, but one of the reasons is considered that due to the formation of a carbide, the frictional resistance is decreased.

The content of C in the alloy which forms the dental implant is not particularly limited, but is preferably 1.5% by mass or less, more preferably 0.7% by mass or less. If the content of C exceeds the above upper limit, the brittleness of the dental implant is increased so that the mechanical properties may be deteriorated.

The lower limit of the addition amount of C is not particularly limited, however, in order to sufficiently exhibit the above-described effect, the lower limit thereof is preferably set to about 0.05% by mass.

The content of C is preferably about 0.02 times or more and 0.5 times or less, more preferably about 0.05 times or more and 0.3 times or less of the content of Si. It is considered that by setting the ratio of the content of C to the content of Si within the above range, these components synergistically act to improve the slidability while minimizing the adverse effect of silicon oxide or a carbide on the mechanical properties of the dental implant. Due to this, the dental implant having particularly excellent slidability can be obtained.

The content of N is preferably about 0.3 times or more and 10 times or less, more preferably about 2 times or more and 8 times or less of the content of C. By setting the ratio of the content of N to the content of C within the above range, particularly, both of the improvement of the slidability of the dental implant by the addition of C and the improvement of the mechanical properties of the dental implant by the addition of N can be achieved.

In addition, the alloy which forms the dental implant may contain, other than the elements described above, impurities inevitably generated during the production. In this case, the total content of the impurities is set to preferably 1% by mass or less, more preferably 0.5% by mass or less, further more preferably 0.2% by mass or less. Examples of such impurity elements include B, 0, Na, Mg, A1, P, S, and Mn.

On the other hand, it is preferred that the alloy which forms the dental implant does not substantially contain Ni (nickel). Ni is often contained in a given amount in a Co—Cr-based alloy for use in a living body in the related art for ensuring plastic workability. However, Ni is sometimes treated as a causative substance of metal allergy and is an element suspected to have an adverse effect on a living body. To the alloy which forms the dental implant, Ni is not added as a constituent element except for Ni inevitably mixed therein during the production. Therefore, the dental implant according to the invention hardly causes metal allergy, and thus has particularly high compatibility with a living body. Incidentally, in consideration of a case where Ni is inevitably mixed therein, the content of Ni is preferably 0.05% by mass or less, more preferably 0.03% by mass or less.

The remainder of the alloy which forms the dental implant other than the elements described above is Co. As described above, the content of Co is set to be the largest of the elements contained in the alloy which forms the dental implant.

The respective constituent elements of the alloy which forms the dental implant and the compositional ratio thereof can be determined by, for example, atomic absorption spectrometry specified in JIS G 1257, ICP optical emission spectroscopy specified in JIS G 1258, spark optical emission spectroscopy specified in JIS G 1253, X-ray fluorescence spectroscopy specified in JIS G 1256, gravimetry, titrimetry, and absorption spectroscopy specified in JIS G 1211 to G 1237, or the like. Specifically, an optical emission spectrometer for solids (spark optical emission spectrometer) manufactured by SPECTRO Analytical Instruments GmbH (model: SPECTROLAB, type: LAVMB08A) can be used.

Further, when C (carbon) and S (sulfur) are determined, particularly, an infrared absorption method after combustion in a current of oxygen (after combustion in a high-frequency induction furnace) specified in JIS G 1211 is also used. Specifically, a carbon-sulfur analyzer, CS-200 manufactured by LECO Corporation can be used.

Further, when N (nitrogen) and O (oxygen) are determined, particularly, a method for determination of nitrogen content in iron and steel specified in JIS G 1228 and a method for determination of oxygen content in metallic materials specified in JIS Z 2613 are also used. Specifically, an oxygen-nitrogen analyzer, TC-300/EF-300 manufactured by LECO Corporation can be used.

Each of the dental implants shown in FIGS. 11A to 11E is a member formed from a sintered body of a metal powder as described above, that is, it is a member produced by a powder metallurgy method. The mechanical properties of such a dental implant are improved as compared with a member produced by, for example, a casting method, a forging method, a rolling method, or the like. The dental implant produced by a powder metallurgy method is a member produced by using a metal powder obtained by quenching (since the volume is small, it is easily quenched), and therefore, significant grain growth of a metal crystal is more difficult to occur than in the case of using a casting method or the like. As a result, it is considered that it is difficult to form a metal crystal with an increased size in the dental implant, and thus, the mechanical properties of the dental implant are improved. Further, according to the powder metallurgy method, a homogeneous composition is easily obtained, and therefore, uniform distribution of Si and silicon oxide is also easily obtained. Accordingly, the dental implant having uniform slidability (an individual difference in slidability is small) can be obtained.

When the dental implant contains N, it is preferred that N is solid-dissolved in a material from the time when the metal powder is produced, and the dental implant is formed from a sintered body obtained by using the powder. In the dental implant produced in this manner, N is substantially uniformly distributed, and therefore, the physical properties of the entire dental implant can be made substantially uniform. Accordingly, such a dental implant has high homogeneity, and also an individual difference in physical properties can be made small.

It is considered that the reason why such a homogeneous dental implant is obtained is because as described above, N is solid-dissolved in the metal material from the time when the powder is produced, and the dental implant is formed from a sintered body produced by a powder metallurgy method using the powder. In order to solid-dissolve N in the metal material at the time when the powder is produced, for example, a method in which at least one element selected from Co, Cr, Mo, and Si contained in the starting material is nitrided in advance, a method in which a molten metal (a metal melt) is maintained in a nitrogen gas atmosphere when or after the starting material is melted, a method in which nitrogen gas is injected (bubbled) in a molten metal, or the like is used.

Further, there is also a method in which a molded body obtained by molding the metal powder or a sintered body obtained by sintering the molded body is heated in a nitrogen gas atmosphere or is subjected to an HIP treatment in a nitrogen gas atmosphere, whereby the alloy is impregnated with nitrogen (a nitriding treatment). However, in this method, it is difficult to uniformly nitride the molded body or the sintered body from a surface layer region to an inner layer region. Supposedly, in the case of performing a nitriding treatment, it is necessary to perform the treatment over an extremely long period of time while controlling the nitriding speed, and therefore, the method is a little problematic from the viewpoint of production efficiency of the dental implant.

When the molded body obtained by solid-dissolving N in the powder is degreased and fired, a variation in the concentration of solid-dissolved N can be suppressed by performing degreasing and firing in an inert gas such as nitrogen gas or argon gas.

As the metal powder to be used for the production of the dental implant, a powder formed from the alloy as described above is used. The average particle diameter thereof is preferably 3 μm or more and 100 μm or less, more preferably 4 μm or more and 80 μm or less, further more preferably 5 μm or more and 60 μm or less. By using a metal powder having such a particle diameter, the dental implant having high density, high mechanical properties such as proof stress, and excellent slidability can be produced.

The average particle diameter is obtained as a particle diameter when the cumulative amount on a mass basis from the smaller particle diameter side in the particle size distribution obtained by laser diffractometry is 50%.

If the average particle diameter of the metal powder is less than the above lower limit, the bulk density of the metal powder is decreased and the moldability in powder metallurgy is deteriorated, and therefore, the density of the dental implant is decreased so that the mechanical properties may be deteriorated. On the other hand, if the average particle diameter of the metal powder exceeds the above upper limit, the packing density of the metal powder in powder metallurgy is decreased, and therefore, also in this case, the density of the dental implant is decreased so that the mechanical properties may be deteriorated. Further, the uniformity of the composition may be deteriorated.

The particle size distribution of the metal powder is preferably as narrow as possible. Specifically, when the average particle diameter of the metal powder is within the above range, the maximum particle diameter is preferably 200 μm or less, more preferably 150 μm or less. By controlling the maximum particle diameter of the metal powder within the above range, the particle size distribution of the metal powder can be made narrower. According to this, the mechanical properties and slidability of the dental implant can be further improved.

Here, the “maximum particle diameter” refers to a particle diameter when the cumulative amount on a mass basis from the smaller particle diameter side in the particle size distribution obtained by laser diffractometry is 99.9%.

The average of the aspect ratio defined by PS/PL wherein PS (μm) represents the minor axis of each particle of the metal powder and PL (μm) represents the major axis thereof is preferably about 0.4 or more and 1 or less, more preferably about 0.7 or more and 1 or less. The particles having an aspect ratio within this range have a shape relatively close to a spherical shape, and therefore, the packing factor when the metal powder containing particles having such a particle diameter is compact-molded is increased. As a result, the dental implant having high mechanical properties and slidability can be obtained.

Here, the “major axis” is the maximum length in the projected image of the particle, and the “minor axis” is the maximum length in the direction orthogonal to the major axis. Incidentally, the average of the aspect ratio is obtained as an average of measurement values of 100 or more particles of the metal powder.

On the other hand, in the cross section of the dental implant, the average of the aspect ratio defined by CS/CL wherein CL represents the major axis of each crystal structure of the sintered body of the metal powder and CS represents the minor axis thereof is preferably about 0.4 or more and 1 or less, more preferably about 0.5 or more and 1 or less. The crystal structure having such an aspect ratio has small anisotropy, and therefore, the dental implant formed from the sintered body having such a crystal structure have high mechanical properties such as proof stress regardless of the direction of a force applied. That is, such a dental implant has excellent fracture resistance even if it is used in any posture. Therefore, a useful dental implant which is not limited to the place where it is used in the mouth can be obtained.

Here, the “major axis” is the maximum length in one crystal structure in the observation image of the cross section of the dental implant, and the “minor axis” is the maximum length in the direction orthogonal to the major axis. Incidentally, the average of the aspect ratio is obtained as an average of measurement values of 100 or more crystal structures.

It is preferred that the dental implant has independent small pores therein. By having such pores, in the dental implant, osteoclasts easily enter the pores. Accordingly, a period required for adhesion between the dental implant and the bone can be decreased. Further, a fixing force thereof to the bone is increased, and thus, the dental implant can be prevented from being pulled out due to mastication, bruxism, or the like.

The average diameter of the pores is preferably 0.1 μm or more and 10 μm or less, more preferably 0.3 μm or more and 8 μm or less. When the average diameter of the pores is within the above range, a decrease in the mechanical properties derived from the pores can be minimized while enhancing the entering of osteoclasts. That is, if the average diameter of the pores is less than the above lower limit, osteoclasts may not be able to sufficiently enter the pores, and on the other hand, if the average diameter of the pores exceeds the above upper limit, the mechanical properties of the dental implant may be deteriorated.

The average diameter of the pores can be obtained as an average of the diameter of a circle having the same area as that of a pore (projected area circle equivalent diameter) in a scanning electron microscopic image.

The ratio of the area occupied by the pores in the observation image of the dental implant is preferably 0.001% or more and 1% or less, more preferably 0.005% or more and 0.5% or less. When the ratio of the area occupied by the pores is within the above range, both of the mechanical properties and the machinability of the dental implant can be more highly achieved.

This area ratio is calculated as a ratio of the area occupied by the pores to the area of the observation image, and the length of one side of the observation image is set to about 50 μm or more and 1000 μm or less.

The Vickers hardness of the dental implant is preferably 200 or more and 480 or less, more preferably 240 or more and 380 or less. The dental implant having such a hardness is, for example, prevented from being deformed or the like when the dental implant is inserted into the jaw bone B50 using a tool or the like. According to this, the dental implant can be efficiently inserted into the jaw bone B50. If the Vickers hardness thereof is less than the above lower limit, when the dental implant is inserted into the jaw bone B50 using a tool or the like, the dental implant may be deformed. On the other hand, if the Vickers hardness thereof exceeds the above upper limit, the toughness is decreased depending on the composition of the alloy which forms the dental implant so that the impact resistance may be deteriorated.

The Vickers hardness of the dental implant is measured in accordance with the test method specified in JIS Z 2244.

The tensile strength of the dental implant is preferably 520 MPa or more, more preferably 600 MPa or more and 1500 MPa or less. The dental implant having such a tensile strength also has excellent deformation resistance over a long period of time.

Similarly, the 0.2% proof stress of the dental implant is preferably 450 MPa or more, more preferably 500 MPa or more and 1200 MPa or less. The dental implant having such a 0.2% proof stress can sufficiently ensure fracture resistance even when a load due to mastication, bruxism, or the like is applied to the dental implant over a long period of time. Accordingly, the dental implant can maintain the crown restoration B3 over a long period of time.

The tensile strength and the 0.2% proof stress of these members are measured in accordance with the test method specified in JIS Z 2241.

The elongation of the dental implant is preferably 2% or more and 50% or less, more preferably 10% or more and 45% or less. The dental implant having such an elongation is hardly chipped, cracked, or the like, and therefore has high reliability.

The elongation (elongation at break) of the dental implant is measured in accordance with the test method specified in JIS Z 2241.

The Young's modulus of the dental implant is preferably 150 GPa or more, more preferably 170 GPa or more and 300 GPa or less. The dental implant having such a Young's modulus is particularly hardly deformed, and therefore, for example, the deformation of the dental implant in an insertion operation hardly occurs, or the deformation of the dental implant due to mastication, bruxism, or the like hardly occurs. Accordingly, the dental implant having higher reliability can be obtained.

The fatigue strength of the dental implant is preferably 250 MPa or more, more preferably 350 MPa or more, further more preferably 500 MPa or more and 1000 MPa or less. Even if the dental implant having such a fatigue strength is used in an environment in which a load is repeatedly applied thereto in a state where the dental implant is in contact with a body fluid in the mouth, the occurrence of a fatigue crack or the like is prevented, and the dental implant can maintain the crown restoration B3 over a long period of time.

The fatigue strength of the dental implant is measured in accordance with the test method specified in JIS T 0309. The waveform of an applied load corresponding to a repeated stress is set to a sine wave, and the stress ratio (minimum stress/maximum stress) is set to 0.1. Further, the repeated frequency is set to 30 Hz, and the repeat count is set to 1×10⁷.

The arithmetic average roughness Ra of the surface of the dental implant is preferably 0.05 μm or more and 2 μm or less, more preferably 0.1 μm or more and 1 μm or less. By setting the surface roughness of the dental implant within the above range, when the dental implant is inserted into the jaw bone B50, the insertion operation can be efficiently performed. Further, the dental implant after insertion can be prevented from being unintentionally pulled out. If the surface roughness of the dental implant is less than the above lower limit, the slidability of the dental implant is too high so that the dental implant may be easily pulled out. Further, the affinity of the dental implant for the bone is deteriorated so that it may take a long period of time for the dental implant to adhere to the bone. On the other hand, if the surface roughness of the dental implant exceeds the above upper limit, the slidability of the dental implant is too low so that the efficiency of the insertion operation is deteriorated and also the efficiency of the pulling-out operation may be deteriorated.

The arithmetic average roughness Ra of the surface may be made different between the male screw portion B11 of the fixture B1 and the crown fixing portion B22 of the abutment B2. Specifically, the surface state may be made different between the male screw portion B11 and the crown fixing portion B22 so that the arithmetic average roughness Ra of the male screw portion B11 is smaller than that of the crown fixing portion B22. According to this, while enhancing the efficiency of the insertion operation of the dental implant (fixture B1), the adhesiveness between the dental implant (abutment B2) and the crown restoration B3 can be enhanced. As a result, an artificial tooth having higher reliability can be provided.

In this case, the arithmetic average roughness Ra of the male screw portion B11 is preferably about 0.3 times or more and 0.9 times or less of the arithmetic average roughness Ra of the crown fixing portion B22. Further, the arithmetic average roughness Ra of the crown fixing portion B22 varies depending on the surface state of the mold, but is preferably, for example, about 0.5 μm or more and 20 μm or less, more preferably about 1 μm or more and 10 μm or less.

Examples of the metal powder to be used for the production of the dental implant include metal powders produced by a variety of powdering methods such as an atomization method (such as a water atomization method, a gas atomization method, or a spinning water atomization method), a reducing method, a carbonyl method, and a pulverization method.

Among these, a metal powder produced by an atomization method is preferably used, and a metal powder produced by a water atomization method or a spinning water atomization method is more preferably used. The atomization method is a method in which a molten metal (a metal melt) is caused to collide with a fluid (a liquid or a gas) sprayed at a high speed to atomize the metal melt, followed by cooling, whereby a metal powder is produced. By producing the metal powder through such an atomization method, an extremely fine powder can be efficiently produced. Further, the shape of the particle of the obtained powder is closer to a spherical shape by the action of surface tension. Due to this, a molded body having a high packing factor is obtained when such a metal powder is molded by a powder metallurgy method. Accordingly, the dental implant having excellent mechanical properties can be obtained.

### Method for Producing Dental Component

Next, an embodiment of the method for producing a dental component according to the invention will be described.

The above-described dental orthodontic bracket, dental anchor, and dental implant shown in the first to third embodiments of the dental component according to the invention can be produced by using the method for producing a dental component according to the invention shown below.

The method for producing a dental component according to the invention includes a step of molding the above-described metal powder for powder metallurgy (metal powder for powder metallurgy according to the invention), thereby obtaining a molded body and a step of sintering this molded body, thereby obtaining a sintered body. Hereinafter, the respective steps will be sequentially described in detail.

(1)

### (1-1) Kneading Step

First, the metal powder for powder metallurgy is kneaded along with an organic binder, whereby a kneaded material is obtained.

The content of the organic binder in the kneaded material is appropriately set according to the molding conditions, the shape to be molded, and the like, but is preferably about 2% by mass or more and 20% by mass or less, more preferably about 5% by mass or more and 10% by mass or less with respect to the total amount of the kneaded material. By setting the content of the organic binder within the above range, the kneaded material has favorable fluidity. According to this, the packing density of the kneaded material during molding is improved, and a dental component (the dental orthodontic bracket 1, the dental anchor A1, or the dental implant B1) having a shape close to the final desired shape (near-net shape) can be obtained.

Examples of the organic binder include various resins including polyolefins such as polyethylene, polypropylene, and an ethylene-vinyl acetate copolymer, acrylic resins such as polymethyl methacrylate and polybutyl methacrylate, styrene-based resins such as polystyrene, polyesters such as polyvinyl chloride, polyvinylidene chloride, polyamide, polyethylene terephthalate, and polybutylene terephthalate, polyether, polyvinyl alcohol, polyvinylpyrrolidone, copolymers thereof, and the like, and various organic binders including various waxes, paraffins, higher fatty acids (such as stearic acid), higher alcohols, higher fatty acid esters, higher fatty acid amides, and the like, and one type or a mixture of two or more types among these can be used.

Further, to the kneaded material, a plasticizer may be added as needed. Examples of the plasticizer include phthalate esters (such as DOP, DEP, and DBP), adipate esters, trimellitate esters, and sebacate esters, and one type or a mixture of two or more types among these can be used.

Further, to the kneaded material, other than the metal powder for powder metallurgy, the organic binder, and the plasticizer, any of various additives such as a lubricant, an antioxidant, a degreasing accelerator, and a surfactant can be added as needed.

The kneading conditions vary depending on the respective conditions such as the metal composition and the particle diameter of the metal powder for powder metallurgy to be used, the composition of the organic binder, and the blending amount thereof. However, as one example, the kneading conditions can be set such that the kneading temperature is about 50° C. or higher and 200° C. or lower, and the kneading time is about 15 minutes or more and 210 minutes or less.

Further, the kneaded material is formed into a pellet (small particle) as needed. The particle diameter of the pellet is set to, for example, about 1 mm or more and 15 mm or less.

Incidentally, in place of the kneaded material, a granulated powder may be produced.

### (1-2) Molding Step

Subsequently, the kneaded material is molded, whereby a molded body having the same shape as that of the dental component (dental orthodontic bracket 1, dental anchor A1, or dental implant B1) is produced.

The molding method is not particularly limited, and for example, any of a variety of molding methods such as a compact molding (compression molding) method, a metal powder injection molding (MIM: Metal Injection Molding) method, and an extrusion molding method can be used. Among these methods, from the viewpoint that the bracket 1 having a near-net shape can be produced, a metal powder injection molding method is preferably used.

The molding conditions in the case of a compact molding method are preferably such that the molding pressure is about 200 MPa or more and 1000 MPa or less (2 t/cm² or more and 10 t/cm² or less), which vary depending on the respective conditions such as the composition and the particle diameter of the metal powder for powder metallurgy to be used, the composition of the organic binder, and the blending amount thereof.

The molding conditions in the case of a metal powder injection molding method are preferably such that the material temperature is about 80° C. or higher and 210° C. or lower, and the injection pressure is about 50 MPa or more and 500 MPa or less (0.5 t/cm² or more and 5 t/cm² or less), which also vary depending on the respective conditions.

The molding conditions in the case of an extrusion molding method are preferably such that the material temperature is about 80° C. or higher and 210° C. or lower, and the extrusion pressure is about 50 MPa or more and 500 MPa or less (0.5 t/cm² or more and 5 t/cm² or less), which also vary depending on the respective conditions.

The thus obtained molded body is in a state where the organic binder is uniformly distributed in the spaces among the particles of the metal powder.

The shape and size of the molded body to be produced are determined in anticipation of shrinkage of the molded body in the subsequent degreasing step and firing step.

The molded body may be subjected to a mechanical process such as machining, polishing, or cutting as needed. The molded body has a relatively low hardness and relative high plasticity, and therefore, a machining process can be easily performed while preventing the molded body from losing its shape. According to such a mechanical process, the dental component having high dimensional accuracy in the end can be more easily obtained.

(2)

### (2-1) Degreasing Step

Subsequently, the thus obtained molded body is subjected to a degreasing treatment (binder removal treatment), whereby a degreased body is obtained.

Specifically, the degreasing treatment is performed as follows: the organic binder is decomposed by heating the molded body, whereby the organic binder is removed at least partially from the molded body.

Examples of the degreasing treatment include a method of heating the molded body and a method of exposing the molded body to a gas capable of decomposing the binder.

In the case of using the method of heating the molded body, the conditions for heating the molded body are preferably such that the temperature is about 100° C. or higher and 750° C. or lower, and the time is about 0.1 hours or more and 20 hours or less, and more preferably such that the temperature is about 150° C. or higher and 600° C. or lower, and the time is about 0.5 hours or more and 15 hours or less, which slightly vary depending on the composition and the blending amount of the organic binder. According to this, the degreasing of the molded body can be necessarily and sufficiently performed without sintering the molded body. As a result, it is possible to reliably prevent a large amount of the organic binder component from remaining inside the degreased body.

The atmosphere when the molded body is heated is not particularly limited, and an atmosphere of a reducing gas such as hydrogen, an atmosphere of an inert gas such as nitrogen or argon, an atmosphere of an oxidative gas such as air, a reduced pressure atmosphere obtained by reducing the pressure of such an atmosphere, or the like can be used.

Examples of the gas capable of decomposing the binder include ozone gas.

Incidentally, by dividing this degreasing step into multiple steps in which the degreasing conditions are different, and performing the multiple steps, the organic binder in the molded body can be more rapidly decomposed and removed so that the organic binder does not remain in the molded body.

Further, according to need, the degreased body may be subjected to a machining process such as machining, polishing, or cutting. The degreased body has a relatively low hardness and relatively high plasticity, and therefore, the machining process can be easily performed while preventing the degreased body from losing its shape. According to such a mechanical process, the dental component having high dimensional accuracy in the end can be more easily obtained.

### (2-2) Firing Step

The degreased body obtained in the above step (2-1) is fired in a firing furnace, whereby a sintered body is obtained. That is, diffusion occurs at the boundary surface between the particles of the metal powder for powder metallurgy so that sintering is achieved. As a result, a sintered body is obtained.

The firing temperature varies depending on the composition, the particle diameter, and the like of the metal powder for powder metallurgy, but is set to, for example, about 900° C. or higher and 1400° C. or lower, preferably set to about 1050° C. or higher and 1300° C. or lower.

Further, the firing time is set to 0.2 hours or more and 7 hours or less, preferably set to about 1 hour or more and 6 hours or less.

In the firing step, the firing temperature or the below-described firing atmosphere may be changed during the step.

The atmosphere when firing is not particularly limited, however, in consideration of prevention of significant oxidation of the metal powder, an atmosphere of a reducing gas such as hydrogen, an atmosphere of an inert gas such as argon, a reduced pressure atmosphere obtained by reducing the pressure of such an atmosphere, or the like is preferably used.

For the thus obtained sintered body, further an HIP treatment (hot isostatic pressing treatment) or the like may be performed. By doing this, the density of the sintered body is further increased, and thus, the dental component having more excellent mechanical properties can be obtained.

The conditions for the HIP treatment are set such that, for example, the temperature is 850° C. or higher and 1200° C. or lower, and the time is about 1 hour or more and 10 hours or less.

Further, the pressure to be applied is preferably 50 MPa or more, more preferably 100 MPa or more.

In this manner, the dental component (dental orthodontic bracket 1, dental anchor A1, or dental implant B1) can be obtained.

Incidentally, according to need, the thus obtained dental component may be subjected to a polishing treatment. Examples of the polishing treatment include barrel polishing and sand blasting.

The thus obtained sintered body is useful as a dental alloy material (dental alloy material according to the invention) which forms a variety of dental components including the above-described dental components (dental orthodontic bracket 1, dental anchor A1, and dental implant B1). Therefore, by subjecting the obtained sintered body to, for example, a machining process such as cutting or grinding, a laser process, an electron beam process, a water jet process, an electrical discharge process, a pressing process, an extrusion process, a rolling process, a forging process, a bending process, a squeezing process, a drawing process, a roll-forming process, or a shearing process, the sintered body is molded into a desired shape, whereby a variety of dental components can be produced. Examples of the dental components include dental orthodontic brackets, dental endosseous implant materials, dental implant fixtures, dental implant abutments, dental abutment screws, orthodontic anchors (anchor screws), orthodontic buccal tubes, orthodontic archwires, ligature wires, power chains, inlays, crowns, bridges, clasps, denture bases, and metal frames for porcelain bonding.

Such a dental component produced by using the above-described sintered body has excellent mechanical properties such as proof stress, and therefore, a prosthesis which is hardly deformed against, for example, a chewing force or the like, and a component capable of continuously applying a force to a tooth over a long period of time in orthodontic treatment can be produced. Further, since such a dental component has excellent corrosion resistance, even when it is placed in the mouth or inserted into the bone or the like, metal allergy or the like is hardly caused, and the biocompatibility is high.

Further, the above-described metal powder for powder metallurgy according to the invention can also be used in the production of a variety of dental components as described above by appropriately selecting the shape of the molded body. That is, by using the metal powder for powder metallurgy, the dental component having a desired shape can be easily produced almost without performing any process. The obtained dental component has excellent mechanical properties such as proof stress and also excellent corrosion resistance as described above.

Hereinabove, the dental component, the dental alloy material, the metal powder for powder metallurgy, and the method for producing a dental orthodontic bracket are described with reference to preferred embodiments, however, the invention is not limited thereto.

For example, the shape of the dental orthodontic bracket according to the first embodiment of the dental component described above is an example, and may be any shape as long as it is a shape capable of being attached to the surface of a tooth and also capable of supporting an archwire.

Further, to the dental components of the respective embodiments of the invention, an arbitrary structure may be added with respect to the above-described respective embodiments.

### EXAMPLES

Next, specific examples of the invention will be described.

### Examples of First Embodiment of Dental Component

### 1. Production of Dental Orthodontic Bracket

### Example 1A

(1) First, a starting material having an alloy composition shown in Table 1 was melted in a high-frequency induction furnace, whereby a molten material of the starting material was obtained. Then, the obtained molten material of the starting material was powdered by a water atomization method, whereby a metal powder was obtained. Subsequently, the particles of the obtained metal powder were classified using a standard sieve having a mesh size of 150 μm. Incidentally, in the determination of the alloy composition, an optical emission spectrometer for solids (a spark optical emission spectrometer) manufactured by SPECTRO Analytical Instruments GmbH (model: Spectrolab, type: LAVMB08A) was used. Further, in the quantitative analysis of C (carbon) in the particles of the metal powder, a carbon/sulfur analyzer CS-200 manufactured by LECO Corporation was used.

(2) Subsequently, the metal powder and a mixture (an organic binder) of polypropylene and a wax were weighed such that the mass ratio thereof was 9:1, followed by mixing, whereby a mixed starting material was obtained.

(3) Subsequently, this mixed starting material was kneaded using a kneader, whereby a kneaded material was obtained.

(4) Subsequently, this kneaded material was molded using an injection molding machine under the following molding conditions, whereby a molded body was produced.

### Molding Conditions

Temperature of material: 150° C.
Injection pressure: 11 MPa (110 kgf/cm²)

(5) Subsequently, this molded body was degreased under the following degreasing conditions, whereby a degreased body was obtained.

### Degreasing Conditions

Degreasing temperature: 470° C.
Degreasing time: 1 hour
Degreasing atmosphere: nitrogen atmosphere

(6) Subsequently, the obtained degreased body was fired under the following firing conditions, whereby a sintered body was obtained.

### Firing Conditions

Firing temperature: 1300° C.
Firing time: 3 hours
Firing atmosphere: argon atmosphere

(7) Subsequently, the obtained sintered body was subjected to a barrel polishing treatment. By doing this, a dental orthodontic bracket having a shape shown in FIG. 1 was obtained.

### Examples 2A to 11A and Comparative Examples 1A and 2A

Sintered bodies (dental orthodontic brackets each having a shape shown in FIG. 1) were obtained in the same manner as in Example 1A except that the production conditions were changed to the conditions shown in Table 1, respectively.

### Comparative Examples 3A and 4A

A starting material having an alloy composition shown in Table 1 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a dental orthodontic bracket having a shape shown in FIG. 1 was obtained.

### Comparative Examples 5A to 7A

Dental orthodontic brackets were obtained in the same manner as in Example 1A except that the production conditions were changed to the conditions shown in Table 1, respectively.

### Comparative Examples 8A to 10A

A starting material having an alloy composition shown in Table 1 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a dental orthodontic bracket having a shape shown in FIG. 1 was obtained.

TABLE 1

| | | Dental orthodontic bracket | | | | | | | | | |
|---|---|---|---|---|---|---|---|---|---|---|---|
| | | Alloy composition | | | | | | | | | |
| | | Cr | Mo | Si | C | N | Ni | Co | | | Production |
| | | % by mass | | | | | | | Si/Mo | C/Si | method |
| Sample No. 1 | Example 1A | 29.0 | 6.04 | 0.70 | 0.05 | 0.00 | 0.01 | remainder | 0.116 | 0.071 | Powder |
| | | | | | | | | | | | metallurgy |
| Sample No. 2 | Example 2A | 27.4 | 8.53 | 0.95 | 0.04 | 0.00 | 0.01 | remainder | 0.111 | 0.042 | Powder |
| | | | | | | | | | | | metallurgy |
| Sample No. 3 | Example 3A | 28.3 | 7.24 | 0.86 | 0.05 | 0.00 | 0.01 | remainder | 0.119 | 0.058 | Powder |
| | | | | | | | | | | | metallurgy |
| Sample No. 4 | Example 4A | 26.2 | 5.30 | 0.52 | 0.02 | 0.00 | 0.01 | remainder | 0.098 | 0.038 | Powder |
| | | | | | | | | | | | metallurgy |
| Sample No. 5 | Example 5A | 31.8 | 6.54 | 0.75 | 0.07 | 0.00 | 0.01 | remainder | 0.115 | 0.093 | Powder |
| | | | | | | | | | | | metallurgy |
| Sample No. 6 | Example 6A | 33.4 | 9.25 | 0.64 | 0.12 | 0.00 | 0.01 | remainder | 0.069 | 0.188 | Powder |
| | | | | | | | | | | | metallurgy |
| Sample No. 7 | Example 7A | 34.6 | 11.50 | 0.94 | 0.31 | 0.00 | 0.01 | remainder | 0.082 | 0.330 | Powder |
| | | | | | | | | | | | metallurgy |
| Sample No. 8 | Example 8A | 27.2 | 5.52 | 0.97 | 0.08 | 0.00 | 0.01 | remainder | 0.176 | 0.082 | Powder |
| | | | | | | | | | | | metallurgy |
| Sample No. 9 | Example 9A | 26.5 | 7.79 | 0.83 | 0.15 | 0.00 | 0.02 | remainder | 0.107 | 0.181 | Powder |
| | | | | | | | | | | | metallurgy |
| Sample No. 10 | Example 10A | 29.8 | 5.87 | 0.65 | 1.24 | 0.00 | 0.02 | remainder | 0.111 | 1.908 | Powder |
| | | | | | | | | | | | metallurgy |
| Sample No. 11 | Example 11A | 28.6 | 6.12 | 0.74 | 0.00 | 0.00 | 0.02 | remainder | 0.121 | 0.000 | Powder |
| | | | | | | | | | | | metallurgy |
| Sample No. 12 | Comparative Example 1A | 29.4 | 5.89 | 0.26 | 0.06 | 0.00 | 0.85 | remainder | 0.044 | 0.231 | Powder |
| | | | | | | | | | | | metallurgy |
| Sample No. 13 | Comparative Example 2A | 31.6 | 6.74 | 2.06 | 0.06 | 0.00 | 0.77 | remainder | 0.306 | 0.029 | Powder |
| | | | | | | | | | | | metallurgy |
| Sample No. 14 | Comparative Example 3A | 30.5 | 6.23 | 0.75 | 0.04 | 0.00 | 0.02 | remainder | 0.120 | 0.053 | Casting |
| Sample No. 15 | Comparative Example 4A | 28.4 | 11.60 | 0.87 | 0.11 | 0.00 | 0.89 | remainder | 0.075 | 0.126 | Casting |

| | | | | | |
|---|---|---|---|---|---|
| Sample No. 16 | Comparative Example 5A | Ti | — | — | Powder |
| | | | | | metallurgy |
| Sample No. 17 | Comparative Example 6A | Ti-6Al-4V | — | — | Powder |
| | | | | | metallurgy |
| Sample No. 18 | Comparative Example 7A | 17-4PH stainless steel | — | — | Powder |
| | | | | | metallurgy |
| Sample No. 19 | Comparative Example 8A | Ti | — | — | Casting |
| Sample No. 20 | Comparative Example 9A | Ti-6Al-4V | — | — | Casting |
| Sample No. 21 | Comparative Example 10A | 17-4PH stainless steel | — | — | Casting |

### Example 12A

(1) First, a starting material having an alloy composition shown in Table 2 was melted in a high-frequency induction furnace, whereby a molten material of the starting material was obtained. Then, the obtained molten material of the starting material was powdered by a water atomization method, whereby a metal powder was obtained. Subsequently, the particles of the obtained metal powder were classified using a standard sieve having a mesh size of 150 μm. Incidentally, N was incorporated in the starting material in a state where N was attached to Cr (a state of chromium nitride). Further, in the determination of the alloy composition, an optical emission spectrometer for solids (a spark optical emission spectrometer) manufactured by SPECTRO Analytical Instruments GmbH (model: Spectrolab, type: LAVMB08A) was used. Further, in the quantitative analysis of C (carbon) in the particles of the metal powder, a carbon/sulfur analyzer CS-200 manufactured by LECO Corporation was used. Further, in the quantitative analysis of N (nitrogen) in the particles of the metal powder, an oxygen-nitrogen analyzer, TC-300/EF-300 manufactured by LECO Corporation was used.

(2) Subsequently, the metal powder and a mixture (an organic binder) of polypropylene and a wax were weighed such that the mass ratio thereof was 9:1, followed by mixing, whereby a mixed starting material was obtained.

(3) Subsequently, this mixed starting material was kneaded using a kneader, whereby a kneaded material was obtained.

(4) Subsequently, this kneaded material was molded using an injection molding machine under the following molding conditions, whereby a molded body was produced.

### Molding Conditions

Temperature of material: 150° C.
Injection pressure: 11 MPa (110 kgf/cm²)

(5) Subsequently, the obtained molded body was subjected to a heat treatment (degreasing treatment) under the following degreasing conditions, whereby a degreased body was obtained.

### Degreasing Conditions

Degreasing temperature: 470° C.
Degreasing time: 1 hour
Degreasing atmosphere: nitrogen atmosphere

(6) Subsequently, the obtained degreased body was fired under the following firing conditions, whereby a sintered body was obtained.

### Firing Conditions

Firing temperature: 1300° C.
Firing time: 3 hours
Firing atmosphere: argon atmosphere

(7) Subsequently, the obtained sintered body was subjected to a barrel polishing treatment. By doing this, a dental orthodontic bracket having a shape shown in FIG. 1 was obtained.

### Examples 13A to 25A

Dental orthodontic brackets were obtained in the same manner as in Example 12A except that the production conditions were changed to the conditions shown in Table 2, respectively.

### Examples 26A to 28A

When a starting material was melted in a high-frequency induction furnace, nitrogen gas was injected into the molten metal. At this time, by appropriately changing the injection time, the content of N was changed.

Then, dental orthodontic brackets were obtained in the same manner as in Example 12A except that the production conditions other than this were changed to the conditions shown in Table 2, respectively.

### Examples 30A to 33A

First, a metal powder was obtained in the same manner as in Example 12A by using a starting material containing no N.

Subsequently, a sintered body was obtained in the same manner as in Example 12A except that the obtained metal powder was used, and also the firing atmosphere in the firing conditions was changed to a mixed gas atmosphere containing argon at 50% by volume and nitrogen at 50% by volume. At this time, by appropriately changing the partial pressure of nitrogen gas, the content of N contained in the metal powder was changed.

Then, dental orthodontic brackets were obtained in the same manner as in Example 12A except that the production conditions other than this were changed to the conditions shown in Table 2, respectively.

### Comparative Examples 11A to 13A

A starting material having an alloy composition shown in Table 2 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a dental orthodontic bracket as obtained.

TABLE 2

| | | Dental orthodontic bracket | | | | | | | | | | | | | |
|---|---|---|---|---|---|---|---|---|---|---|---|---|---|---|---|
| | | Alloy composition | | | | | | | | | | | N | Pro- | With or |
| | | Cr | Mo | Si | C | N | Ni | Co | | | | | impregnation | duction | without |
| | | % by mass | | | | | | | Si/Mo | C/Si | N/Si | N/C | method | method | polishing |
| Sample | Example | 29.8 | 6.80 | 0.78 | 0.02 | 0.13 | 0.01 | re- | 0.115 | 0.026 | 0.167 | 6.50 | Metal nitride | Powder | With |
| No. 22 | 12A | | | | | | | main- | | | | | starting | metallurgy | polishing |
| | | | | | | | | der | | | | | material | | |
| Sample | Example | 27.3 | 8.43 | 0.96 | 0.04 | 0.18 | 0.01 | re- | 0.114 | 0.042 | 0.188 | 4.50 | Metal nitride | Powder | With |
| No. 23 | 13A | | | | | | | main- | | | | | starting | metallurgy | polishing |
| | | | | | | | | der | | | | | material | | |
| Sample | Example | 28.5 | 7.21 | 0.83 | 0.03 | 0.12 | 0.01 | re- | 0.115 | 0.036 | 0.145 | 4.00 | Metal nitride | Powder | With |
| No. 24 | 14A | | | | | | | main- | | | | | starting | metallurgy | polishing |
| | | | | | | | | der | | | | | material | | |
| Sample | Example | 26.1 | 5.32 | 0.34 | 0.02 | 0.09 | 0.01 | re- | 0.064 | 0.059 | 0.265 | 4.50 | Metal nitride | Powder | With |
| No. 25 | 15A | | | | | | | main- | | | | | starting | metallurgy | polishing |
| | | | | | | | | der | | | | | material | | |
| Sample | Example | 31.9 | 6.50 | 0.71 | 0.07 | 0.23 | 0.01 | re- | 0.109 | 0.099 | 0.324 | 3.29 | Metal nitride | Powder | With |
| No. 26 | 16A | | | | | | | main- | | | | | starting | metallurgy | polishing |
| | | | | | | | | der | | | | | material | | |
| Sample | Example | 33.5 | 9.27 | 0.65 | 0.13 | 0.28 | 0.01 | re- | 0.070 | 0.200 | 0.431 | 2.15 | Metal nitride | Powder | With |
| No. 27 | 17A | | | | | | | main- | | | | | starting | metallurgy | polishing |
| | | | | | | | | der | | | | | material | | |
| Sample | Example | 34.9 | 11.80 | 0.95 | 0.35 | 0.27 | 0.01 | re- | 0.081 | 0.368 | 0.284 | 0.77 | Metal nitride | Powder | With |
| No. 28 | 18A | | | | | | | main- | | | | | starting | metallurgy | polishing |
| | | | | | | | | der | | | | | material | | |
| Sample | Example | 27.1 | 5.49 | 0.96 | 0.07 | 0.11 | 0.01 | re- | 0.175 | 0.073 | 0.115 | 1.57 | Metal nitride | Powder | With |
| No. 29 | 19A | | | | | | | main- | | | | | starting | metallurgy | polishing |
| | | | | | | | | der | | | | | material | | |
| Sample | Example | 26.1 | 5.11 | 0.83 | 0.04 | 0.12 | 0.02 | re- | 0.162 | 0.048 | 0.145 | 3.00 | Metal nitride | Powder | With |
| No. 30 | 20A | | | | | | | main- | | | | | starting | metallurgy | polishing |
| | | | | | | | | der | | | | | material | | |
| Sample | Example | 29.9 | 10.75 | 0.65 | 1.19 | 0.21 | 0.02 | re- | 0.060 | 1.831 | 0.323 | 0.18 | Metal nitride | Powder | With |
| No. 31 | 21A | | | | | | | main- | | | | | starting | metallurgy | polishing |
| | | | | | | | | der | | | | | material | | |
| Sample | Example | 29.8 | 6.80 | 0.78 | 0.05 | 0.26 | 0.01 | re- | 0.115 | 0.064 | 0.333 | 5.20 | Metal nitride | Powder | With |
| No. 32 | 22A | | | | | | | main- | | | | | starting | metallurgy | polishing |
| | | | | | | | | der | | | | | material | | |
| Sample | Example | 27.3 | 8.43 | 0.96 | 0.04 | 0.36 | 0.01 | re- | 0.114 | 0.042 | 0.375 | 9.00 | Metal nitride | Powder | Without |
| No. 33 | 23A | | | | | | | main- | | | | | starting | metallurgy | polishing |
| | | | | | | | | der | | | | | material | | |
| Sample | Example | 28.5 | 7.21 | 0.83 | 0.03 | 0.24 | 0.01 | re- | 0.115 | 0.036 | 0.289 | 8.00 | Metal nitride | Powder | Without |
| No. 34 | 24A | | | | | | | main- | | | | | starting | metallurgy | polishing |
| | | | | | | | | der | | | | | material | | |
| Sample | Example | 26.1 | 5.32 | 0.54 | 0.00 | 0.18 | 0.01 | re- | 0.102 | 0.000 | 0.333 | — | Metal nitride | Powder | Without |
| No. 35 | 25A | | | | | | | main- | | | | | starting | metallurgy | polishing |
| | | | | | | | | der | | | | | material | | |
| Sample | Example | 31.9 | 6.50 | 0.71 | 0.03 | 0.46 | 0.01 | re- | 0.109 | 0.042 | 0.648 | 15.33 | Injection into | Powder | With |
| No. 36 | 26A | | | | | | | main- | | | | | molten metal | metallurgy | polishing |
| | | | | | | | | der | | | | | | | |
| Sample | Example | 27.1 | 5.49 | 0.96 | 0.07 | 0.35 | 0.01 | re- | 0.175 | 0.073 | 0.365 | 5.00 | Injection into | Powder | With |
| No. 37 | 27A | | | | | | | main- | | | | | molten metal | metallurgy | polishing |
| | | | | | | | | der | | | | | | | |
| Sample | Example | 26.1 | 5.11 | 0.83 | 0.04 | 0.31 | 0.02 | re- | 0.162 | 0.048 | 0.373 | 7.75 | Injection into | Powder | With |
| No. 38 | 28A | | | | | | | main- | | | | | molten metal | metallurgy | polishing |
| | | | | | | | | der | | | | | | | |
| Sample | Example | 29.9 | 6.52 | 0.65 | 1.19 | 0.42 | 0.02 | re- | 0.100 | 1.831 | 0.646 | 0.35 | Injection into | Powder | With |
| No. 39 | 29A | | | | | | | main- | | | | | molten metal | metallurgy | polishing |
| | | | | | | | | der | | | | | | | |
| Sample | Example | 29.1 | 5.88 | 0.71 | 0.02 | 0.01 | 0.01 | re- | 0.121 | 0.028 | 0.014 | 0.50 | Nitriding | Powder | With |
| No. 40 | 30A | | | | | | | main- | | | | | during | metallurgy | polishing |
| | | | | | | | | der | | | | | sintering | | |
| Sample | Example | 32.4 | 6.78 | 1.45 | 0.06 | 0.03 | 0.02 | re- | 0.214 | 0.041 | 0.021 | 0.50 | Nitriding | Powder | With |
| No. 41 | 31A | | | | | | | main- | | | | | during | metallurgy | polishing |
| | | | | | | | | der | | | | | sintering | | |
| Sample | Example | 33.5 | 9.27 | 0.65 | 0.13 | 0.56 | 0.01 | re- | 0.070 | 0.200 | 0.862 | 4.31 | Nitriding | Powder | With |
| No. 42 | 32A | | | | | | | main- | | | | | during | metallurgy | polishing |
| | | | | | | | | der | | | | | sintering | | |
| Sample | Example | 34.9 | 11.80 | 0.95 | 0.35 | 0.54 | 0.01 | re- | 0.081 | 0.368 | 0.568 | 1.54 | Nitriding | Powder | With |
| No. 43 | 33A | | | | | | | main- | | | | | during | metallurgy | polishing |
| | | | | | | | | der | | | | | sintering | | |
| Sample | Com- | 29.2 | 6.11 | 0.65 | 0.04 | 0.32 | 0.02 | re- | 0.106 | 0.062 | 0.492 | 8.00 | Injection into | Casting | With |
| No. 44 | parative | | | | | | | main- | | | | | molten metal | | polishing |
| | Example | | | | | | | der | | | | | | | |
| | 11A | | | | | | | | | | | | | | |
| Sample | Com- | 27.9 | 5.82 | 0.69 | 0.02 | 0.45 | 0.03 | re- | 0.119 | 0.029 | 0.652 | 22.50 | Injection into | Casting | With |
| No. 45 | parative | | | | | | | main- | | | | | molten metal | | polishing |
| | Example | | | | | | | der | | | | | | | |
| | 12A | | | | | | | | | | | | | | |
| Sample | Com- | 30.1 | 6.99 | 0.61 | 0.05 | 0.39 | 0.10 | re- | 0.087 | 0.082 | 0.639 | 7.80 | Injection into | Casting | With |
| No. 46 | parative | | | | | | | main- | | | | | molten metal | | polishing |
| | Example | | | | | | | der | | | | | | | |
| | 13A | | | | | | | | | | | | | | |

### 2. Evaluation of Dental Orthodontic Bracket

### 2.1 Measurement of Total Amount of Si and Content of Si Contained as Silicon Oxide

For each of the dental orthodontic brackets of the respective Examples and Comparative Examples, the total amount of Si and the content of Si contained as silicon oxide were measured by gravimetry and ICP optical emission spectroscopy. The measurement results are shown in Tables 3 and 4.

### 2.2 Evaluation of Crystal Structure by X-Ray Diffractometry

For each of the dental orthodontic brackets of the respective Examples and Comparative Examples, a crystal structure analysis was performed by X-ray diffractometry. Then, the height and the position of each peak contained in an obtained X-ray diffraction pattern were collated with the database listed in ICDD card, whereby the crystal structure contained in the dental orthodontic bracket was identified. Then, when the height of the highest peak among the peaks derived from Co was assumed to be 1, the height of the highest peak among the peaks derived from Co₃Mo was calculated. The calculation results are shown in Tables 3 and 4.

### 2.3 Evaluation of Pore, Dendrite Phase, and Aspect Ratio of Crystal Structure

A test piece was cut out by a machining process from each of the dental orthodontic brackets of the respective Examples and Comparative Examples.

Then, the machined surface of the test piece was polished. Subsequently, the obtained polished surface was observed with a scanning electron microscope, and a region occupied by a pore in the observation image was specified. Then, the average diameter of the region occupied by a pore (this is regarded as the average diameter of a pore) was measured, and also the ratio of the area of the region occupied by a pore to the total area of the observation image (area ratio) was calculated.

Further, by observing the obtained polished surface with a scanning electron microscope and confirming the degree of existence of a dendritic structure in the observation image, the degree of existence of the dendrite phase was evaluated according to the following evaluation criteria.

### Evaluation Criteria for Dendrite Phase

A: Almost no dendrite phase exists.
B: A dendrite phase exists in a slight amount (at an area ratio of 10% or less).
C: A dendrite phase exists in a slightly large amount (at an area ratio of more than 10% and 20% or less).
D: A dendrite phase exists in a very large amount (at an area ratio of more than 20%).

Further, the obtained polished surface was observed with a scanning electron microscope, and an average of the aspect ratio of a crystal structure in the observation image was calculated.

The above evaluation results are shown in Tables 3 and 4.

### 2.4 Measurement of Vickers Hardness

For the surface of each of the dental orthodontic brackets of the respective Examples and Comparative Examples, the Vickers hardness was measured. The measurement results are shown in Tables 3 and 4.

### 2.5 Evaluation of Corrosion Resistance

A test piece was cut out by a machining process from each of the dental orthodontic brackets of the respective Examples and Comparative Examples.

Subsequently, for each of the obtained test pieces, the amount of eluted metal ions was measured in accordance with the test method for corrosion resistance of a noble metal material for dental metal-ceramic restoration specified in JIS T 6118.

Then, the measurement results were evaluated based on the following evaluation criteria.

### Evaluation Criteria for Corrosion Resistance

A: The corrosion resistance is very high (the amount of eluted metal ions is very small).
B: The corrosion resistance is high (the amount of eluted metal ions is small).
C: The corrosion resistance is low (the amount of eluted metal ions is large).
D: The corrosion resistance is very low (the amount of eluted metal ions is very large).

The above evaluation results are shown in Tables 3 and 4.

### 2.6 Measurement of 0.2% Proof Stress, Elongation, and Young's Modulus

A test piece was cut out by a machining process from each of the dental orthodontic brackets of the respective Examples and Comparative Examples.

Subsequently, for the obtained test pieces, the 0.2% proof stress and the elongation were measured in accordance with the test method for mechanical properties of a noble metal material for dental metal-ceramic restoration specified in JIS T 6118.

Further, the Young's modulus was obtained in accordance with the test method for a dental metal material specified in JIS T 6004.

The measurement results are shown in Tables 3 and 4.

### 2.7 Measurement of Fatigue Strength

A test piece was cut out by a machining process from each of the dental orthodontic brackets of the respective Examples and Comparative Examples.

Subsequently, for the obtained test pieces, the fatigue strength was measured in accordance with the test method specified in JIS T 0309.

The measurement results are shown in Tables 3 and 4.

### 2.8 Measurement of Surface Roughness

For each of the dental orthodontic brackets of the respective Examples and Comparative Examples, the arithmetic average roughness Ra of an archwire slot was measured using a stylus-type surface roughness tester.

The measurement results are shown in Tables 3 and 4.

### 2.9 Evaluation of Slidability for Archwire

First, each of the dental orthodontic brackets of the respective Examples and Comparative Examples was put into a closed state, and an archwire made of a Ti alloy was inserted into the archwire slot and supported thereby.

Subsequently, the archwire was pulled and a force applied to the dental orthodontic bracket was measured, whereby the slidability of the dental orthodontic bracket for the archwire was evaluated. This evaluation was performed based on the following evaluation criteria.

### Evaluation Criteria for Slidability

A: The slidability is very favorable.
B: The slidability is favorable.
C: The slidability is slightly favorable.
D: The slidability is unfavorable.

The above evaluation results are shown in Tables 3 and 4.

2.10 Evaluation of Degree of Application of Torque through Archwire

First, each of the dental orthodontic brackets of the respective Examples and Comparative Examples was put into a closed state, and an archwire made of a Ti alloy was inserted into the archwire slot and supported thereby.

Subsequently, the degree of change in force applied to the dental orthodontic bracket was measured while pulling the archwire. Then, the obtained degree of change in force was evaluated based on the following evaluation criteria.

### Evaluation Criteria for Degree of Application of Torque

A: The degree of application of torque is particularly favorable (the degree of change is particularly low).
B: The degree of application of torque is favorable (the degree of change is low).
C: The degree of application of torque is slightly favorable (the degree of change is slightly low).
D: The degree of application of torque is unfavorable (the degree of change is high).
   The above evaluation results are shown in Tables 3 and 4.

TABLE 3

| | | Dental orthodontic bracket | | | | | | | |
|---|---|---|---|---|---|---|---|---|---|
| | | Evaluation results | | | | | | | |
| | | | Ratio of | | | Arithmetic | | | |
| | | SiO₂/ | height | Pore | | average | | | |
| | | total | of peak | Average | Area | roughness | Dendrite | Corrosion | |
| | | Si | in XRD | diameter | ratio | Ra | phase | resistance | |
| | | % | — | μm | % | μm | — | — | |
| Sample | Example 1A | 0.53 | 0.22 | 0.53 | 0.025 | 0.24 | A | A | |
| No. 1 | | | | | | | | | |
| Sample | Example 2A | 0.36 | 0.31 | 0.66 | 0.038 | 0.31 | A | A | |
| No. 2 | | | | | | | | | |
| Sample | Example 3A | 0.45 | 0.27 | 0.58 | 0.032 | 0.12 | A | A | |
| No. 3 | | | | | | | | | |
| Sample | Example 4A | 0.24 | 0.25 | 0.74 | 0.051 | 0.08 | A | B | |
| No. 4 | | | | | | | | | |
| Sample | Example 5A | 0.49 | 0.38 | 0.35 | 0.022 | 0.36 | A | A | |
| No. 5 | | | | | | | | | |
| Sample | Example 6A | 0.32 | 0.42 | 0.89 | 0.087 | 0.41 | A | A | |
| No. 6 | | | | | | | | | |
| Sample | Example 7A | 0.28 | 0.48 | 0.97 | 0.097 | 0.56 | A | A | |
| No. 7 | | | | | | | | | |
| Sample | Example 8A | 0.66 | 0.16 | 0.45 | 0.121 | 0.91 | A | A | |
| No. 8 | | | | | | | | | |
| Sample | Example 9A | 0.77 | 0.36 | 0.43 | 0.112 | 0.23 | A | B | |
| No. 9 | | | | | | | | | |
| Sample | Example 10A | 0.55 | 0.63 | 0.75 | 0.089 | 0.18 | A | B | |
| No. 10 | | | | | | | | | |
| Sample | Example 11A | 0.55 | 0.37 | 0.75 | 0.063 | 0.32 | A | A | |
| No. 11 | | | | | | | | | |
| Sample | Comparative | 0.06 | 0.76 | 0.25 | 0.087 | 0.04 | B | B | |
| No. 12 | Example 1A | | | | | | | | |
| Sample | Comparative | 0.93 | 0.52 | 0.33 | 0.077 | 1.54 | B | C | |
| No. 13 | Example 2A | | | | | | | | |
| Sample | Comparative | 0.01 | 0.98 | 0.05 | 0.001 | 0.02 | D | C | |
| No. 14 | Example 3A | | | | | | | | |
| Sample | Comparative | 0.02 | 1.05 | 0.06 | 0.001 | 0.03 | D | C | |
| No. 15 | Example 4A | | | | | | | | |
| Sample | Comparative | — | — | — | — | 0.56 | — | C | |
| No. 16 | Example 5A | | | | | | | | |
| Sample | Comparative | — | — | — | — | 0.42 | — | C | |
| No. 17 | Example 6A | | | | | | | | |
| Sample | Comparative | — | — | — | — | 0.36 | — | D | |
| No. 18 | Example 7A | | | | | | | | |
| Sample | Comparative | — | — | — | — | 0.03 | — | C | |
| No. 19 | Example 8A | | | | | | | | |
| Sample | Comparative | — | — | — | — | 0.04 | — | C | |
| No. 20 | Example 9A | | | | | | | | |
| Sample | Comparative | — | — | — | — | 0.02 | — | D | |
| No. 21 | Example 10A | | | | | | | | |
| | | Dental orthodontic bracket | | | | | | | |
| | | Evaluation results | | | | | | | |
| | | | | 0.2% | | | | | Degree of |
| | | Aspect | Vickers | proof | | Young's | Fatigue | | application |
| | | ratio | hardness | stress | Elongation | modulus | strength | Slidability | of torque |
| | | — | — | MPa | % | GPa | MPa | — | — |
| Sample | Example 1A | 0.71 | 350 | 505 | 35 | >150 | 650 | A | A |
| No. 1 | | | | | | | | | |
| Sample | Example 2A | 0.69 | 385 | 485 | 26 | >150 | 565 | A | B |
| No. 2 | | | | | | | | | |
| Sample | Example 3A | 0.64 | 364 | 501 | 30 | >150 | 675 | A | A |
| No. 3 | | | | | | | | | |
| Sample | Example 4A | 0.81 | 401 | 455 | 10 | >150 | 558 | B | B |
| No. 4 | | | | | | | | | |
| Sample | Example 5A | 0.75 | 365 | 512 | 31 | >150 | 712 | A | A |
| No. 5 | | | | | | | | | |
| Sample | Example 6A | 0.72 | 426 | 512 | 5 | >150 | 683 | A | A |
| No. 6 | | | | | | | | | |
| Sample | Example 7A | 0.68 | 448 | 513 | 4 | >150 | 597 | B | B |
| No. 7 | | | | | | | | | |
| Sample | Example 8A | 0.83 | 433 | 512 | 7 | >150 | 564 | B | B |
| No. 8 | | | | | | | | | |
| Sample | Example 9A | 0.74 | 422 | 507 | 7 | >150 | 625 | A | A |
| No. 9 | | | | | | | | | |
| Sample | Example 10A | 0.76 | 449 | 510 | 4 | >150 | 542 | A | A |
| No. 10 | | | | | | | | | |
| Sample | Example 11A | 0.59 | 375 | 501 | 28 | >150 | 566 | A | A |
| No. 11 | | | | | | | | | |
| Sample | Comparative | 0.58 | 457 | 432 | 4 | — | 475 | D | D |
| No. 12 | Example 1A | | | | | | | | |
| Sample | Comparative | 0.36 | 234 | 276 | 35 | — | 458 | C | D |
| No. 13 | Example 2A | | | | | | | | |
| Sample | Comparative | — | 560 | 520 | 2 | — | 275 | D | D |
| No. 14 | Example 3A | | | | | | | | |
| Sample | Comparative | — | 620 | 545 | 1 | — | 246 | D | D |
| No. 15 | Example 4A | | | | | | | | |
| Sample | Comparative | 0.31 | 180 | 380 | 25 | 110 | 310 | C | D |
| No. 16 | Example 5A | | | | | | | | |
| Sample | Comparative | 0.39 | 305 | 820 | 12 | 120 | 540 | C | C |
| No. 17 | Example 6A | | | | | | | | |
| Sample | Comparative | 0.56 | 402 | 900 | 6 | 190 | 300 | B | C |
| No. 18 | Example 7A | | | | | | | | |
| Sample | Comparative | — | 180 | 240 | 30 | 102 | 240 | D | D |
| No. 19 | Example 8A | | | | | | | | |
| Sample | Comparative | — | 310 | 910 | 12 | 108 | 450 | D | D |
| No. 20 | Example 9A | | | | | | | | |
| Sample | Comparative | — | 412 | 950 | 4 | 170 | 260 | C | D |
| No. 21 | Example 10A | | | | | | | | |

TABLE 4

| | | Dental orthodontic bracket | | | | | | | |
|---|---|---|---|---|---|---|---|---|---|
| | | Evaluation results | | | | | | | |
| | | | Ratio of | | | Arithmetic | | | |
| | | SiO2/ | height | Pore | | average | | | |
| | | total | of peak | Average | Area | roughness | Dendrite | Corrosion | |
| | | Si | in XRD | diameter | ratio | Ra | phase | resistance | |
| | | % | — | μm | % | μm | — | — | |
| Sample | Example 12A | 53 | 0.22 | 0.53 | 0.025 | 0.36 | B | A | |
| No. 22 | | | | | | | | | |
| Sample | Example 13A | 36 | 0.31 | 0.66 | 0.038 | 0.20 | A | A | |
| No. 23 | | | | | | | | | |
| Sample | Example 14A | 45 | 0.27 | 0.58 | 0.032 | 0.22 | B | A | |
| No. 24 | | | | | | | | | |
| Sample | Example 15A | 24 | 0.25 | 0.74 | 0.051 | 0.08 | C | B | |
| No. 25 | | | | | | | | | |
| Sample | Example 16A | 49 | 0.38 | 0.35 | 0.022 | 0.17 | A | A | |
| No. 26 | | | | | | | | | |
| Sample | Example 17A | 32 | 0.42 | 0.89 | 0.087 | 0.07 | A | B | |
| No. 27 | | | | | | | | | |
| Sample | Example 18A | 28 | 0.48 | 0.97 | 0.097 | 0.09 | A | B | |
| No. 28 | | | | | | | | | |
| Sample | Example 19A | 66 | 0.16 | 0.45 | 0.121 | 0.18 | C | A | |
| No. 29 | | | | | | | | | |
| Sample | Example 20A | 77 | 0.36 | 0.43 | 0.112 | 0.26 | B | A | |
| No. 30 | | | | | | | | | |
| Sample | Example 21A | 55 | 0.63 | 0.75 | 0.089 | 0.42 | A | C | |
| No. 31 | | | | | | | | | |
| Sample | Example 22A | 53 | 0.22 | 0.53 | 0.025 | 0.44 | A | A | |
| No. 32 | | | | | | | | | |
| Sample | Example 23A | 36 | 0.31 | 0.66 | 0.038 | 0.57 | A | A | |
| No. 33 | | | | | | | | | |
| Sample | Example 24A | 45 | 0.27 | 0.58 | 0.032 | 0.62 | A | A | |
| No. 34 | | | | | | | | | |
| Sample | Example 25A | 24 | 0.25 | 0.74 | 0.051 | 0.48 | A | B | |
| No. 35 | | | | | | | | | |
| Sample | Example 26A | 49 | 0.38 | 0.35 | 0.022 | 0.26 | A | A | |
| No. 36 | | | | | | | | | |
| Sample | Example 27A | 66 | 0.16 | 0.45 | 0.121 | 0.17 | A | A | |
| No. 37 | | | | | | | | | |
| Sample | Example 28A | 77 | 0.36 | 0.43 | 0.112 | 0.13 | A | A | |
| No. 38 | | | | | | | | | |
| Sample | Example 29A | 55 | 0.63 | 0.75 | 0.089 | 1.02 | A | C | |
| No. 39 | | | | | | | | | |
| Sample | Example 30A | 19 | 0.37 | 0.75 | 0.063 | 1.23 | C | A | |
| No. 40 | | | | | | | | | |
| Sample | Example 31A | 6 | 0.76 | 0.25 | 0.087 | 1.89 | C | A | |
| No. 41 | | | | | | | | | |
| Sample | Example 32A | 17 | 0.42 | 0.89 | 0.087 | 1.05 | A | C | |
| No. 42 | | | | | | | | | |
| Sample | Example 33A | 15 | 0.48 | 0.97 | 0.097 | 1.34 | A | C | |
| No. 43 | | | | | | | | | |
| Sample | Comparative | 93 | 0.52 | 15.2 | 1.5 | 2.56 | D | D | |
| No. 44 | Example 11A | | | | | | | | |
| Sample | Comparative | 1 | 0.98 | 12.5 | 1.2 | 3.12 | D | D | |
| No. 45 | Example 12A | | | | | | | | |
| Sample | Comparative | 2 | 1.05 | 10.3 | 1.1 | 2.04 | D | D | |
| No. 46 | Example 13A | | | | | | | | |
| | | Dental orthodontic bracket | | | | | | | |
| | | Evaluation results | | | | | | | |
| | | | | 0.2% | | | | | Degree of |
| | | Aspect | Vickers | proof | | Young's | Fatigue | | application |
| | | ratio | hardness | stress | Elongation | modulus | strength | Slidability | of torque |
| | | — | — | MPa | % | GPa | MPa | — | — |
| Sample | Example 12A | 0.65 | 265 | 505 | 40 | >150 | 665 | A | B |
| No. 22 | | | | | | | | | |
| Sample | Example 13A | 0.72 | 301 | 509 | 38 | >150 | 704 | A | A |
| No. 23 | | | | | | | | | |
| Sample | Example 14A | 0.81 | 295 | 501 | 33 | >150 | 721 | A | A |
| No. 24 | | | | | | | | | |
| Sample | Example 15A | 0.53 | 332 | 515 | 22 | >150 | 605 | B | B |
| No. 25 | | | | | | | | | |
| Sample | Example 16A | 0.64 | 308 | 516 | 32 | >150 | 748 | A | A |
| No. 26 | | | | | | | | | |
| Sample | Example 17A | 0.82 | 341 | 528 | 17 | >150 | 678 | B | B |
| No. 27 | | | | | | | | | |
| Sample | Example 18A | 0.75 | 379 | 542 | 9 | >150 | 654 | B | B |
| No. 28 | | | | | | | | | |
| Sample | Example 19A | 0.74 | 276 | 503 | 36 | >150 | 612 | A | B |
| No. 29 | | | | | | | | | |
| Sample | Example 20A | 0.72 | 262 | 507 | 41 | >150 | 621 | A | B |
| No. 30 | | | | | | | | | |
| Sample | Example 21A | 0.68 | 412 | 518 | 8 | >150 | 547 | C | C |
| No. 31 | | | | | | | | | |
| Sample | Example 22A | 0.81 | 265 | 505 | 40 | >150 | 556 | C | B |
| No. 32 | | | | | | | | | |
| Sample | Example 23A | 0.69 | 301 | 509 | 38 | >150 | 698 | A | A |
| No. 33 | | | | | | | | | |
| Sample | Example 24A | 0.63 | 295 | 501 | 33 | >150 | 710 | A | A |
| No. 34 | | | | | | | | | |
| Sample | Example 25A | 0.74 | 332 | 515 | 22 | >150 | 531 | C | B |
| No. 35 | | | | | | | | | |
| Sample | Example 26A | 0.77 | 308 | 516 | 32 | >150 | 654 | A | A |
| No. 36 | | | | | | | | | |
| Sample | Example 27A | 0.63 | 289 | 503 | 36 | >150 | 615 | A | A |
| No. 37 | | | | | | | | | |
| Sample | Example 28A | 0.66 | 296 | 507 | 41 | >150 | 632 | A | A |
| No. 38 | | | | | | | | | |
| Sample | Example 29A | 0.54 | 456 | 518 | 8 | >150 | 465 | C | C |
| No. 39 | | | | | | | | | |
| Sample | Example 30A | 0.45 | 546 | 415 | 7 | — | 457 | C | C |
| No. 40 | | | | | | | | | |
| Sample | Example 31A | 0.36 | 523 | 431 | 5 | — | 474 | C | C |
| No. 41 | | | | | | | | | |
| Sample | Example 32A | 0.48 | 534 | 335 | 3 | >150 | 336 | C | C |
| No. 42 | | | | | | | | | |
| Sample | Example 33A | 0.68 | 524 | 342 | 3 | >150 | 343 | C | C |
| No. 43 | | | | | | | | | |
| Sample | Comparative | 0.32 | 565 | 326 | 4 | — | 359 | D | D |
| No. 44 | Example 11A | | | | | | | | |
| Sample | Comparative | 0.27 | 506 | 301 | 18 | — | 331 | D | D |
| No. 45 | Example 12A | | | | | | | | |
| Sample | Comparative | 0.31 | 495 | 297 | 12 | — | 327 | C | D |
| No. 46 | Example 13A | | | | | | | | |

As apparent from Tables 3 and 4, the dental orthodontic bracket corresponding to each Example was found to have excellent fatigue strength and corrosion resistance, and also confirmed to have an appropriate Vickers hardness, and relatively high 0.2% proof stress and Young's modulus. Based on these results, the dental orthodontic bracket corresponding to each Example was confirmed to have high deformation resistance.

Further, the dental orthodontic bracket corresponding to each Example was confirmed to have relatively favorable slidability for an archwire and relatively high degree of application of torque through an archwire.

It was also confirmed that the dental orthodontic bracket corresponding to each Example contains given amounts of silicon oxide and pores, but contains almost no dendrite phase.

On the other hand, the dental orthodontic bracket corresponding to each Comparative Example was confirmed to have low corrosion resistance and low mechanical properties, and was also found to have low slidability for an archwire and also have low degree of application of torque through an archwire.

### Examples 34A to 40A

Test pieces having an alloy composition shown in Table 5 were produced.

### 3. Evaluation of Relationship between Concentration of N and Hardness

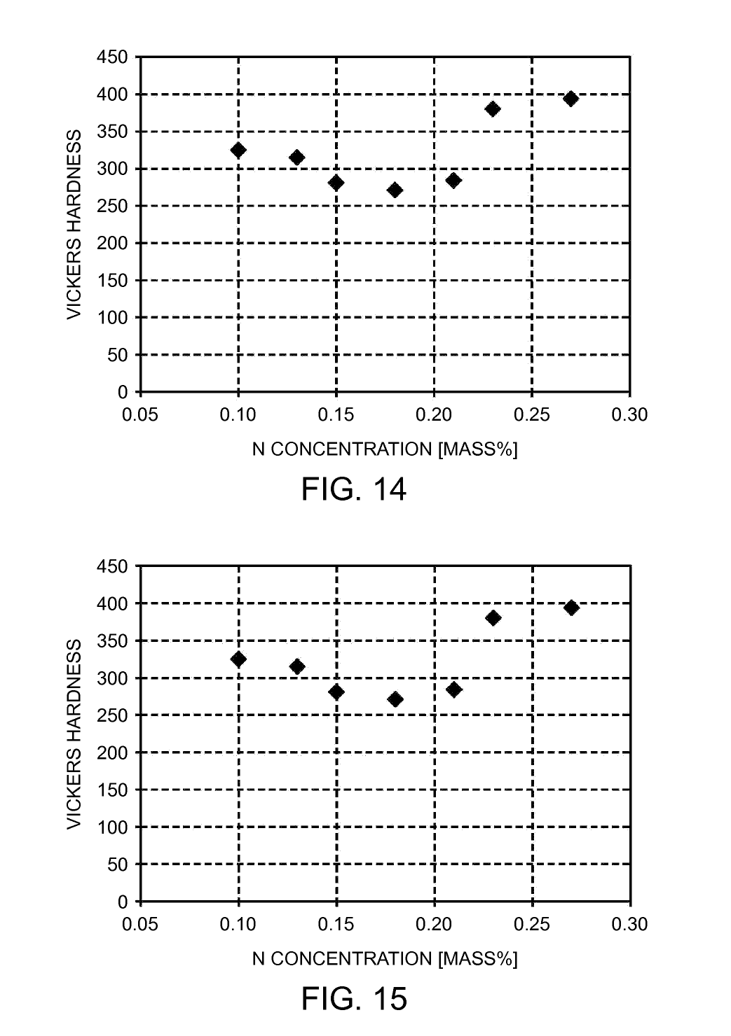

According to the procedure of the above-described “2.4 Measurement of Vickers Hardness”, the Vickers hardness of each of the test pieces of the respective Examples 34A to 40A was measured. The measurement results are shown in Table 5 and FIG. 14.

TABLE 5

| | | Test piece | | | | | | | |
|---|---|---|---|---|---|---|---|---|---|
| | | | | | | | | | Eva- |
| | | | | | | | | | luation |
| | | | | | | | | | results |
| | | | | | | | | | Vick- |
| | | | | | | | | | ers |
| | | | | | | | | | hard- |
| | | | | | | | | | ness |
| | | | | | | | | | Sur- |
| | | | | | | | | | face |
| | | Alloy composition | | | | | | | layer |
| | | Cr | Mo | Si | C | N | Ni | Co | portion |
| | | % by mass | | | | | | | — |
| Sample | Ex- | 29.7 | 6.84 | 0.77 | 0.02 | 0.10 | 0.01 | re- | 325 |
| No. 47 | ample | | | | | | | main- | |
| | 34A | | | | | | | der | |
| Sample | Ex- | 29.8 | 6.80 | 0.78 | 0.02 | 0.13 | 0.01 | re- | 315 |
| No. 48 | ample | | | | | | | main- | |
| | 35A | | | | | | | der | |
| Sample | Ex- | 30.2 | 6.82 | 0.79 | 0.02 | 0.15 | 0.01 | re- | 281 |
| No. 49 | ample | | | | | | | main- | |
| | 36A | | | | | | | der | |
| Sample | Ex- | 29.9 | 6.83 | 0.78 | 0.02 | 0.18 | 0.01 | re- | 271 |
| No. 50 | ample | | | | | | | main- | |
| | 37A | | | | | | | der | |
| Sample | Ex- | 30.1 | 6.85 | 0.77 | 0.02 | 0.21 | 0.01 | re- | 284 |
| No. 51 | ample | | | | | | | main- | |
| | 38A | | | | | | | der | |
| Sample | Ex- | 29.6 | 6.84 | 0.76 | 0.02 | 0.23 | 0.01 | re- | 380 |
| No. 52 | ample | | | | | | | main- | |
| | 39A | | | | | | | der | |
| Sample | Ex- | 29.7 | 6.81 | 0.78 | 0.02 | 0.27 | 0.01 | re- | 394 |
| No. 53 | ample | | | | | | | main- | |
| | 40A | | | | | | | der | |

As apparent from Table 5 and FIG. 14, the concentration of N in the test piece and the Vickers hardness have such a relationship that the hardness reaches the local minimum at a specific N concentration. When the hardness is appropriately decreased, the toughness of the test piece is increased, so that the improvement of the tensile strength, proof stress, etc. is observed. When the hardness is near the local minimum, the balance between the hardness and the proof stress is favorable, and thus, such an alloy can be used as a dental alloy material useful as a dental orthodontic bracket.

### Examples of Second Embodiment of Dental Component

### 1. Production of Test Piece

### Example 1B

(1) First, a starting material having an alloy composition shown in Table 6 was melted in a high-frequency induction furnace, whereby a molten material of the starting material was obtained. Then, the obtained molten material of the starting material was powdered by a water atomization method, whereby a metal powder was obtained. Subsequently, the particles of the obtained metal powder were classified using a standard sieve having a mesh size of 150 μm. Incidentally, in the determination of the alloy composition, an optical emission spectrometer for solids (a spark optical emission spectrometer) manufactured by SPECTRO Analytical Instruments GmbH (model: Spectrolab, type: LAVMB08A) was used. Further, in the quantitative analysis of C (carbon) in the particles of the metal powder, a carbon/sulfur analyzer CS-200 manufactured by LECO Corporation was used.

(2) Subsequently, the metal powder and a mixture (an organic binder) of polypropylene and a wax were weighed such that the mass ratio thereof was 9:1, followed by mixing, whereby a mixed starting material was obtained.

(3) Subsequently, this mixed starting material was kneaded using a kneader, whereby a kneaded material was obtained.

(4) Subsequently, this kneaded material was molded using an injection molding machine under the following molding conditions, whereby a molded body was produced.

### Molding Conditions

Temperature of material: 150° C.
Injection pressure: 11 MPa (110 kgf/cm²)

(5) Subsequently, this molded body was degreased under the following degreasing conditions, whereby a degreased body was obtained.

### Degreasing Conditions

Degreasing temperature: 470° C.
Degreasing time: 1 hour
Degreasing atmosphere: nitrogen atmosphere

(6) Subsequently, the obtained degreased body was fired under the following firing conditions, whereby a sintered body was obtained.

### Firing Conditions

Firing temperature: 1300° C.
Firing time: 3 hours
Firing atmosphere: argon atmosphere

(7) Subsequently, the obtained sintered body was subjected to a barrel polishing treatment. By doing this, a test piece was obtained.

### Examples 2B to 11B and Comparative Examples 1B and 2B

Test pieces were obtained in the same manner as in Example 1B except that the production conditions were changed to the conditions shown in Table 6, respectively.

### Comparative Examples 3B and 4B

A starting material having an alloy composition shown in Table 6 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a test piece was obtained.

### Comparative Examples 5B to 7B

Test pieces were obtained in the same manner as in Example 1B except that the production conditions were changed to the conditions shown in Table 6, respectively.

### Comparative Examples 8B to 10B

A starting material having an alloy composition shown in Table 6 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a test piece was obtained.

TABLE 6

| | | Test piece | | | | | | | | | | |
|---|---|---|---|---|---|---|---|---|---|---|---|---|
| | | Alloy composition | | | | | | | | | | With or |
| | | Cr | Mo | Si | C | N | Ni | Co | | | Molding | without |
| | | % by mass | | | | | | | Si/Mo | C/Si | method | polishing |
| Sample No. 1 | Example 1B | 29.0 | 6.04 | 0.70 | 0.05 | 0.00 | 0.01 | remainder | 0.116 | 0.071 | Powder | With |
| | | | | | | | | | | | metallurgy | polishing |
| Sample No. 2 | Example 2B | 27.4 | 8.53 | 0.95 | 0.04 | 0.00 | 0.01 | remainder | 0.111 | 0.042 | Powder | With |
| | | | | | | | | | | | metallurgy | polishing |
| Sample No. 3 | Example 3B | 28.3 | 7.24 | 0.86 | 0.05 | 0.00 | 0.01 | remainder | 0.119 | 0.058 | Powder | With |
| | | | | | | | | | | | metallurgy | polishing |
| Sample No. 4 | Example 4B | 26.2 | 5.30 | 0.52 | 0.02 | 0.00 | 0.01 | remainder | 0.098 | 0.038 | Powder | With |
| | | | | | | | | | | | metallurgy | polishing |
| Sample No. 5 | Example 5B | 31.8 | 6.54 | 0.75 | 0.07 | 0.00 | 0.01 | remainder | 0.115 | 0.093 | Powder | With |
| | | | | | | | | | | | metallurgy | polishing |
| Sample No. 6 | Example 6B | 33.4 | 9.25 | 0.64 | 0.12 | 0.00 | 0.01 | remainder | 0.069 | 0.188 | Powder | With |
| | | | | | | | | | | | metallurgy | polishing |
| Sample No. 7 | Example 7B | 34.6 | 11.50 | 0.94 | 0.31 | 0.00 | 0.01 | remainder | 0.082 | 0.330 | Powder | With |
| | | | | | | | | | | | metallurgy | polishing |
| Sample No. 8 | Example 8B | 27.2 | 5.52 | 0.97 | 0.08 | 0.00 | 0.01 | remainder | 0.176 | 0.082 | Powder | With |
| | | | | | | | | | | | metallurgy | polishing |
| Sample No. 9 | Example 9B | 26.5 | 7.79 | 0.83 | 0.15 | 0.00 | 0.02 | remainder | 0.107 | 0.181 | Powder | With |
| | | | | | | | | | | | metallurgy | polishing |
| Sample No. 10 | Example 10B | 29.8 | 5.87 | 0.65 | 1.24 | 0.00 | 0.02 | remainder | 0.111 | 1.908 | Powder | With |
| | | | | | | | | | | | metallurgy | polishing |
| Sample No. 11 | Example 11B | 28.6 | 6.12 | 0.74 | 0.00 | 0.00 | 0.02 | remainder | 0.121 | 0.000 | Powder | With |
| | | | | | | | | | | | metallurgy | polishing |
| Sample No. 12 | Comparative | 29.4 | 5.89 | 0.26 | 0.06 | 0.00 | 0.85 | remainder | 0.044 | 0.231 | Powder | With |
| | Example 1B | | | | | | | | | | metallurgy | polishing |
| Sample No. 13 | Comparative | 31.6 | 6.74 | 2.06 | 0.06 | 0.00 | 0.77 | remainder | 0.306 | 0.029 | Powder | With |
| | Example 2B | | | | | | | | | | metallurgy | polishing |
| Sample No. 14 | Comparative | 30.5 | 6.23 | 0.75 | 0.04 | 0.00 | 0.02 | remainder | 0.120 | 0.053 | Casting | With |
| | Example 3B | | | | | | | | | | | polishing |
| Sample No. 15 | Comparative | 28.4 | 11.60 | 0.87 | 0.11 | 0.00 | 0.89 | remainder | 0.075 | 0.126 | Casting | With |
| | Example 4B | | | | | | | | | | | polishing |

| Sample No. 16 | Comparative | Ti | — | — | Powder | With |
|---|---|---|---|---|---|---|
| | Example 5B | | | | metallurgy | polishing |
| Sample No. 17 | Comparative | Ti-6Al-4V | — | — | Powder | With |
| | Example 6B | | | | metallurgy | polishing |
| Sample No. 18 | Comparative | 17-4PH stainless steel | — | — | Powder | With |
| | Example 7B | | | | metallurgy | polishing |
| Sample No. 19 | Comparative | Ti | — | — | Casting | With |
| | Example 8B | | | | | polishing |
| Sample No. 20 | Comparative | Ti-6Al-4V | — | — | Casting | With |
| | Example 9B | | | | | polishing |
| Sample No. 21 | Comparative | 17-4PH stainless steel | — | — | Casting | With |

| | |
|---|---|
| Example 10B | polishing |

### Example 12B

(1) First, a starting material having an alloy composition shown in Table 7 was melted in a high-frequency induction furnace, whereby a molten material of the starting material was obtained. Then, the obtained molten material of the starting material was powdered by a water atomization method, whereby a metal powder was obtained. Subsequently, the particles of the obtained metal powder were classified using a standard sieve having a mesh size of 150 μm. Incidentally, N was incorporated in the starting material in a state where N was attached to Cr (a state of chromium nitride). Further, in the determination of the alloy composition, an optical emission spectrometer for solids (a spark optical emission spectrometer) manufactured by SPECTRO Analytical Instruments GmbH (model: Spectrolab, type: LAVMB08A) was used. Further, in the quantitative analysis of C (carbon) in the particles of the metal powder, a carbon/sulfur analyzer CS-200 manufactured by LECO Corporation was used. Further, in the quantitative analysis of N (nitrogen) in the particles of the metal powder, an oxygen-nitrogen analyzer, TC-300/EF-300 manufactured by LECO Corporation was used.

(2) Subsequently, the metal powder and a mixture (an organic binder) of polypropylene and a wax were weighed such that the mass ratio thereof was 9:1, followed by mixing, whereby a mixed starting material was obtained.

(3) Subsequently, this mixed starting material was kneaded using a kneader, whereby a kneaded material was obtained.

(4) Subsequently, this kneaded material was molded using an injection molding machine under the following molding conditions, whereby a molded body was produced.

### Molding Conditions

Temperature of material: 150° C.
Injection pressure: 11 MPa (110 kgf/cm²)

(5) Subsequently, the obtained molded body was subjected to a heat treatment (degreasing treatment) under the following degreasing conditions, whereby a degreased body was obtained.

### Degreasing Conditions

Degreasing temperature: 470° C.
Degreasing time: 1 hour
Degreasing atmosphere: nitrogen atmosphere

(6) Subsequently, the obtained degreased body was fired under the following firing conditions, whereby a sintered body was obtained.

### Firing Conditions

Firing temperature: 1300° C.
Firing time: 3 hours
Firing atmosphere: argon atmosphere

(7) Subsequently, the obtained sintered body was subjected to a barrel polishing treatment. By doing this, a test piece was obtained.

### Examples 13B to 25B

Test pieces were obtained in the same manner as in Example 12B except that the production conditions were changed to the conditions shown in Table 7, respectively.

### Examples 26B to 28B

When a starting material was melted in a high-frequency induction furnace, nitrogen gas was injected into the molten metal. At this time, by appropriately changing the injection time, the content of N was changed.

Then, test pieces were obtained in the same manner as in Example 12B except that the production conditions other than this were changed to the conditions shown in Table 7, respectively.

### Examples 30B to 33B

First, a metal powder was obtained in the same manner as in Example 12B by using a starting material containing no N.

Subsequently, a sintered body was obtained in the same manner as in Example 12B except that the obtained metal powder was used, and also the firing atmosphere in the firing conditions was changed to a mixed gas atmosphere containing argon at 50% by volume and nitrogen at 50% by volume. At this time, by appropriately changing the partial pressure of nitrogen gas, the content of N contained in the metal powder was changed.

Then, test pieces were obtained in the same manner as in Example 12B except that the production conditions other than this were changed to the conditions shown in Table 7, respectively.

### Comparative Examples 11B to 13B

A starting material having an alloy composition shown in Table 7 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a test piece as obtained.

TABLE 7

| | | Test piece | | | | | | | | | | | | | |
|---|---|---|---|---|---|---|---|---|---|---|---|---|---|---|---|
| | | Alloy composition | | | | | | | | | | | N | | With or |
| | | Cr | Mo | Si | C | N | Ni | Co | | | | | impregnation | Molding | without |
| | | % by mass | | | | | | | Si/Mo | C/Si | N/Si | N/C | method | method | polishing |
| Sample | Example | 29.8 | 6.80 | 0.78 | 0.02 | 0.13 | 0.01 | re- | 0.115 | 0.026 | 0.167 | 6.50 | Metal nitride | Powder | With |
| No. 22 | 12B | | | | | | | main- | | | | | starting | metallurgy | polishing |
| | | | | | | | | der | | | | | material | | |
| Sample | Example | 27.3 | 8.43 | 0.96 | 0.04 | 0.18 | 0.01 | re- | 0.114 | 0.042 | 0.188 | 4.50 | Metal nitride | Powder | With |
| No. 23 | 13B | | | | | | | main- | | | | | starting | metallurgy | polishing |
| | | | | | | | | der | | | | | material | | |
| Sample | Example | 28.5 | 7.21 | 0.83 | 0.03 | 0.12 | 0.01 | re- | 0.115 | 0.036 | 0.145 | 4.00 | Metal nitride | Powder | With |
| No. 24 | 14B | | | | | | | main- | | | | | starting | metallurgy | polishing |
| | | | | | | | | der | | | | | material | | |
| Sample | Example | 26.1 | 5.32 | 0.34 | 0.02 | 0.09 | 0.01 | re- | 0.064 | 0.059 | 0.265 | 4.50 | Metal nitride | Powder | With |
| No. 25 | 15B | | | | | | | main- | | | | | starting | metallurgy | polishing |
| | | | | | | | | der | | | | | material | | |
| Sample | Example | 31.9 | 6.50 | 0.71 | 0.07 | 0.23 | 0.01 | re- | 0.109 | 0.099 | 0.324 | 3.29 | Metal nitride | Powder | With |
| No. 26 | 16B | | | | | | | main- | | | | | starting | metallurgy | polishing |
| | | | | | | | | der | | | | | material | | |
| Sample | Example | 33.5 | 9.27 | 0.65 | 0.13 | 0.28 | 0.01 | re- | 0.070 | 0.200 | 0.431 | 2.15 | Metal nitride | Powder | With |
| No. 27 | 17B | | | | | | | main- | | | | | starting | metallurgy | polishing |
| | | | | | | | | der | | | | | material | | |
| Sample | Example | 34.9 | 11.80 | 0.95 | 0.35 | 0.27 | 0.01 | re- | 0.081 | 0.368 | 0.284 | 0.77 | Metal nitride | Powder | With |
| No. 28 | 18B | | | | | | | main- | | | | | starting | metallurgy | polishing |
| | | | | | | | | der | | | | | material | | |
| Sample | Example | 27.1 | 5.49 | 0.96 | 0.07 | 0.11 | 0.01 | re- | 0.175 | 0.073 | 0.115 | 1.57 | Metal nitride | Powder | With |
| No. 29 | 19B | | | | | | | main- | | | | | starting | metallurgy | polishing |
| | | | | | | | | der | | | | | material | | |
| Sample | Example | 26.1 | 5.11 | 0.83 | 0.04 | 0.12 | 0.02 | re- | 0.162 | 0.048 | 0.145 | 3.00 | Metal nitride | Powder | With |
| No. 30 | 20B | | | | | | | main- | | | | | starting | metallurgy | polishing |
| | | | | | | | | der | | | | | material | | |
| Sample | Example | 29.9 | 10.75 | 0.65 | 1.19 | 0.21 | 0.02 | re- | 0.060 | 1.831 | 0.323 | 0.18 | Metal nitride | Powder | With |
| No. 31 | 21B | | | | | | | main- | | | | | starting | metallurgy | polishing |
| | | | | | | | | der | | | | | material | | |
| Sample | Example | 29.8 | 6.80 | 0.78 | 0.05 | 0.26 | 0.01 | re- | 0.115 | 0.064 | 0.333 | 5.20 | Metal nitride | Powder | With |
| No. 32 | 22B | | | | | | | main- | | | | | starting | metallurgy | polishing |
| | | | | | | | | der | | | | | material | | |
| Sample | Example | 27.3 | 8.43 | 0.96 | 0.04 | 0.36 | 0.01 | re- | 0.114 | 0.042 | 0.375 | 9.00 | Metal nitride | Powder | Without |
| No. 33 | 23B | | | | | | | main- | | | | | starting | metallurgy | polishing |
| | | | | | | | | der | | | | | material | | |
| Sample | Example | 28.5 | 7.21 | 0.83 | 0.03 | 0.24 | 0.01 | re- | 0.115 | 0.036 | 0.289 | 8.00 | Metal nitride | Powder | Without |
| No. 34 | 24B | | | | | | | main- | | | | | starting | metallurgy | polishing |
| | | | | | | | | der | | | | | material | | |
| Sample | Example | 26.1 | 5.32 | 0.54 | 0.00 | 0.18 | 0.01 | re- | 0.102 | 0.000 | 0.333 | — | Metal nitride | Powder | Without |
| No. 35 | 25B | | | | | | | main- | | | | | starting | metallurgy | polishing |
| | | | | | | | | der | | | | | material | | |
| Sample | Example | 31.9 | 6.50 | 0.71 | 0.03 | 0.46 | 0.01 | re- | 0.109 | 0.042 | 0.648 | 15.33 | Injection into | Powder | With |
| No. 36 | 26B | | | | | | | main- | | | | | molten metal | metallurgy | polishing |
| | | | | | | | | der | | | | | | | |
| Sample | Example | 27.1 | 5.49 | 0.96 | 0.07 | 0.35 | 0.01 | re- | 0.175 | 0.073 | 0.365 | 5.00 | Injection into | Powder | With |
| No. 37 | 27B | | | | | | | main- | | | | | molten metal | metallurgy | polishing |
| | | | | | | | | der | | | | | | | |
| Sample | Example | 26.1 | 5.11 | 0.83 | 0.04 | 0.31 | 0.02 | re- | 0.162 | 0.048 | 0.373 | 7.75 | Injection into | Powder | With |
| No. 38 | 28B | | | | | | | main- | | | | | molten metal | metallurgy | polishing |
| | | | | | | | | der | | | | | | | |
| Sample | Example | 29.9 | 6.52 | 0.65 | 1.19 | 0.42 | 0.02 | re- | 0.100 | 1.831 | 0.646 | 0.35 | Injection into | Powder | With |
| No. 39 | 29B | | | | | | | main- | | | | | molten metal | metallurgy | polishing |
| | | | | | | | | der | | | | | | | |
| Sample | Example | 29.1 | 5.88 | 0.71 | 0.02 | 0.01 | 0.01 | re- | 0.121 | 0.028 | 0.014 | 0.50 | Nitriding | Powder | With |
| No. 40 | 30B | | | | | | | main- | | | | | during | metallurgy | polishing |
| | | | | | | | | der | | | | | sintering | | |
| Sample | Example | 32.4 | 6.78 | 1.45 | 0.06 | 0.03 | 0.02 | re- | 0.214 | 0.041 | 0.021 | 0.50 | Nitriding | Powder | With |
| No. 41 | 31B | | | | | | | main- | | | | | during | metallurgy | polishing |
| | | | | | | | | der | | | | | sintering | | |
| Sample | Example | 33.5 | 9.27 | 0.65 | 0.13 | 0.56 | 0.01 | re- | 0.070 | 0.200 | 0.862 | 4.31 | Nitriding | Powder | With |
| No. 42 | 32B | | | | | | | main- | | | | | during | metallurgy | polishing |
| | | | | | | | | der | | | | | sintering | | |
| Sample | Example | 34.9 | 11.80 | 0.95 | 0.35 | 0.54 | 0.01 | re- | 0.081 | 0.368 | 0.568 | 1.54 | Nitriding | Powder | With |
| No. 43 | 33B | | | | | | | main- | | | | | during | metallurgy | polishing |
| | | | | | | | | der | | | | | sintering | | |
| Sample | Com- | 29.2 | 6.11 | 0.65 | 0.04 | 0.32 | 0.02 | re- | 0.106 | 0.062 | 0.492 | 8.00 | Injection into | Casting | With |
| No. 44 | parative | | | | | | | main- | | | | | molten metal | | polishing |
| | Example | | | | | | | der | | | | | | | |
| | 11B | | | | | | | | | | | | | | |
| Sample | Com- | 27.9 | 5.82 | 0.69 | 0.02 | 0.45 | 0.03 | re- | 0.119 | 0.029 | 0.652 | 22.50 | Injection into | Casting | With |
| No. 45 | parative | | | | | | | main- | | | | | molten metal | | polishing |
| | Example | | | | | | | der | | | | | | | |
| | 12B | | | | | | | | | | | | | | |
| Sample | Com- | 30.1 | 6.99 | 0.61 | 0.05 | 0.39 | 0.10 | re- | 0.087 | 0.082 | 0.639 | 7.80 | Injection into | Casting | With |
| No. 46 | parative | | | | | | | main- | | | | | molten metal | | polishing |
| | Example | | | | | | | der | | | | | | | |
| | 13B | | | | | | | | | | | | | | |

### 2. Evaluation of Test Piece

### 2.1 Measurement of Total Amount of Si and Content of Si Contained as Silicon Oxide

For each of the test pieces of the respective Examples and Comparative Examples, the total amount of Si and the content of Si contained as silicon oxide were measured by gravimetry and ICP optical emission spectroscopy. The measurement results are shown in Tables 8 and 9.

### 2.2 Evaluation of Crystal Structure by X-ray Diffractometry

For each of the test pieces of the respective Examples and Comparative Examples, a crystal structure analysis was performed by X-ray diffractometry. Then, the height and the position of each peak contained in an obtained X-ray diffraction pattern were collated with the database listed in ICDD card, whereby the crystal structure contained in the dental anchor was identified. Then, when the height of the highest peak among the peaks derived from Co was assumed to be 1, the height of the highest peak among the peaks derived from Co₃Mo was calculated. The calculation results are shown in Tables 8 and 9.

### 2.3 Evaluation of Dendrite Phase and Aspect Ratio of Crystal Structure

Each of the test pieces of the respective Examples and Comparative Examples was cut and the cut surface was polished. Subsequently, the obtained polished surface was observed with a scanning electron microscope, and the degree of existence of a dendritic structure in the observation image was confirmed, whereby the degree of existence of the dendrite phase was evaluated according to the following evaluation criteria.

### Evaluation Criteria for Dendrite Phase

A: Almost no dendrite phase exists.
B: A dendrite phase exists in a slight amount (at an area ratio of 10% or less).
C: A dendrite phase exists in a slightly large amount (at an area ratio of more than 10% and 20% or less).
D: A dendrite phase exists in a very large amount (at an area ratio of more than 20%).

Further, the obtained polished surface was observed with a scanning electron microscope, and an average of the aspect ratio of a crystal structure in the observation image was calculated.

The above evaluation results are shown in Tables 8 and 9.

### 2.4 Measurement of Vickers Hardness

For the surface of each of the test pieces of the respective Examples and Comparative Examples, the Vickers hardness was measured. The measurement results are shown in Tables 8 and 9.

### 2.5 Evaluation of Corrosion Resistance

For each of the test pieces of the respective Examples and Comparative Examples, the amount of eluted metal ions was measured in accordance with the test method for corrosion resistance of a noble metal material for dental metal-ceramic restoration specified in JIS T 6118.

Then, the measurement results were evaluated based on the following evaluation criteria.

### Evaluation Criteria for Corrosion Resistance

A: The corrosion resistance is very high (the amount of eluted metal ions is very small).
B: The corrosion resistance is high (the amount of eluted metal ions is small).
C: The corrosion resistance is low (the amount of eluted metal ions is large).
D: The corrosion resistance is very low (the amount of eluted metal ions is very large).

The above evaluation results are shown in Tables 8 and 9.

### 2.6 Measurement of 0.2% Proof Stress, Elongation, and Young's Modulus

For each of the test pieces of the respective Examples and Comparative Examples, the 0.2% proof stress and the elongation were measured in accordance with the test method for mechanical properties of a noble metal material for dental metal-ceramic restoration specified in JIS T 6118.

Further, the Young's modulus was obtained in accordance with the test method for a dental metal material specified in JIS T 6004.

The measurement results are shown in Tables 8 and 9.

### 2.7 Measurement of Fatigue Strength

For each of the test pieces of the respective Examples and Comparative Examples, the fatigue strength was measured in accordance with the test method specified in JIS T 0309.

The measurement results are shown in Tables 8 and 9.

### 2.8 Measurement of Surface Roughness

For each of the test pieces of the respective Examples and Comparative Examples, the arithmetic average roughness Ra of the surface thereof was measured using a stylus-type surface roughness tester.

The measurement results are shown in Tables 8 and 9.

### 2.9 Evaluation of Slidability

For each of the test pieces of the respective Examples and Comparative Examples, the wear coefficient of the surface thereof was measured in accordance with the B method (pin-on-disk method) of the sliding wear test method specified in JIS K 7218. Then, the sliding wear performance was evaluated based on the following evaluation criteria. Incidentally, as a counter material in the sliding wear test, a test piece of hydroxyapatite regarded as bone was used.

### Evaluation Criteria for Sliding Wear Performance

A: The sliding wear performance is very favorable.
B: The sliding wear performance is favorable.
C: The sliding wear performance is slightly favorable.
D: The sliding wear performance is unfavorable.

The above evaluation results are shown in Tables 8 and 9.

TABLE 8

| | | Test piece | | | | | |
|---|---|---|---|---|---|---|---|
| | | Evaluation results | | | | | |
| | | SiO₂/ | Ratio of | Arithmetic | | | |
| | | total | height of peak | average | Dendrite | Corrosion | Aspect |
| | | Si | in XRD | roughness Ra | phase | resistance | ratio |
| | | % | — | μm | — | — | — |
| Sample | Example | 0.53 | 0.22 | 0.24 | A | A | 0.71 |
| No. 1 | 1B | | | | | | |
| Sample | Example | 0.36 | 0.31 | 0.31 | A | A | 0.69 |
| No. 2 | 2B | | | | | | |
| Sample | Example | 0.45 | 0.27 | 0.12 | A | A | 0.64 |
| No. 3 | 3B | | | | | | |
| Sample | Example | 0.24 | 0.25 | 0.08 | A | B | 0.81 |
| No. 4 | 4B | | | | | | |
| Sample | Example | 0.49 | 0.38 | 0.36 | A | A | 0.75 |
| No. 5 | 5B | | | | | | |
| Sample | Example | 0.32 | 0.42 | 0.41 | A | A | 0.72 |
| No. 6 | 6B | | | | | | |
| Sample | Example | 0.28 | 0.48 | 0.56 | A | A | 0.68 |
| No. 7 | 7B | | | | | | |
| Sample | Example | 0.66 | 0.16 | 0.91 | A | A | 0.83 |
| No. 8 | 8B | | | | | | |
| Sample | Example | 0.77 | 0.36 | 0.23 | A | B | 0.74 |
| No. 9 | 9B | | | | | | |
| Sample | Example | 0.55 | 0.63 | 0.18 | A | B | 0.76 |
| No. 10 | 10B | | | | | | |
| Sample | Example | 0.55 | 0.37 | 0.32 | A | A | 0.59 |
| No. 11 | 11B | | | | | | |
| Sample | Comparative | 0.06 | 0.76 | 0.04 | B | B | 0.58 |
| No. 12 | Example | | | | | | |
| | 1B | | | | | | |
| Sample | Comparative | 0.93 | 0.52 | 1.54 | B | C | 0.36 |
| No. 13 | Example | | | | | | |
| | 2B | | | | | | |
| Sample | Comparative | 0.01 | 0.98 | 0.02 | D | C | — |
| No. 14 | Example | | | | | | |
| | 3B | | | | | | |
| Sample | Comparative | 0.02 | 1.05 | 0.03 | D | C | — |
| No. 15 | Example | | | | | | |
| | 4B | | | | | | |
| Sample | Comparative | — | — | 0.56 | — | C | 0.31 |
| No. 16 | Example | | | | | | |
| | 5B | | | | | | |
| Sample | Comparative | — | — | 0.42 | — | C | 0.39 |
| No. 17 | Example | | | | | | |
| | 6B | | | | | | |
| Sample | Comparative | — | — | 0.36 | — | D | 0.56 |
| No. 18 | Example | | | | | | |
| | 7B | | | | | | |
| Sample | Comparative | — | — | 0.03 | — | C | — |
| No. 19 | Example | | | | | | |
| | 8B | | | | | | |
| Sample | Comparative | — | — | 0.04 | — | C | — |
| No. 20 | Example | | | | | | |
| | 9B | | | | | | |
| Sample | Comparative | — | — | 0.02 | — | D | — |
| No. 21 | Example | | | | | | |
| | 10B | | | | | | |
| | | Test piece | | | | | |
| | | Evaluation results | | | | | |
| | | Vickers | 0.2% | | Young's | Fatigue | |
| | | hardness | proof Stress | Elongation | modulus | strength | Slidability |
| | | — | MPa | % | GPa | MPa | — |
| Sample | Example | 350 | 505 | 35 | >150 | 650 | A |
| No. 1 | 1B | | | | | | |
| Sample | Example | 385 | 485 | 26 | >150 | 565 | A |
| No. 2 | 2B | | | | | | |
| Sample | Example | 364 | 501 | 30 | >150 | 675 | A |
| No. 3 | 3B | | | | | | |
| Sample | Example | 401 | 455 | 10 | >150 | 558 | B |
| No. 4 | 4B | | | | | | |
| Sample | Example | 365 | 512 | 31 | >150 | 712 | A |
| No. 5 | 5B | | | | | | |
| Sample | Example | 426 | 512 | 5 | >150 | 683 | A |
| No. 6 | 6B | | | | | | |
| Sample | Example | 448 | 513 | 4 | >150 | 597 | B |
| No. 7 | 7B | | | | | | |
| Sample | Example | 433 | 512 | 7 | >150 | 564 | B |
| No. 8 | 8B | | | | | | |
| Sample | Example | 422 | 507 | 7 | >150 | 625 | A |
| No. 9 | 9B | | | | | | |
| Sample | Example | 449 | 510 | 4 | >150 | 542 | A |
| No. 10 | 10B | | | | | | |
| Sample | Example | 375 | 501 | 28 | >150 | 566 | A |
| No. 11 | 11B | | | | | | |
| Sample | Comparative | 457 | 432 | 4 | — | 475 | D |
| No. 12 | Example | | | | | | |
| | 1B | | | | | | |
| Sample | Comparative | 234 | 276 | 35 | — | 458 | C |
| No. 13 | Example | | | | | | |
| | 2B | | | | | | |
| Sample | Comparative | 560 | 520 | 2 | — | 275 | D |
| No. 14 | Example | | | | | | |
| | 3B | | | | | | |
| Sample | Comparative | 620 | 545 | 1 | — | 246 | D |
| No. 15 | Example | | | | | | |
| | 4B | | | | | | |
| Sample | Comparative | 180 | 380 | 25 | 110 | 310 | C |
| No. 16 | Example | | | | | | |
| | 5B | | | | | | |
| Sample | Comparative | 305 | 820 | 12 | 120 | 540 | C |
| No. 17 | Example | | | | | | |
| | 6B | | | | | | |
| Sample | Comparative | 402 | 900 | 6 | 190 | 300 | B |
| No. 18 | Example | | | | | | |
| | 7B | | | | | | |
| Sample | Comparative | 180 | 240 | 30 | 102 | 240 | D |
| No. 19 | Example | | | | | | |
| | 8B | | | | | | |
| Sample | Comparative | 310 | 910 | 12 | 108 | 450 | D |
| No. 20 | Example | | | | | | |
| | 9B | | | | | | |
| Sample | Comparative | 412 | 950 | 4 | 170 | 260 | C |
| No. 21 | Example | | | | | | |
| | 10B | | | | | | |

TABLE 9

| | | Test piece | | | | | |
|---|---|---|---|---|---|---|---|
| | | Evaluation results | | | | | |
| | | | | Arithmetic | | | |
| | | | Ratio of height | average | | | |
| | | SiO₂/ | of peak in | roughness | Dendrite | Corrosion | Aspect |
| | | total Si | XRD | Ra | phase | resistance | ratio |
| | | % | — | μm | — | — | — |
| Sample | Example | 53 | 0.22 | 0.36 | B | A | 0.65 |
| No. 22 | 12B | | | | | | |
| Sample | Example | 36 | 0.31 | 0.20 | A | A | 0.72 |
| No. 23 | 13B | | | | | | |
| Sample | Example | 45 | 0.27 | 0.22 | B | A | 0.81 |
| No. 24 | 14B | | | | | | |
| Sample | Example | 24 | 0.25 | 0.08 | C | B | 0.53 |
| No. 25 | 15B | | | | | | |
| Sample | Example | 49 | 0.38 | 0.17 | A | A | 0.64 |
| No. 26 | 16B | | | | | | |
| Sample | Example | 32 | 0.42 | 0.07 | A | B | 0.82 |
| No. 27 | 17B | | | | | | |
| Sample | Example | 28 | 0.48 | 0.09 | A | B | 0.75 |
| No. 28 | 18B | | | | | | |
| Sample | Example | 66 | 0.16 | 0.18 | C | A | 0.74 |
| No. 29 | 19B | | | | | | |
| Sample | Example | 77 | 0.36 | 0.26 | B | A | 0.72 |
| No. 30 | 20B | | | | | | |
| Sample | Example | 55 | 0.63 | 0.42 | A | C | 0.68 |
| No. 31 | 21B | | | | | | |
| Sample | Example | 53 | 0.22 | 0.44 | A | A | 0.81 |
| No. 32 | 22B | | | | | | |
| Sample | Example | 36 | 0.31 | 0.57 | A | A | 0.69 |
| No. 33 | 23B | | | | | | |
| Sample | Example | 45 | 0.27 | 0.62 | A | A | 0.63 |
| No. 34 | 24B | | | | | | |
| Sample | Example | 24 | 0.25 | 0.48 | A | B | 0.74 |
| No. 35 | 25B | | | | | | |
| Sample | Example | 49 | 0.38 | 0.26 | A | A | 0.77 |
| No. 36 | 26B | | | | | | |
| Sample | Example | 66 | 0.16 | 0.17 | A | A | 0.63 |
| No. 37 | 27B | | | | | | |
| Sample | Example | 77 | 0.36 | 0.13 | A | A | 0.66 |
| No. 38 | 28B | | | | | | |
| Sample | Example | 55 | 0.63 | 1.02 | A | C | 0.54 |
| No. 39 | 29B | | | | | | |
| Sample | Example | 19 | 0.37 | 1.23 | C | A | 0.45 |
| No. 40 | 30B | | | | | | |
| Sample | Example | 6 | 0.76 | 1.89 | C | A | 0.36 |
| No. 41 | 31B | | | | | | |
| Sample | Example | 17 | 0.42 | 1.05 | A | C | 0.48 |
| No. 42 | 32B | | | | | | |
| Sample | Example | 15 | 0.48 | 1.34 | A | C | 0.68 |
| No. 43 | 33B | | | | | | |
| Sample | Comparative | 93 | 0.52 | 2.56 | D | D | 0.32 |
| No. 44 | Example | | | | | | |
| | 11B | | | | | | |
| Sample | Comparative | 1 | 0.98 | 3.12 | D | D | 0.27 |
| No. 45 | Example | | | | | | |
| | 12B | | | | | | |
| Sample | Comparative | 2 | 1.05 | 2.04 | D | D | 0.31 |
| No. 46 | Example | | | | | | |
| | 13B | | | | | | |
| | | Test piece | | | | | |
| | | Evaluation results | | | | | |
| | | Vickers | 0.2% | | Young's | Fatigue | |
| | | hardness | proof stress | Elongation | modulus | strength | Slidability |
| | | — | MPa | % | GPa | MPa | — |
| Sample | Example | 265 | 505 | 40 | >150 | 665 | A |
| No. 22 | 12B | | | | | | |
| Sample | Example | 301 | 509 | 38 | >150 | 704 | A |
| No. 23 | 13B | | | | | | |
| Sample | Example | 295 | 501 | 33 | >150 | 721 | A |
| No. 24 | 14B | | | | | | |
| Sample | Example | 332 | 515 | 22 | >150 | 605 | B |
| No. 25 | 15B | | | | | | |
| Sample | Example | 308 | 516 | 32 | >150 | 748 | A |
| No. 26 | 16B | | | | | | |
| Sample | Example | 341 | 528 | 17 | >150 | 678 | B |
| No. 27 | 17B | | | | | | |
| Sample | Example | 379 | 542 | 9 | >150 | 654 | B |
| No. 28 | 18B | | | | | | |
| Sample | Example | 276 | 503 | 36 | >150 | 612 | A |
| No. 29 | 19B | | | | | | |
| Sample | Example | 262 | 507 | 41 | >150 | 621 | A |
| No. 30 | 20B | | | | | | |
| Sample | Example | 412 | 518 | 8 | >150 | 547 | C |
| No. 31 | 21B | | | | | | |
| Sample | Example | 265 | 505 | 40 | >150 | 556 | C |
| No. 32 | 22B | | | | | | |
| Sample | Example | 301 | 509 | 38 | >150 | 698 | A |
| No. 33 | 23B | | | | | | |
| Sample | Example | 295 | 501 | 33 | >150 | 710 | A |
| No. 34 | 24B | | | | | | |
| Sample | Example | 332 | 515 | 22 | >150 | 531 | C |
| No. 35 | 25B | | | | | | |
| Sample | Example | 308 | 516 | 32 | >150 | 654 | A |
| No. 36 | 26B | | | | | | |
| Sample | Example | 289 | 503 | 36 | >150 | 615 | A |
| No. 37 | 27B | | | | | | |
| Sample | Example | 296 | 507 | 41 | >150 | 632 | A |
| No. 38 | 28B | | | | | | |
| Sample | Example | 456 | 518 | 8 | >150 | 465 | C |
| No. 39 | 29B | | | | | | |
| Sample | Example | 546 | 415 | 7 | — | 457 | C |
| No. 40 | 30B | | | | | | |
| Sample | Example | 523 | 431 | 5 | — | 474 | C |
| No. 41 | 31B | | | | | | |
| Sample | Example | 534 | 335 | 3 | >150 | 336 | C |
| No. 42 | 32B | | | | | | |
| Sample | Example | 524 | 342 | 3 | >150 | 343 | C |
| No. 43 | 33B | | | | | | |
| Sample | Comparative | 565 | 326 | 4 | — | 359 | D |
| No. 44 | Example | | | | | | |
| | 11B | | | | | | |
| Sample | Comparative | 506 | 301 | 18 | — | 331 | D |
| No. 45 | Example | | | | | | |
| | 12B | | | | | | |
| Sample | Comparative | 495 | 297 | 12 | — | 327 | C |
| No. 46 | Example | | | | | | |
| | 13B | | | | | | |

As apparent from Tables 8 and 9, the test piece corresponding to each Example was confirmed to have high 0.2% proof stress and excellent corrosion resistance, and also confirmed to have relatively high fatigue strength, Young's modulus, etc. Based on these results, the dental anchor formed from the dental alloy material corresponding to each Example was confirmed to have high mechanical properties such as proof stress and high corrosion resistance. Therefore, it was confirmed that even when it is placed, for example, in the mouth and is used in an environment where a force is continuously applied thereto over a long period of time, it is hardly bent or fractured.

Further, it was also confirmed that the test piece of each Example contains a given amount of silicon oxide, but contains almost no dendrite phase.

On the other hand, the test piece of each Comparative Example was confirmed to have low corrosion resistance and low mechanical properties.

### Examples 34B to 40B

Test pieces having an alloy composition shown in Table 10 were produced.

### 3. Evaluation of Relationship between Concentration of N and Hardness

According to the procedure of the above-described “2.4 Measurement of Vickers Hardness”, the Vickers hardness of each of the test pieces of the respective Examples 34B to 40B was measured. The measurement results are shown in Table 10 and FIG. 15.

TABLE 10

| | | Test piece | | | | | | | |
|---|---|---|---|---|---|---|---|---|---|
| | | | | | | | | | Eval- |
| | | | | | | | | | uation |
| | | | | | | | | | results |
| | | | | | | | | | Vick- |
| | | | | | | | | | ers |
| | | | | | | | | | hard- |
| | | | | | | | | | ness |
| | | | | | | | | | Sur- |
| | | | | | | | | | face |
| | | Alloy composition | | | | | | | layer |
| | | Cr | Mo | Si | C | N | Ni | Co | portion |
| | | % by mass | | | | | | | — |
| Sam- | Ex- | 29.7 | 6.84 | 0.77 | 0.02 | 0.10 | 0.01 | re- | 325 |
| ple | ample | | | | | | | main- | |
| No. 47 | 34B | | | | | | | der | |
| Sam- | Ex- | 29.8 | 6.80 | 0.78 | 0.02 | 0.13 | 0.01 | re- | 315 |
| ple | ample | | | | | | | main- | |
| No. 48 | 35B | | | | | | | der | |
| Sam- | Ex- | 30.2 | 6.82 | 0.79 | 0.02 | 0.15 | 0.01 | re- | 281 |
| ple | ample | | | | | | | main- | |
| No. 49 | 36B | | | | | | | der | |
| Sam- | Ex- | 29.9 | 6.83 | 0.78 | 0.02 | 0.18 | 0.01 | re- | 271 |
| ple | ample | | | | | | | main- | |
| No. 50 | 37B | | | | | | | der | |
| Sam- | Ex- | 30.1 | 6.85 | 0.77 | 0.02 | 0.21 | 0.01 | re- | 284 |
| ple | ample | | | | | | | main- | |
| No. 51 | 38B | | | | | | | der | |
| Sam- | Ex- | 29.6 | 6.84 | 0.76 | 0.02 | 0.23 | 0.01 | re- | 380 |
| ple | ample | | | | | | | main- | |
| No. 52 | 39B | | | | | | | der | |
| Sam- | Ex- | 29.7 | 6.81 | 0.78 | 0.02 | 0.27 | 0.01 | re- | 394 |
| ple | ample | | | | | | | main- | |
| No. 53 | 40B | | | | | | | der | |

As apparent from Table 10 and FIG. 15, the concentration of N in the test piece and the Vickers hardness have such a relationship that the hardness reaches the local minimum at a specific N concentration. When the hardness is appropriately decreased, the toughness of the test piece is increased, so that the improvement of the tensile strength, proof stress, etc. is observed. When the hardness is near the local minimum, the balance between the hardness and the proof stress is favorable, and thus, such an alloy can be used as a dental alloy material useful as a dental anchor.

### Examples of Third Embodiment of Dental Component

### 1. Production of Test Piece

### Example 1C

(1) First, a starting material having an alloy composition shown in Table 11 was melted in a high-frequency induction furnace, whereby a molten material of the starting material was obtained. Then, the obtained molten material of the starting material was powdered by a water atomization method, whereby a metal powder was obtained. Subsequently, the particles of the obtained metal powder were classified using a standard sieve having a mesh size of 150 μm. Incidentally, in the determination of the alloy composition, an optical emission spectrometer for solids (a spark optical emission spectrometer) manufactured by SPECTRO Analytical Instruments GmbH (model: Spectrolab, type: LAVMB08A) was used. Further, in the quantitative analysis of C (carbon) in the particles of the metal powder, a carbon/sulfur analyzer CS-200 manufactured by LECO Corporation was used.

(2) Subsequently, the metal powder and a mixture (an organic binder) of polypropylene and a wax were weighed such that the mass ratio thereof was 9:1, followed by mixing, whereby a mixed starting material was obtained.

(3) Subsequently, this mixed starting material was kneaded using a kneader, whereby a kneaded material was obtained.

(4) Subsequently, this kneaded material was molded using an injection molding machine under the following molding conditions, whereby a molded body was produced.

### Molding Conditions

Temperature of material: 150° C.
Injection pressure: 11 MPa (110 kgf/cm²)

(5) Subsequently, this molded body was degreased under the following degreasing conditions, whereby a degreased body was obtained.

### Degreasing Conditions

Degreasing temperature: 470° C.
Degreasing time: 1 hour
Degreasing atmosphere: nitrogen atmosphere

(6) Subsequently, the obtained degreased body was fired under the following firing conditions, whereby a sintered body was obtained.

### Firing Conditions

Firing temperature: 1300° C.
Firing time: 3 hours
Firing atmosphere: argon atmosphere

(7) Subsequently, the obtained sintered body was subjected to a barrel polishing treatment. By doing this, a test piece was obtained.

### Examples 2C to 11C and Comparative Examples 1C and 2C

Test pieces were obtained in the same manner as in Example 1C except that the production conditions were changed to the conditions shown in Table 11, respectively.

### Comparative Examples 3C and 4C

A starting material having an alloy composition shown in Table 11 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a test piece was obtained.

### Comparative Examples 5C to 7C

Test pieces were obtained in the same manner as in Example 1C except that the production conditions were changed to the conditions shown in Table 11, respectively.

### Comparative Examples 8C to 10C

A starting material having an alloy composition shown in Table 11 was melted in a high-frequency induction furnace, the resulting molten metal was poured into a mold, whereby a cast body was obtained. Subsequently, the obtained cast body was subjected to a barrel polishing treatment. By doing this, a test piece was obtained.

TABLE 11

| | | Test piece | | | | | | | | | | |
|---|---|---|---|---|---|---|---|---|---|---|---|---|
| | | Alloy composition | | | | | | | | | | With or |
| | | Cr | Mo | Si | C | N | Ni | Co | | | Molding | without |
| | | % by mass | | | | | | | Si/Mo | C/Si | method | polishing |
| Sample No. 1 | Example 1C | 29.0 | 6.04 | 0.70 | 0.05 | 0.00 | 0.01 | remainder | 0.116 | 0.071 | Powder | With |
| | | | | | | | | | | | metallurgy | polishing |
| Sample No. 2 | Example 2C | 27.4 | 8.53 | 0.95 | 0.04 | 0.00 | 0.01 | remainder | 0.111 | 0.042 | Powder | With |
| | | | | | | | | | | | metallurgy | polishing |
| Sample No. 3 | Example 3C | 28.3 | 7.24 | 0.86 | 0.05 | 0.00 | 0.01 | remainder | 0.119 | 0.058 | Powder | With |
| | | | | | | | | | | | metallurgy | polishing |
| Sample No. 4 | Example 4C | 26.2 | 5.30 | 0.52 | 0.02 | 0.00 | 0.01 | remainder | 0.098 | 0.038 | Powder | With |
| | | | | | | | | | | | metallurgy | polishing |
| Sample No. 5 | Example 5C | 31.8 | 6.54 | 0.75 | 0.07 | 0.00 | 0.01 | remainder | 0.115 | 0.093 | Powder | With |
| | | | | | | | | | | | metallurgy | polishing |
| Sample No. 6 | Example 6C | 33.4 | 9.25 | 0.64 | 0.12 | 0.00 | 0.01 | remainder | 0.069 | 0.188 | Powder | With |
| | | | | | | | | | | | metallurgy | polishing |
| Sample No. 7 | Example 7C | 34.6 | 11.50 | 0.94 | 0.31 | 0.00 | 0.01 | remainder | 0.082 | 0.330 | Powder | With |
| | | | | | | | | | | | metallurgy | polishing |
| Sample No. 8 | Example 8C | 27.2 | 5.52 | 0.97 | 0.08 | 0.00 | 0.01 | remainder | 0.176 | 0.082 | Powder | With |
| | | | | | | | | | | | metallurgy | polishing |
| Sample No. 9 | Example 9C | 26.5 | 7.79 | 0.83 | 0.15 | 0.00 | 0.02 | remainder | 0.107 | 0.181 | Powder | With |
| | | | | | | | | | | | metallurgy | polishing |
| Sample No. 10 | Example 10C | 29.8 | 5.87 | 0.65 | 1.24 | 0.00 | 0.02 | remainder | 0.111 | 1.908 | Powder | With |
| | | | | | | | | | | | metallurgy | polishing |
| Sample No. 11 | Example 11C | 28.6 | 6.12 | 0.74 | 0.00 | 0.00 | 0.02 | remainder | 0.121 | 0.000 | Powder | With |
| | | | | | | | | | | | metallurgy | polishing |
| Sample No. 12 | Comparative | 29.4 | 5.89 | 0.26 | 0.06 | 0.00 | 0.85 | remainder | 0.044 | 0.231 | Powder | With |
| | Example 1C | | | | | | | | | | metallurgy | polishing |
| Sample No. 13 | Comparative | 31.6 | 6.74 | 2.06 | 0.06 | 0.00 | 0.77 | remainder | 0.306 | 0.029 | Powder | With |
| | Example 2C | | | | | | | | | | metallurgy | polishing |
| Sample No. 14 | Comparative | 30.5 | 6.23 | 0.75 | 0.04 | 0.00 | 0.02 | remainder | 0.120 | 0.053 | Casting | With |
| | Example 3C | | | | | | | | | | | polishing |
| Sample No. 15 | Comparative | 28.4 | 11.60 | 0.87 | 0.11 | 0.00 | 0.89 | remainder | 0.075 | 0.126 | Casting | With |
| | Example 4C | | | | | | | | | | | polishing |

| | | | | | | |
|---|---|---|---|---|---|---|
| Sample No. 16 | Comparative | Ti | — | — | Powder | With |
| | Example 5C | | | | metallurgy | polishing |
| Sample No. 17 | Comparative | Ti-6Al-4V | — | — | Powder | With |
| | Example 6C | | | | metallurgy | polishing |
| Sample No. 18 | Comparative | 17-4PH stainless steel | — | — | Powder | With |
| | Example 7C | | | | metallurgy | polishing |
| Sample No. 19 | Comparative | Ti | — | — | Casting | With |
| | Example 8C | | | | | polishing |
| Sample No. 20 | Comparative | Ti-6Al-4V | — | — | Casting | With |
| | Example 9C | | | | | polishing |
| Sample No. 21 | Comparative | 17-4PH stainless steel | — | — | Casting | With |
| | Example 10C | | | | | polishing |

### Example 12C

(1) First, a starting material having an alloy composition shown in Table 12 was melted in a high-frequency induction furnace, whereby a molten material of the starting material was obtained. Then, the obtained molten material of the starting material was powdered by a water atomization method, whereby a metal powder was obtained. Subsequently, the particles of the obtained metal powder were classified using a standard sieve having a mesh size of 150 μm. Incidentally, N was incorporated in the starting material in a state where N was attached to Cr (a state of chromium nitride). Further, in the determination of the alloy composition, an optical emission spectrometer for solids (a spark optical emission spectrometer) manufactured by SPECTRO Analytical Instruments GmbH (model: Spectrolab, type: LAVMB08A) was used. Further, in the quantitative analysis of C (carbon) in the particles of the metal powder, a carbon/sulfur analyzer CS-200 manufactured by LECO Corporation was used. Further, in the quantitative analysis of N (nitrogen) in the particles of the metal powder, an oxygen-nitrogen analyzer, TC-300/EF-300 manufactured by LECO Corporation was used.

(2) Subsequently, the metal powder and a mixture (an organic binder) of polypropylene and a wax were weighed such that the mass ratio thereof was 9:1, followed by mixing, whereby a mixed starting material was obtained.

(3) Subsequently, this mixed starting material was kneaded using a kneader, whereby a kneaded material was obtained.

(4) Subsequently, this kneaded material was molded using an injection molding machine under the following molding conditions, whereby a molded body was produced.

### Molding Conditions

Temperature of material: 150° C.
Injection pressure: 11 MPa (110 kgf/cm²)

(5) Subsequently, the obtained molded body was subjected to a heat treatment (degreasing treatment) under the following degreasing conditions, whereby a degreased body was obtained.

### Degreasing Conditions

Degreasing temperature: 470° C.
Degreasing time: 1 hour
Degreasing atmosphere: nitrogen atmosphere

(6) Subsequently, the obtained degreased body was fired under the following firing conditions, whereby a sintered body was obtained.

### Firing Conditions

Firing temperature: 1300° C.
Firing time: 3 hours
Firing atmosphere: argon atmosphere

(7) Subsequently, the obtained sintered body was subjected to a barrel polishing treatment. By doing this, a test piece was obtained.

### Examples 13C to 25C

Test pieces were obtained in the same manner as in Example 12C except that the production conditions were changed to the conditions shown in Table 12, respectively.

### Examples 26C to 28C

When a starting material was melted in a high-frequency induction furnace, nitrogen gas was injected into the molten metal. At this time, by appropriately changing the injection time, the content of N was changed.

Then, test pieces were obtained in the same manner as in Example 12C except that the production conditions other than this were changed to the conditions shown in Table 12, respectively.

### Examples 30C to 33C

First, a metal powder was obtained in the same manner as in Example 12C by using a starting material containing no N.

Subsequently, a sintered body was obtained in the same manner as in Example 12C except that the obtained metal powder was used, and also the firing atmosphere in the firing conditions was changed to a mixed gas atmosphere containing argon at 50% by volume and nitrogen at 50% by volume. At this time, by appropriately changing the partial pressure of nitrogen gas, the content of N contained in the metal powder was changed.

Then, test pieces were obtained in the same manner as in Example 12C except that the production conditions other than this were changed to the conditions shown in Table 12, respectively.

### Comparative Examples 11C to 13C

A starting material having an alloy composition shown in Table 12 was melted in a high-frequency induction furnace, whereby a molten material of the starting material was obtained. Then, the molten metal (molten material of the starting material) was poured into a mold, whereby a cast body was obtained. Subsequently, the obtained cast body was subjected to a barrel polishing treatment. By doing this, a test piece as obtained.

TABLE 12

| | | Test piece | | | | | | | | | | | | | |
|---|---|---|---|---|---|---|---|---|---|---|---|---|---|---|---|
| | | Alloy composition | | | | | | | | | | | N | | With or |
| | | Cr | Mo | Si | C | N | Ni | Co | | | | | impregnation | Molding | without |
| | | % by mass | | | | | | | Si/Mo | C/Si | N/Si | N/C | method | method | polishing |
| Sample | Example | 29.8 | 6.80 | 0.78 | 0.02 | 0.13 | 0.01 | re- | 0.115 | 0.026 | 0.167 | 6.50 | Metal nitride | Powder | With |
| No. 22 | 12C | | | | | | | main- | | | | | starting | metallurgy | polishing |
| | | | | | | | | der | | | | | material | | |
| Sample | Example | 27.3 | 8.43 | 0.96 | 0.04 | 0.18 | 0.01 | re- | 0.114 | 0.042 | 0.188 | 4.50 | Metal nitride | Powder | With |
| No. 23 | 13C | | | | | | | main- | | | | | starting | metallurgy | polishing |
| | | | | | | | | der | | | | | material | | |
| Sample | Example | 28.5 | 7.21 | 0.83 | 0.03 | 0.12 | 0.01 | re- | 0.115 | 0.036 | 0.145 | 4.00 | Metal nitride | Powder | With |
| No. 24 | 14C | | | | | | | main- | | | | | starting | metallurgy | polishing |
| | | | | | | | | der | | | | | material | | |
| Sample | Example | 26.1 | 5.32 | 0.34 | 0.02 | 0.09 | 0.01 | re- | 0.064 | 0.059 | 0.265 | 4.50 | Metal nitride | Powder | With |
| No. 25 | 15C | | | | | | | main- | | | | | starting | metallurgy | polishing |
| | | | | | | | | der | | | | | material | | |
| Sample | Example | 31.9 | 6.50 | 0.71 | 0.07 | 0.23 | 0.01 | re- | 0.109 | 0.099 | 0.324 | 3.29 | Metal nitride | Powder | With |
| No. 26 | 16C | | | | | | | main- | | | | | starting | metallurgy | polishing |
| | | | | | | | | der | | | | | material | | |
| Sample | Example | 33.5 | 9.27 | 0.65 | 0.13 | 0.28 | 0.01 | re- | 0.070 | 0.200 | 0.431 | 2.15 | Metal nitride | Powder | With |
| No. 27 | 17C | | | | | | | main- | | | | | starting | metallurgy | polishing |
| | | | | | | | | der | | | | | material | | |
| Sample | Example | 34.9 | 11.80 | 0.95 | 0.35 | 0.27 | 0.01 | re- | 0.081 | 0.368 | 0.284 | 0.77 | Metal nitride | Powder | With |
| No. 28 | 18C | | | | | | | main- | | | | | starting | metallurgy | polishing |
| | | | | | | | | der | | | | | material | | |
| Sample | Example | 27.1 | 5.49 | 0.96 | 0.07 | 0.11 | 0.01 | re- | 0.175 | 0.073 | 0.115 | 1.57 | Metal nitride | Powder | With |
| No. 29 | 19C | | | | | | | main- | | | | | starting | metallurgy | polishing |
| | | | | | | | | der | | | | | material | | |
| Sample | Example | 26.1 | 5.11 | 0.83 | 0.04 | 0.12 | 0.02 | re- | 0.162 | 0.048 | 0.145 | 3.00 | Metal nitride | Powder | With |
| No. 30 | 20C | | | | | | | main- | | | | | starting | metallurgy | polishing |
| | | | | | | | | der | | | | | material | | |
| Sample | Example | 29.9 | 10.75 | 0.65 | 1.19 | 0.21 | 0.02 | re- | 0.060 | 1.831 | 0.323 | 0.18 | Metal nitride | Powder | With |
| No. 31 | 21C | | | | | | | main- | | | | | starting | metallurgy | polishing |
| | | | | | | | | der | | | | | material | | |
| Sample | Example | 29.8 | 6.80 | 0.78 | 0.05 | 0.26 | 0.01 | re- | 0.115 | 0.064 | 0.333 | 5.20 | Metal nitride | Powder | With |
| No. 32 | 22C | | | | | | | main- | | | | | starting | metallurgy | polishing |
| | | | | | | | | der | | | | | material | | |
| Sample | Example | 27.3 | 8.43 | 0.96 | 0.04 | 0.36 | 0.01 | re- | 0.114 | 0.042 | 0.375 | 9.00 | Metal nitride | Powder | Without |
| No. 33 | 23C | | | | | | | main- | | | | | starting | metallurgy | polishing |
| | | | | | | | | der | | | | | material | | |
| Sample | Example | 28.5 | 7.21 | 0.83 | 0.03 | 0.24 | 0.01 | re- | 0.115 | 0.036 | 0.289 | 8.00 | Metal nitride | Powder | Without |
| No. 34 | 24C | | | | | | | main- | | | | | starting | metallurgy | polishing |
| | | | | | | | | der | | | | | material | | |
| Sample | Example | 26.1 | 5.32 | 0.54 | 0.00 | 0.18 | 0.01 | re- | 0.102 | 0.000 | 0.333 | — | Metal nitride | Powder | Without |
| No. 35 | 25C | | | | | | | main- | | | | | starting | metallurgy | polishing |
| | | | | | | | | der | | | | | material | | |
| Sample | Example | 31.9 | 6.50 | 0.71 | 0.03 | 0.46 | 0.01 | re- | 0.109 | 0.042 | 0.648 | 15.33 | Injection into | Powder | With |
| No. 36 | 26C | | | | | | | main- | | | | | molten metal | metallurgy | polishing |
| | | | | | | | | der | | | | | | | |
| Sample | Example | 27.1 | 5.49 | 0.96 | 0.07 | 0.35 | 0.01 | re- | 0.175 | 0.073 | 0.365 | 5.00 | Injection into | Powder | With |
| No. 37 | 27C | | | | | | | main- | | | | | molten metal | metallurgy | polishing |
| | | | | | | | | der | | | | | | | |
| Sample | Example | 26.1 | 5.11 | 0.83 | 0.04 | 0.31 | 0.02 | re- | 0.162 | 0.048 | 0.373 | 7.75 | Injection into | Powder | With |
| No. 38 | 28C | | | | | | | main- | | | | | molten metal | metallurgy | polishing |
| | | | | | | | | der | | | | | | | |
| Sample | Example | 29.9 | 6.52 | 0.65 | 1.19 | 0.42 | 0.02 | re- | 0.100 | 1.831 | 0.646 | 0.35 | Injection into | Powder | With |
| No. 39 | 29C | | | | | | | main- | | | | | molten metal | metallurgy | polishing |
| | | | | | | | | der | | | | | | | |
| Sample | Example | 29.1 | 5.88 | 0.71 | 0.02 | 0.01 | 0.01 | re- | 0.121 | 0.028 | 0.014 | 0.50 | Nitriding | Powder | With |
| No. 40 | 30C | | | | | | | main- | | | | | during | metallurgy | polishing |
| | | | | | | | | der | | | | | sintering | | |
| Sample | Example | 32.4 | 6.78 | 1.45 | 0.06 | 0.03 | 0.02 | re- | 0.214 | 0.041 | 0.021 | 0.50 | Nitriding | Powder | With |
| No. 41 | 31C | | | | | | | main- | | | | | during | metallurgy | polishing |
| | | | | | | | | der | | | | | sintering | | |
| Sample | Example | 33.5 | 9.27 | 0.65 | 0.13 | 0.56 | 0.01 | re- | 0.070 | 0.200 | 0.862 | 4.31 | Metal nitride | Powder | With |
| No. 42 | 32C | | | | | | | main- | | | | | during | metallurgy | polishing |
| | | | | | | | | der | | | | | material | | |
| Sample | Example | 34.9 | 11.80 | 0.95 | 0.35 | 0.54 | 0.01 | re- | 0.081 | 0.368 | 0.568 | 1.54 | Nitriding | Powder | With |
| No. 43 | 33C | | | | | | | main- | | | | | during | metallurgy | polishing |
| | | | | | | | | der | | | | | sintering | | |
| Sample | Com- | 29.2 | 6.11 | 0.65 | 0.04 | 0.32 | 0.02 | re- | 0.106 | 0.062 | 0.492 | 8.00 | Injection into | Casting | With |
| No. 44 | parative | | | | | | | main- | | | | | molten metal | | polishing |
| | Example | | | | | | | der | | | | | | | |
| | 11C | | | | | | | | | | | | | | |
| Sample | Com- | 27.9 | 5.82 | 0.69 | 0.02 | 0.45 | 0.03 | re- | 0.119 | 0.029 | 0.652 | 22.50 | Injection into | Casting | With |
| No. 45 | parative | | | | | | | main- | | | | | molten metal | | polishing |
| | Example | | | | | | | der | | | | | | | |
| | 12C | | | | | | | | | | | | | | |
| Sample | Com- | 30.1 | 6.99 | 0.61 | 0.05 | 0.39 | 0.10 | re- | 0.087 | 0.082 | 0.639 | 7.80 | Injection into | Casting | With |
| No. 46 | parative | | | | | | | main- | | | | | molten metal | | polishing |
| | Example | | | | | | | der | | | | | | | |
| | 13C | | | | | | | | | | | | | | |

### 2. Evaluation of Test Piece

### 2.1 Measurement of Total Amount of Si and Content of Si Contained as Silicon Oxide

For each of the test pieces of the respective Examples and Comparative Examples, the total amount of Si and the content of Si contained as silicon oxide were measured by gravimetry and ICP optical emission spectroscopy. The measurement results are shown in Tables 13 and 14.

### 2.2 Evaluation of Crystal Structure by X-ray Diffractometry

For each of the test pieces of the respective Examples and Comparative Examples, a crystal structure analysis was performed by X-ray diffractometry. Then, the height and the position of each peak contained in an obtained X-ray diffraction pattern were collated with the database listed in ICDD card, whereby the crystal structure contained in the test piece was identified. Then, when the height of the highest peak among the peaks derived from Co was assumed to be 1, the height of the highest peak among the peaks derived from Co₃Mo was calculated. The calculation results are shown in Tables 13 and 14.

### 2.3 Evaluation of Pore, Dendrite Phase, and Aspect Ratio of Crystal Structure

Each of the test pieces of the respective Examples and Comparative Examples was cut and the cut surface was polished. Subsequently, the obtained polished surface was observed with a scanning electron microscope, and a region occupied by a pore in the observation image was specified. Then, the average diameter of the region occupied by a pore (this is regarded as the average diameter of a pore) was measured, and also the ratio of the area of the region occupied by a pore to the total area of the observation image (area ratio) was calculated.

Further, by observing the obtained polished surface with a scanning electron microscope and confirming the degree of existence of a dendritic structure in the observation image, the degree of existence of the dendrite phase was evaluated according to the following evaluation criteria.

### Evaluation Criteria for Dendrite Phase

A: Almost no dendrite phase exists.
B: A dendrite phase exists in a slight amount (at an area ratio of 10% or less).
C: A dendrite phase exists in a slightly large amount (at an area ratio of more than 10% and 20% or less).
D: A dendrite phase exists in a very large amount (at an area ratio of more than 20%).

Further, the obtained polished surface was observed with a scanning electron microscope, and an average of the aspect ratio of a crystal structure in the observation image was calculated.

The above evaluation results are shown in Tables 13 and 14.

### 2.4 Measurement of Vickers Hardness

For the surface of each of the test pieces of the respective Examples and Comparative Examples, the Vickers hardness was measured. The measurement results are shown in Tables 13 and 14.

### 2.5 Evaluation of Corrosion Resistance

For each of the test pieces of the respective Examples and Comparative Examples, the amount of eluted metal ions was measured in accordance with the test method for corrosion resistance of a noble metal material for dental metal-ceramic restoration specified in JIS T 6118.

Then, the measurement results were evaluated based on the following evaluation criteria.

### Evaluation Criteria for Corrosion Resistance

A: The corrosion resistance is very high (the amount of eluted metal ions is very small).
B: The corrosion resistance is high (the amount of eluted metal ions is small).
C: The corrosion resistance is low (the amount of eluted metal ions is large).
D: The corrosion resistance is very low (the amount of eluted metal ions is very large).

The above evaluation results are shown in Tables 13 and 14.

### 2.6 Measurement of 0.2% Proof Stress, Elongation, and Young's Modulus

For each of the test pieces of the respective Examples and Comparative Examples, the 0.2% proof stress and the elongation were measured in accordance with the test method for mechanical properties of a noble metal material for dental metal-ceramic restoration specified in JIS T 6118.

Further, the Young's modulus was obtained in accordance with the test method for a dental metal material specified in JIS T 6004.

The measurement results are shown in Tables 13 and 14.

### 2.7 Measurement of Fatigue Strength

For each of the test pieces of the respective Examples and Comparative Examples, the fatigue strength was measured in accordance with the test method specified in JIS T 0309.

The measurement results are shown in Tables 13 and 14.

### 2.8 Measurement of Surface Roughness

For each of the test pieces of the respective Examples and Comparative Examples, the arithmetic average roughness Ra of the surface thereof was measured using a stylus-type surface roughness tester.

The measurement results are shown in Tables 13 and 14.

### 2.9 Evaluation of Slidability

For each of the test pieces of the respective Examples and Comparative Examples, the wear coefficient of the surface thereof was measured in accordance with the B method (pin-on-disk method) of the sliding wear test method specified in JIS K 7218. Then, the sliding wear performance was evaluated based on the following evaluation criteria. Incidentally, as a counter material in the sliding wear test, a test piece of hydroxyapatite regarded as bone was used.

### Evaluation Criteria for Sliding Wear Performance

A: The sliding wear performance is very favorable.
B: The sliding wear performance is favorable.
C: The sliding wear performance is slightly favorable.
D: The sliding wear performance is unfavorable.

The above evaluation results are shown in Tables 13 and 14.

TABLE 13

| | | Test piece | | | | | | |
|---|---|---|---|---|---|---|---|---|
| | | Evaluation results | | | | | | |
| | | SiO₂/ | Ratio of | Pore | | Arithmetic | | |
| | | total | height of | Average | Area | average | Dendrite | Corrosion |
| | | Si | peak in XRD | diameter | ratio | roughness Ra | phase | resistance |
| | | % | — | μm | % | μm | — | — |
| Sample | Example 1C | 0.53 | 0.22 | 0.53 | 0.025 | 0.24 | A | A |
| No. 1 | | | | | | | | |
| Sample | Example 2C | 0.36 | 0.31 | 0.66 | 0.038 | 0.31 | A | A |
| No. 2 | | | | | | | | |
| Sample | Example 3C | 0.45 | 0.27 | 0.58 | 0.032 | 0.12 | A | A |
| No. 3 | | | | | | | | |
| Sample | Example 4C | 0.24 | 0.25 | 0.74 | 0.051 | 0.08 | A | B |
| No. 4 | | | | | | | | |
| Sample | Example 5C | 0.49 | 0.38 | 0.35 | 0.022 | 0.36 | A | A |
| No. 5 | | | | | | | | |
| Sample | Example 6C | 0.32 | 0.42 | 0.89 | 0.087 | 0.41 | A | A |
| No. 6 | | | | | | | | |
| Sample | Example 7C | 0.28 | 0.48 | 0.97 | 0.097 | 0.56 | A | A |
| No. 7 | | | | | | | | |
| Sample | Example 8C | 0.66 | 0.16 | 0.45 | 0.121 | 0.91 | A | A |
| No. 8 | | | | | | | | |
| Sample | Example 9C | 0.77 | 0.36 | 0.43 | 0.112 | 0.23 | A | B |
| No. 9 | | | | | | | | |
| Sample | Example 10C | 0.55 | 0.63 | 0.75 | 0.089 | 0.18 | A | B |
| No. 10 | | | | | | | | |
| Sample | Example 11C | 0.55 | 0.37 | 0.75 | 0.063 | 0.32 | A | A |
| No. 11 | | | | | | | | |
| Sample | Comparative | 0.06 | 0.76 | 0.25 | 0.087 | 0.04 | B | B |
| No. 12 | Example 1C | | | | | | | |
| Sample | Comparative | 0.93 | 0.52 | 0.33 | 0.077 | 1.54 | B | C |
| No. 13 | Example 2C | | | | | | | |
| Sample | Comparative | 0.01 | 0.98 | 0.05 | 0.001 | 0.02 | D | C |
| No. 14 | Example 3C | | | | | | | |
| Sample | Comparative | 0.02 | 1.05 | 0.06 | 0.001 | 0.03 | D | C |
| No. 15 | Example 4C | | | | | | | |
| Sample | Comparative | — | — | — | — | 0.56 | — | C |
| No. 16 | Example 5C | | | | | | | |
| Sample | Comparative | — | — | — | — | 0.42 | — | C |
| No. 17 | Example 6C | | | | | | | |
| Sample | Comparative | — | — | — | — | 0.36 | — | D |
| No. 18 | Example 7C | | | | | | | |
| Sample | Comparative | — | — | — | — | 0.03 | — | C |
| No. 19 | Example 8C | | | | | | | |
| Sample | Comparative | — | — | — | — | 0.04 | — | C |
| No. 20 | Example 9C | | | | | | | |
| Sample | Comparative | — | — | — | — | 0.02 | — | D |
| No. 21 | Example 10C | | | | | | | |
| | | Test piece | | | | | | |
| | | Evaluation results | | | | | | |
| | | Aspect | Vickers | 0.2% proof | | Young's | Fatigue | |
| | | ratio | hardness | stress | Elongation | modulus | strength | Slidability |
| | | — | — | MPa | % | GPa | MPa | — |
| Sample | Example 1C | 0.71 | 350 | 505 | 35 | >150 | 650 | A |
| No. 1 | | | | | | | | |
| Sample | Example 2C | 0.69 | 385 | 485 | 26 | >150 | 565 | A |
| No. 2 | | | | | | | | |
| Sample | Example 3C | 0.64 | 364 | 501 | 30 | >150 | 675 | A |
| No. 3 | | | | | | | | |
| Sample | Example 4C | 0.81 | 401 | 455 | 10 | >150 | 558 | B |
| No. 4 | | | | | | | | |
| Sample | Example 5C | 0.75 | 365 | 512 | 31 | >150 | 712 | A |
| No. 5 | | | | | | | | |
| Sample | Example 6C | 0.72 | 426 | 512 | 5 | >150 | 683 | A |
| No. 6 | | | | | | | | |
| Sample | Example 7C | 0.68 | 448 | 513 | 4 | >150 | 597 | B |
| No. 7 | | | | | | | | |
| Sample | Example 8C | 0.83 | 433 | 512 | 7 | >150 | 564 | B |
| No. 8 | | | | | | | | |
| Sample | Example 9C | 0.74 | 422 | 507 | 7 | >150 | 625 | A |
| No. 9 | | | | | | | | |
| Sample | Example 10C | 0.76 | 449 | 510 | 4 | >150 | 542 | A |
| No. 10 | | | | | | | | |
| Sample | Example 11C | 0.59 | 375 | 501 | 28 | >150 | 566 | A |
| No. 11 | | | | | | | | |
| Sample | Comparative | 0.58 | 457 | 432 | 4 | — | 475 | D |
| No. 12 | Example 1C | | | | | | | |
| Sample | Comparative | 0.36 | 234 | 276 | 35 | — | 458 | C |
| No. 13 | Example 2C | | | | | | | |
| Sample | Comparative | — | 560 | 520 | 2 | — | 275 | D |
| No. 14 | Example 3C | | | | | | | |
| Sample | Comparative | — | 620 | 545 | 1 | — | 246 | D |
| No. 15 | Example 4C | | | | | | | |
| Sample | Comparative | 0.31 | 180 | 380 | 25 | 110 | 310 | C |
| No. 16 | Example 5C | | | | | | | |
| Sample | Comparative | 0.39 | 305 | 820 | 12 | 120 | 540 | C |
| No. 17 | Example 6C | | | | | | | |
| Sample | Comparative | 0.56 | 402 | 900 | 6 | 190 | 300 | B |
| No. 18 | Example 7C | | | | | | | |
| Sample | Comparative | — | 180 | 240 | 30 | 102 | 240 | D |
| No. 19 | Example 8C | | | | | | | |
| Sample | Comparative | — | 310 | 910 | 12 | 108 | 450 | D |
| No. 20 | Example 9C | | | | | | | |
| Sample | Comparative | — | 412 | 950 | 4 | 170 | 260 | C |
| No. 21 | Example 10C | | | | | | | |

TABLE 14

| | | Test piece | | | | | | |
|---|---|---|---|---|---|---|---|---|
| | | Evaluation results | | | | | | |
| | | SiO₂/ | Ratio of | Pore | | Arithmetic | | |
| | | total | height of | Average | Area | average | Dendrite | Corrosion |
| | | Si | peak in XRD | diameter | ratio | roughness Ra | phase | resistance |
| | | % | — | μm | % | μm | — | — |
| Sample | Example 12C | 53 | 0.22 | 0.53 | 0.025 | 0.36 | B | A |
| No. 22 | | | | | | | | |
| Sample | Example 13C | 36 | 0.31 | 0.66 | 0.038 | 0.20 | A | A |
| No. 23 | | | | | | | | |
| Sample | Example 14C | 45 | 0.27 | 0.58 | 0.032 | 0.22 | B | A |
| No. 24 | | | | | | | | |
| Sample | Example 15C | 24 | 0.25 | 0.74 | 0.051 | 0.08 | C | B |
| No. 25 | | | | | | | | |
| Sample | Example 16C | 49 | 0.38 | 0.35 | 0.022 | 0.17 | A | A |
| No. 26 | | | | | | | | |
| Sample | Example 17C | 32 | 0.42 | 0.89 | 0.087 | 0.07 | A | B |
| No. 27 | | | | | | | | |
| Sample | Example 18C | 28 | 0.48 | 0.97 | 0.097 | 0.09 | A | B |
| No. 28 | | | | | | | | |
| Sample | Example 19C | 66 | 0.16 | 0.45 | 0.121 | 0.18 | C | A |
| No. 29 | | | | | | | | |
| Sample | Example 20C | 77 | 0.36 | 0.43 | 0.112 | 0.26 | B | A |
| No. 30 | | | | | | | | |
| Sample | Example 21C | 55 | 0.63 | 0.75 | 0.089 | 0.42 | A | C |
| No. 31 | | | | | | | | |
| Sample | Example 22C | 53 | 0.22 | 0.53 | 0.025 | 0.44 | A | A |
| No. 32 | | | | | | | | |
| Sample | Example 23C | 36 | 0.31 | 0.66 | 0.038 | 0.57 | A | A |
| No. 33 | | | | | | | | |
| Sample | Example 24C | 45 | 0.27 | 0.58 | 0.032 | 0.62 | A | A |
| No. 34 | | | | | | | | |
| Sample | Example 25C | 24 | 0.25 | 0.74 | 0.051 | 0.48 | A | B |
| No. 35 | | | | | | | | |
| Sample | Example 26C | 49 | 0.38 | 0.35 | 0.022 | 0.26 | A | A |
| No. 36 | | | | | | | | |
| Sample | Example 27C | 66 | 0.16 | 0.45 | 0.121 | 0.17 | A | A |
| No. 37 | | | | | | | | |
| Sample | Example 28C | 77 | 0.36 | 0.43 | 0.112 | 0.13 | A | A |
| No. 38 | | | | | | | | |
| Sample | Example 29C | 55 | 0.63 | 0.75 | 0.089 | 1.02 | A | C |
| No. 39 | | | | | | | | |
| Sample | Example 30C | 19 | 0.37 | 0.75 | 0.063 | 1.23 | C | A |
| No. 40 | | | | | | | | |
| Sample | Example 31C | 6 | 0.76 | 0.25 | 0.087 | 1.89 | C | A |
| No. 41 | | | | | | | | |
| Sample | Example 32C | 17 | 0.42 | 0.89 | 0.087 | 1.05 | A | C |
| No. 42 | | | | | | | | |
| Sample | Example 33C | 15 | 0.48 | 0.97 | 0.097 | 1.34 | A | C |
| No. 43 | | | | | | | | |
| Sample | Comparative | 93 | 0.52 | 15.2 | 1.5 | 2.56 | D | D |
| No. 44 | Example 11C | | | | | | | |
| Sample | Comparative | 1 | 0.98 | 12.5 | 1.2 | 3.12 | D | D |
| No. 45 | Example 12C | | | | | | | |
| Sample | Comparative | 2 | 1.05 | 10.3 | 1.1 | 2.04 | D | D |
| No. 46 | Example 13C | | | | | | | |
| | | Test piece | | | | | | |
| | | Evaluation results | | | | | | |
| | | | | 0.2% | | | | |
| | | Aspect | Vickers | proof | | Young's | Fatigue | |
| | | ratio | hardness | stress | Elongation | modulus | strength | Slidability |
| | | — | — | MPa | % | GPa | MPa | — |
| Sample | Example 12C | 0.65 | 265 | 505 | 40 | >150 | 665 | A |
| No. 22 | | | | | | | | |
| Sample | Example 13C | 0.72 | 301 | 509 | 38 | >150 | 704 | A |
| No. 23 | | | | | | | | |
| Sample | Example 14C | 0.81 | 295 | 501 | 33 | >150 | 721 | A |
| No. 24 | | | | | | | | |
| Sample | Example 15C | 0.53 | 332 | 515 | 22 | >150 | 605 | B |
| No. 25 | | | | | | | | |
| Sample | Example 16C | 0.64 | 308 | 516 | 32 | >150 | 748 | A |
| No. 26 | | | | | | | | |
| Sample | Example 17C | 0.82 | 341 | 528 | 17 | >150 | 678 | B |
| No. 27 | | | | | | | | |
| Sample | Example 18C | 0.75 | 379 | 542 | 9 | >150 | 654 | B |
| No. 28 | | | | | | | | |
| Sample | Example 19C | 0.74 | 276 | 503 | 36 | >150 | 612 | A |
| No. 29 | | | | | | | | |
| Sample | Example 20C | 0.72 | 262 | 507 | 41 | >150 | 621 | A |
| No. 30 | | | | | | | | |
| Sample | Example 21C | 0.68 | 412 | 518 | 8 | >150 | 547 | C |
| No. 31 | | | | | | | | |
| Sample | Example 22C | 0.81 | 265 | 505 | 40 | >150 | 556 | C |
| No. 32 | | | | | | | | |
| Sample | Example 23C | 0.69 | 301 | 509 | 38 | >150 | 698 | A |
| No. 33 | | | | | | | | |
| Sample | Example 24C | 0.63 | 295 | 501 | 33 | >150 | 710 | A |
| No. 34 | | | | | | | | |
| Sample | Example 25C | 0.74 | 332 | 515 | 22 | >150 | 531 | C |
| No. 35 | | | | | | | | |
| Sample | Example 26C | 0.77 | 308 | 516 | 32 | >150 | 654 | A |
| No. 36 | | | | | | | | |
| Sample | Example 27C | 0.63 | 289 | 503 | 36 | >150 | 615 | A |
| No. 37 | | | | | | | | |
| Sample | Example 28C | 0.66 | 296 | 507 | 41 | >150 | 632 | A |
| No. 38 | | | | | | | | |
| Sample | Example 29C | 0.54 | 456 | 518 | 8 | >150 | 465 | C |
| No. 39 | | | | | | | | |
| Sample | Example 30C | 0.45 | 546 | 415 | 7 | — | 457 | C |
| No. 40 | | | | | | | | |
| Sample | Example 31C | 0.36 | 523 | 431 | 5 | — | 474 | C |
| No. 41 | | | | | | | | |
| Sample | Example 32C | 0.48 | 534 | 335 | 3 | >150 | 336 | C |
| No. 42 | | | | | | | | |
| Sample | Example 33C | 0.68 | 524 | 342 | 3 | >150 | 343 | C |
| No. 43 | | | | | | | | |
| Sample | Comparative | 0.32 | 565 | 326 | 4 | — | 359 | D |
| No. 44 | Example 11C | | | | | | | |
| Sample | Comparative | 0.27 | 506 | 301 | 18 | — | 331 | D |
| No. 45 | Example 12C | | | | | | | |
| Sample | Comparative | 0.31 | 495 | 297 | 12 | — | 327 | C |
| No. 46 | Example 13C | | | | | | | |

As apparent from Tables 13 and 14, the test piece corresponding to each Example was confirmed to have high 0.2% proof stress and excellent corrosion resistance, and also confirmed to have relatively high fatigue strength, Young's modulus, etc. Based on these results, it was confirmed that the dental implant formed from the dental alloy material corresponding to each Example has high mechanical properties such as proof stress and high corrosion resistance, and therefore, even when it is placed, for example, in the mouth and is used in an environment where a force is continuously applied thereto over a long period of time, it is hardly fractured.

Further, it was also confirmed that the test piece of each Example contains a given amount of silicon oxide, but contains almost no dendrite phase.

On the other hand, the test piece of each Comparative Example was confirmed to have low corrosion resistance and low mechanical properties.

### Examples 34C to 40C

Test pieces having an alloy composition shown in Table 15 were produced.

### 3. Evaluation of Relationship between Concentration of N and Hardness

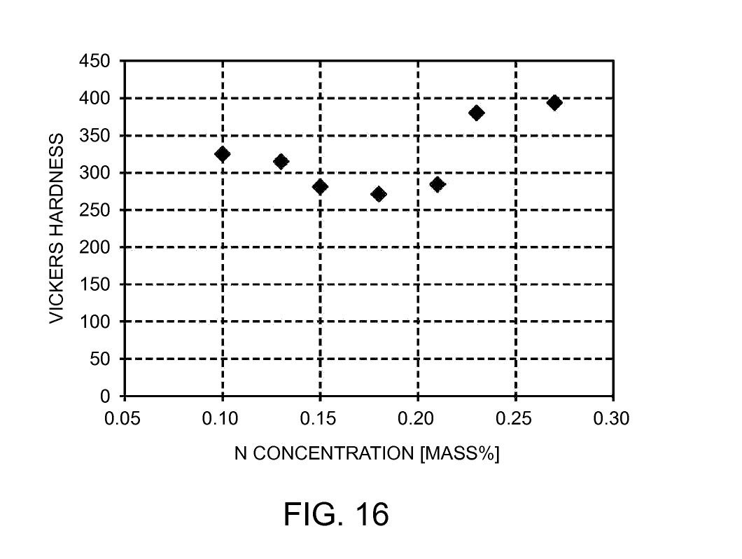

According to the procedure of the above-described “2.4 Measurement of Vickers Hardness”, the Vickers hardness of each of the test pieces of the respective Examples 34C to 40C was measured. The measurement results are shown in Table 15 and FIG. 16.

TABLE 15

| | | Test piece | | | | | | | |
|---|---|---|---|---|---|---|---|---|---|
| | | | | | | | | | Eva- |
| | | | | | | | | | luation |
| | | | | | | | | | results |
| | | | | | | | | | Vick- |
| | | | | | | | | | ers |
| | | | | | | | | | hard- |
| | | | | | | | | | ness |
| | | | | | | | | | Sur- |
| | | | | | | | | | face |
| | | Alloy composition | | | | | | | layer |
| | | Cr | Mo | Si | C | N | Ni | Co | portion |
| | | % by mass | | | | | | | — |
| Sam- | Ex- | 29.7 | 6.84 | 0.77 | 0.02 | 0.10 | 0.01 | re- | 325 |
| ple | ample | | | | | | | main- | |
| No. 47 | 34C | | | | | | | der | |
| Sam- | Ex- | 29.8 | 6.80 | 0.78 | 0.02 | 0.13 | 0.01 | re- | 315 |
| ple | ample | | | | | | | main- | |
| No. 48 | 35C | | | | | | | der | |
| Sam- | Ex- | 30.2 | 6.82 | 0.79 | 0.02 | 0.15 | 0.01 | re- | 281 |
| ple | ample | | | | | | | main- | |
| No. 49 | 36C | | | | | | | der | |
| Sam- | Ex- | 29.9 | 6.83 | 0.78 | 0.02 | 0.18 | 0.01 | re- | 271 |
| ple | ample | | | | | | | main- | |
| No. 50 | 37C | | | | | | | der | |
| Sam- | Ex- | 30.1 | 6.85 | 0.77 | 0.02 | 0.21 | 0.01 | re- | 284 |
| ple | ample | | | | | | | main- | |
| No. 51 | 38C | | | | | | | der | |
| Sam- | Ex- | 29.6 | 6.84 | 0.76 | 0.02 | 0.23 | 0.01 | re- | 380 |
| ple | ample | | | | | | | main- | |
| No. 52 | 39C | | | | | | | der | |
| Sam- | Ex- | 29.7 | 6.81 | 0.78 | 0.02 | 0.27 | 0.01 | re- | 394 |
| ple | ample | | | | | | | main- | |
| No. 53 | 40C | | | | | | | der | |

As apparent from Table 15 and FIG. 16, the concentration of N in the test piece and the Vickers hardness have such a relationship that the hardness reaches the local minimum at a specific N concentration. When the hardness is appropriately decreased, the toughness of the test piece is increased, so that the improvement of the tensile strength, proof stress, etc. is observed. When the hardness is near the local minimum, the balance between the hardness and the proof stress is favorable, and thus, such an alloy can be used as a dental alloy material useful as a dental implant.

What is claimed is:

1. A dental component comprising a sintered body of a metal powder having particles containing Co, Cr, Mo, and Si as constituent components, wherein
in the particles,
Co is contained as a main component,
the content of Cr is 26% by mass or more and 35% by mass or less,
the content of Mo is 5% by mass or more and 12% by mass or less, and
the content of Si is 0.3% by mass or more and 2.0% by mass or less.

2. The dental component according to claim 1, wherein
a part of Si in the sintered body is contained as silicon oxide, and
the ratio of the content of Si contained as the silicon oxide to the content of Si in the sintered body is 20% or more and 80% or less.

3. The dental component according to claim 2, wherein the silicon oxide is segregated at the grain boundary of the sintered body.

4. The dental component according to claim 1, wherein
the particles further contain N as a constituent component, and
the content of N in the particles is 0.09% by mass or more and 0.5% by mass or less.

5. The dental component according to claim 1, wherein in an X-ray diffraction pattern obtained by X-ray diffractometry using a Cu-Kα ray, when the height of the highest peak among the peaks derived from Co identified based on ICDD card is assumed to be 1, the height of the highest peak among the peaks derived from Co₃Mo identified based on ICDD card is 0.01 or more and 0.5 or less.

6. The dental component according to claim 1, wherein the dental component has a 0.2% proof stress of 500 MPa or more and a Young's modulus of 150 GPa or more.

7. The dental component according to claim 1, wherein the dental component is a dental orthodontic bracket.

8. The dental component according to claim 7, wherein the dental orthodontic bracket has a Vickers hardness of 200 or more and 550 or less.

9. The dental component according to claim 1, wherein the dental component is a dental anchor.

10. The dental component according to claim 9, wherein in a cross section of the dental anchor, when the major axis of a crystal structure of the sintered body is represented by CL and the minor axis thereof is represented by CS, an aspect ratio defined by CS/CL is 0.4 or more and 1 or less.

11. The dental component according to claim 1, wherein the dental component is a dental implant.

12. The dental component according to claim 11, wherein in a cross section of the dental implant, when the major axis of a crystal structure of the sintered body is represented by CL and the minor axis thereof is represented by CS, an aspect ratio defined by CS/CL is 0.4 or more and 1 or less.

13. The dental component according to claim 11, wherein
the dental implant is provided between the jaw bone and a crown restoration, and
in the dental implant, the arithmetic average roughness Ra of a part to be in contact with the jaw bone is smaller than the arithmetic average roughness Ra of a part to be in contact with the crown restoration.

14. A metal powder for powder metallurgy which comprises particles containing Co, Cr, Mo, and Si as constituent components and is used for producing a dental component, wherein
in the particles,
Co is contained as a main component,
the content of Cr is 26% by mass or more and 35% by mass or less,
the content of Mo is 5% by mass or more and 12% by mass or less, and
the content of Si is 0.3% by mass or more and 2.0% by mass or less.

15. A method for producing a dental component comprising:
molding a metal powder having particles containing Co, Cr, Mo, and Si as constituent components by a metal powder injection molding method, thereby obtaining a molded body; and
firing the molded body, thereby obtaining a sintered body, wherein
in the particles,
Co is contained as a main component,
the content of Cr is 26% by mass or more and 35% by mass or less,
the content of Mo is 5% by mass or more and 12% by mass or less, and
the content of Si is 0.3% by mass or more and 2.0% by mass or less.

16. The method for producing a dental component according to claim 15, wherein the dental component is a dental orthodontic bracket.

17. The method for producing a dental component according to claim 15, wherein the dental component is a dental anchor.

18. The method for producing a dental component according to claim 15, wherein the dental component is a dental implant.
